(19) United States
(12) Patent Application Publication
(10) Pub. No.: US 2009/0186328 A1
(43) Pub. Date: Jul. 23, 2009

(54) Method for teaching rapid recall of facts

(75) Inventors: Kathryn Marie Robinson, Hendrix, OK (US); Scott Allen Satterfield, Bokchito, OK (US)

Correspondence Address: James T. Robinson;Exclusivity-Law, Inc., 222 East Main Street, Norman, OK, 73069-1303, US

(73) Assignee: Schoolware, Inc.

(21) Appl. No.: 12/011,042

(22) Filed: Jan. 23, 2008

(51) Int. Cl. G09B 5/00; G09B 7/00

(52) U.S. Cl. 434/350; 434/362

(57) ABSTRACT

An internet-based method for teaching rapid recall of facts uses a grid system to deliver facts (i.e. problems) from a teacher-selected pool of facts to individual students in student sessions. Each student session includes a fact practice portion, wherein the student engages in the somewhat mundane, repetitive steps, required to master the particular set of facts and a game practice portion, whereby the student earns game practice time in arcade-style games as a reward for the student's efforts. The method permits a teacher or administrator to track the performance of a single student or a group of students through on-demand reports. Selected reports are also available, on demand, to the student and the student's parents. The method identifies each student's mastered and un-mastered facts based on each student's performance. The teacher can then provide each student with supplemental, individualized materials. The Method automatically notifies teachers and administrators when intervention is needed. The present Method permits teachers and parents to obtain, on demand, customized and individualized work sheets, activity sheets, and flash cards. The present Method delivers math facts in multiple formats, including pre-algebraic and algebraic views, and tracks each student's progress by use of fractions and a pie chart, thereby exposing students to fractions and charts at an early age.

### BACKGROUND OF THE INVENTION

1. Field of the Invention

This invention relates to a method for teaching students rapid recall of facts incorporating guaranteed review and recycle. Student sessions using the internet consist of a fact practice portion and a game practice portion. As used herein, the terms “fact practice,” “fact practice portion,” and “fact practice session” of the student session are used interchangeably to mean the portion of a student session wherein the student practices working problems involving the rapid recall of facts. The web-based software incorporates a grid system to deliver particular facts from staged groups of facts, to track student progress, to generate student-specific reviews, to expand the content of the groups of facts, and to provide on-demand, real-time reports. Based on the student's demonstrated progress during the fact practice portion of the student session (i.e., during “fact practice”), the student is rewarded for engaging in the mundane, repetitive exercises required to master rapid recall of facts with game time (sometimes referred to herein as “the game practice portion of the student session” or “game practice”) in an arcade-style game. Further progress towards mastering rapid recall of the facts earns additional game time. As used herein, the term “fact” means a question (or problem) from a group of facts (sometimes referred to herein, interchangeably, as a pool of facts) and a matching answer. The fact may be a simple mathematical operation (e.g., 2+2=4 or 3×5=15). The fact may be a question (or fill-in-the-blank problem) having a specific matching answer (e.g., “The President of the United States during World War II was . . . Franklin D. Roosevelt or Harry S. Truman”). The pool of facts can be addition problems whose sum does not exceed 10 or vocabulary for foreign languages (“In Spanish, a friend is an” . . . amigo or amiga).

The present method will be described in detail with respect to math facts drawn from four pools of facts (one pool each for addition, subtraction, multiplication, and division). The present Method is equally applicable to developing student mastery of rapid recall of facts from all areas of education.

2. Discussion

Students (also referred to herein, interchangeably, as learners) must develop math fact fluency before moving on to more complex problems. Recent fMRI studies of math fact recall (Dahaene, 1999; Delazer, 2004) conclude that automatically retrieved facts are stored in the same region of the brain, suggesting a potential linguistic relationship between a math calculation (e.g., 3×4) and its answer (12). Sounding out or decoding every word prohibits fluency in reading, thereby leading many overwhelmed and discouraged readers to avoid reading altogether. Studies have shown that the student's acquisition of a large vocabulary of sight words increases reading fluency.

Similarly, if a student must stop and “count up” each time the student learns a new mathematical concept, this interruption of the student's learning makes mastery of mathematical concepts and objectives nearly impossible for the average learner. Studies have demonstrated that a lack of math fact retrieval (i.e., rapid recall of the math fact) can impede successful mathematics problem solving (Pellegrino & Goldman, 1987). The process by which a student learns long division demonstrates this point. Each time a learner has to stop the sequence of long division (divide, multiply, subtract, and bring down) to count out math facts, the learner's opportunity for acquiring the long division skill is diminished. Rapid recall of math facts increases student acquisition of higher-order math skills for any learner. From the fourth grade through adulthood, answers to basic math facts are recalled from memory with a continued strengthening of relationships between problems and answers resulting in further increases in fluency (Ashcraft, 1985).

Traditionally, teachers begin with a limited set of math facts such as the twos. When the student demonstrates mastery of the twos, the teacher then delivers math facts involving the threes, then the fours, etc. As used herein, the terms “teacher” and “instructor” are used, interchangeably. At some point, the teacher will have a review of the math facts delivered to date and then resume delivery of additional math facts (e.g., the fives). In this delivery model, teachers are systematically delivering increments of the complete set of math facts because the complete set of math facts is too large for the student to take on in a single delivery. Yet the student's success in mathematics requires the student to be able to process the entire math facts data set of each mathematical operation (i.e., addition, subtraction, multiplication, and division). A certain amount of recycling of previously-learned math facts within each operation is required for the student to master each operation as a complete set of math facts. For a new skill to become automatic or for new knowledge to become long-lasting, sustained practice, beyond the point of mastery, is necessary (Willingham, spring 2004).

Educators sometimes compare the mastery of prerequisite skills and objectives to a set of steps or a stairway which a student climbs to reach the next objective. Instruction and practice cause math fact processing to move from a quantitative area of the brain to an area related to automatic retrieval (Dehaene, 1997, 1999, 2003). Thus a constant review and re-delivery of un-mastered math facts, together with a random recycling of mastered math facts and identification of trouble facts is required if the student is to succeed in acquiring the complete set of math facts. The unexpected finding from cognitive science is that practicing only until one is perfect results in brief perfection. What is necessary is sustained practice such as regular, ongoing review or use of the target material (Willingham, spring 2004).

Educators have long designed rewards into classroom activities in an effort to inspire and motivate learners. College students spend many more hours playing video games than they spend in class (Cannon-Bowers at the Federation of American Scientists Summit on Video Gaming, 2005). “Educators need tools and standards to create games quickly at low cost. Educators also need an infrastructure for the collection of data and a way to analyze the effectiveness of these games in teaching content. Better research on motivation would not only help K-12 educators transform young people into better students in the short term, but it would also help today's students become lifelong learners” (Olds at the Federation of American Scientists Summit on Video Gaming, 2005).

As noted above, classroom teachers historically delivered new math facts in small increments, reviewed previously-learned facts, then moved on to another increment of math facts, reviewed once again, and repeated the process until the complete set of math facts had been delivered to the students. Periodic testing provided feedback to the teacher on each student's progress. Teachers have the ability to tailor additional exercises to each student's trouble facts (i.e., the individual student's most frequently missed math facts), but teachers do not have the time to do so. In the absence of a capacity to address each student's trouble facts, the teacher is limited to addressing trouble facts for the class as a whole.

With current methods, teachers must monitor (assess) a student's performance, evaluate the student's needs, assign work designed to help the student learn, monitor the student's progress, re-evaluate the student's needs, assign additional work, monitor, re-evaluate . . . repeating the process. What is needed is a method which not only delivers rapid-recall facts but also tracks student progress, creates student-specific reviews, identifies each student's trouble facts, automatically expands the content of the pool of facts based on the student's progress, and provides on-demand reports (for each individual student, for a class of students, for multiple classes, for multiple grades, and for multiple schools) to students, teachers, and administrators. The method should also provide each student with periodic rewards, in the form of earned time in an arcade-style game, based on the student's progress.

### SUMMARY OF THE INVENTION

An internet-based method for teaching rapid-recall facts uses a grid system to deliver facts (i.e. problems) from a teacher-selected pool of facts to individual students, thereby providing individualized instruction to an entire class of students. Each student session includes a fact practice portion, wherein the student engages in the somewhat mundane, repetitive steps, and a game practice portion, wherein the method rewards students for engaging in the mundane, repetitive steps required to master the rapid-recall facts with game time in arcade-style games. The method permits a teacher or administrator to track the performance of a single student or a group of students through on-demand reports. Selected reports are also available, on demand, to the student and the student's parents. The method further allows the teacher to identify each student's mastered and un-mastered facts and, based on each student's performance. The teacher can then provide each student with supplemental, individualized materials. The present Method automatically notifies teachers and administrators when intervention is needed. The present Method permits teachers and parents to obtain, on demand, customized and individualized work sheets, activity sheets, and flash cards. The present Method delivers math facts in multiple formats, including pre-algebraic and algebraic views, and tracks each student's progress by use of fractions and a pie chart, thereby exposing students to fractions and charts at an early age.

An object of the present invention is to provide an internet-based Method For Teaching Rapid Recall Of Facts which is available to students both at school and at home.

Yet another object of the present invention is to provide a Method For Teaching Rapid Recall Of Facts which uses a grid to deliver facts from one or more teacher-selected pools of facts to individual students based on each student's progress.

Yet another object of the present invention is to provide a Method For Teaching Rapid Recall Of Facts which rewards each student's success in the fact practice portion of a student session with game practice in an arcade-style game.

Yet another object of the present invention is to provide a teacher-friendly tracking and management system which selectively provides students, teachers, administrators, and parents with appropriate information about each student's progress.

Yet another object of the present invention is to provide a teacher-friendly tracking and management system which provides teachers and administrators student information about the progress of selected groups of students (a single class, multiple classes within the same school, and multiple classes in two or more schools).

Yet another object of the present invention is to identify each student's mastered and un-mastered facts and, at the request of the student, teacher, or administrator, generate supplemental, individualized materials.

Yet another object of the present method for teaching rapid-recall facts is to generate customized and individualized work sheets, activity sheets, and flash cards.

Yet another object of the present method for teaching rapid-recall facts is to selectively deliver math facts in multiple formats, including pre-algebraic and algebraic views.

Yet another object of the present method for teaching rapid-recall facts is to track each student's progress by the use of fractions and a pie chart, thereby exposing students to fractions and graphs at an early age.

Other objects, features, and advantages of the present invention will become clear from the following description of the preferred embodiment when read in conjunction with the accompanying drawings and appended claims.

### BRIEF DESCRIPTION OF THE DRAWINGS

FIG. 1 is a math facts addition grid showing the staged introduction of addition problems to students based on grade level.

FIG. 2 is a math facts multiplication grid showing the staged introduction of multiplication problems to students based on grade level.

FIG. 3 is a math facts subtraction grid showing the staged introduction of subtraction problems to students based on grade level.

FIG. 4 is a math facts division grid showing the staged introduction of division problems to students based on grade level.

FIG. 5 is a view of a selection screen whereby the student begins a student session by selecting one of four mathematical operations or, in the alternative, by selecting a link to view the student's Student Progress Report.

FIG. 6 is a view of a math facts addition problem as the addition problem is initially displayed on a student's computer display during the fact practice portion of a student session.

FIG. 7 is a view of another math facts addition problem as it is displayed on the student's computer display during the fact practice illustrated in FIG. 6.

FIG. 8 is a view of another math facts addition problem as the problem is displayed on the student's computer display during the fact practice illustrated in FIGS. 6-7.

FIG. 9 is a view of another math facts addition problem as the problem is displayed on the student's computer display during the fact practice illustrated in FIGS. 6-8.

FIG. 10 is a view of the student's combination Student Progress Report and menu of arcade-style games as displayed on the student's computer display when the predetermined fact practice ending criteria are met during the fact practice illustrated in FIGS. 6-9.

FIG. 11 is a view of the ten highest game scores, for the specific student's class and grade on the selected arcade-style game, as displayed on the student's display when predetermined game-ending criteria are met.

FIG. 12 is a view of the ten highest game scores, for all students in the student's school on the selected arcade-style game, as displayed on the student's display.

FIG. 13 is a view of another math facts addition problem as the problem as displayed on the student's display screen during a fact practice portion of a student session.

FIG. 14 is a view of a math facts multiplication problem as the problem is displayed on the student's display screen during fact practice.

FIG. 15 is a view of another math facts multiplication problem as the problem is displayed on the student's display screen during fact practice.

FIG. 16 is a view of a math facts subtraction problem as the problem is displayed on the student's display screen during fact practice.

FIG. 17 is another view of a math facts subtraction problem as the problem is displayed on the student's display screen during fact practice.

FIG. 18 is a view of a math facts division problem as the problem is displayed on the student's display screen during fact practice.

FIG. 19 is a view of another math facts division problem as the problem is displayed on the student's display screen during fact practice.

FIG. 20 is an illustration of a Student User Report provided, on demand, to the teacher or administrator.

FIGS. 21-22 are a 2-page Assessment Report provided, on demand, to the teacher or administrator.

FIGS. 23-24 are a 2-page “We Beat Our Best Assessment!” report provided, on demand, to the teacher or administrator.

FIGS. 25-26 are a 2-page Group Summary Report provided, on demand, to the teacher or administrator.

FIGS. 27-28 are a 2-page Histogram Report provided, on demand, to the teacher or administrator.

FIG. 29 is an Individual Trouble Facts Report, in flash card format, for student Brooklyn Gacia.

FIGS. 30-33 are a 4-page Group Trouble Facts Report, in short-form strip format, for each student in Sampson's class.

FIG. 34 is a generic 50-Problem Mad Minute work sheet provided, on demand, to the teacher or administrator.

FIG. 35 shows a generic 100-Problem Mad Minute work sheet provided, on demand, to the teacher or administrator.

FIG. 36 is a student-specific Mad Minute work sheet provided, on demand, to the teacher or administrator.

FIG. 37 is an illustration of a report of the top ten students and their scores in an arcade-style game for all students in the school.

FIG. 38 is an illustration of a Student Progress Report for a selected student.

FIG. 39 is an illustration of an interactive Student Progress Report for a selected student.

FIG. 40 is an Administrator Teacher User Report provided, on demand, to the Administrator.

FIG. 41 is an Administrative Instructor Summary Report provided, on demand, to the Administrator.

FIG. 42 is a Administrative Histogram Report for All Instructors provided, on demand, to the Administrator.

FIG. 43 is a step-by-step summary of the steps taken by the student during a student session.

FIG. 44 is a generic diagram showing the content of the student fact practice display screen.

FIG. 45 is a Summary of the Administrator Interface.

FIG. 46 is step-by-step Summary of a portion (“Instructor Settings”) of the Administrator Interface of FIG. 45.

FIG. 47 is step-by-step Summary of another portion (“Student Settings”) of the Administrator Interface of FIG. 45.

FIG. 48 is step-by-step Summary of another portion (“Site Defaults Settings”) of the Administrator Interface of FIG. 45.

FIG. 49 is step-by-step Summary of another portion (“Reports Settings”) of the Administrator Interface of FIG. 45.

FIG. 50 is step-by-step Summary of another portion (“Password Settings”) of the Administrator Interface of FIG. 45.

FIG. 51 is a Summary of the Teacher Interface.

FIGS. 52A and 52B are a step-by-step Summary of a portion (“Student Settings”) of the Teacher Interface of FIG. 51.

FIG. 53 is a step-by-step Summary of another portion (“Reports Settings”) of the Teacher Interface of FIG. 51.

FIG. 54 is a step-by-step Summary of another portion (“Give Assessment”) of the Teacher Interface of FIG. 51.

FIG. 55 is a step-by-step Summary of another portion (“Change Teacher Password”) of the Teacher Interface of FIG. 51.

FIGS. 56A-56C summarize the present Method's selection and display of problems.

FIG. 57 is a view of a math facts problem as the problem is displayed on the student's display screen during an assessment.

### DETAILED DESCRIPTION OF THE INVENTION

In the following description of the invention, like numerals and characters designate like elements throughout the figures of the drawings.

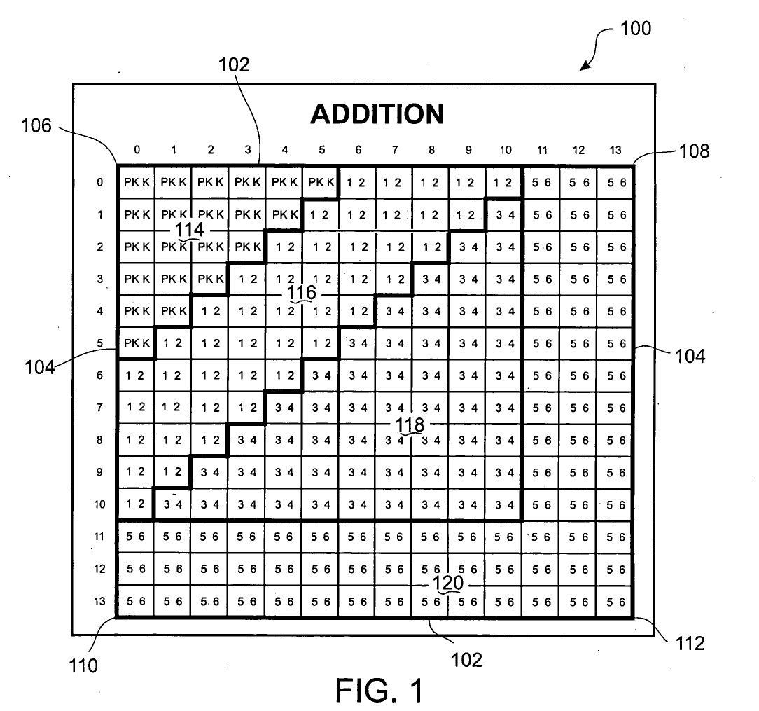

Referring now to FIG. 1, an addition grid 100 contains a pool of addition problems to be introduced to students in stages. The addition grid 100 has a horizontal axis 102 (the x axis) along which first fact components are spaced and a vertical axis 104 (the y axis) along which second fact components are spaced. The numbers along each axis represent the numbers (fact components) to be added in a problem (defined by corresponding fact components) to be displayed to the student. The extremes are indicated by problems corresponding to positions 106 (0+0), 108 (13+0), 110 (0+13), and 112 (13+13).

Still referring to FIG. 1, the addition problems derived from the addition grid 100 are divided into a first group 114, a second group 116, a third group 118, and a fourth group 120. The groups 114, 116, 118, and 120 contain the terms (also sometimes called “addends” or “summands”) to be added to generate addition problems to be introduced to students in corresponding stages A1, A2, A3, and A4, respectively. The stages A1, A2, A3, and A4 are also referred to herein as phase A1, phase A2, phase A3, and phase A4, respectively.

Still referring to FIG. 1, the group 114 (corresponding to stage 1) contains terms which are added to create addition problems whose sums never exceed 10 (0+0=0, 0+1=1, 1+0=1, 0+2=2, 2+0+2 . . . 1+9=10, 9+1=10, 0+10=10, 10+0=10). The stage A1 problems are suitable for introduction to students in the pre-kindergarten and kindergarten grade levels. The group 116 (corresponding to stage A2) contains addends used to create addition problems typically introduced to the students in the first and second grade levels. The group 118 contains summands used to create addition problems typically introduced to students in the third and fourth grade levels (stage A3), and the group 120 contains addends used to create addition problems typically introduced to students in the fifth grade and beyond (stage A4).

It will be understood by one skilled in the art that the staged introduction of addition problems, beginning with addition problems wherein the addends (also known as terms or summands) are relatively smaller numbers and introducing relatively larger addends over time, is a well-known and established teaching practice.

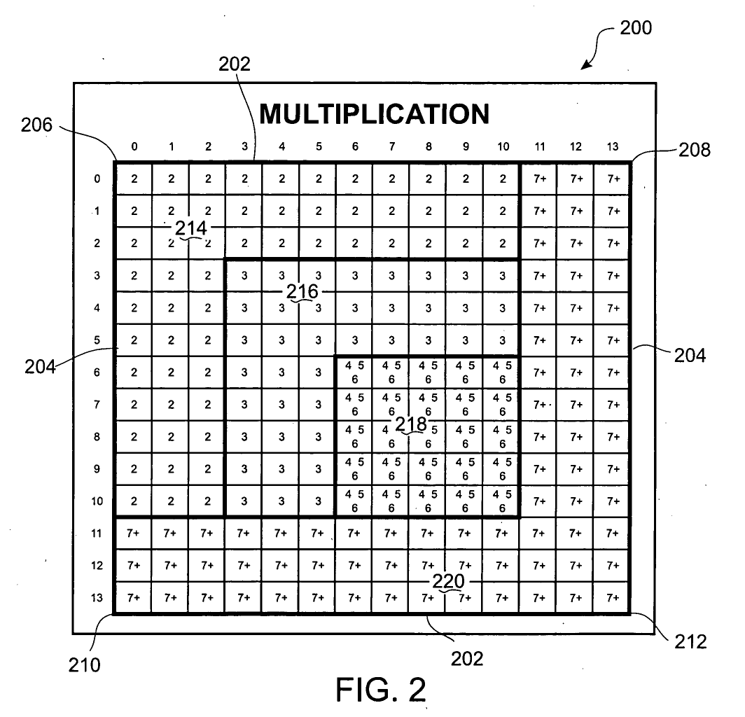

Referring now to FIG. 2, a multiplication grid 200 contains multiplicands and multipliers used to create multiplication problems to be introduced to the student in stages. The multiplication grid 200 has a horizontal axis 202 (the x axis) and a vertical axis 204 (the y axis). The numbers along each axis represent the numbers (multiplicand and multiplier) used to create a problem to be displayed to the student. The extremes are indicated by problems corresponding to positions 206 (0×0), 208 (13×0), 210 (0×13), and 212 (13×13).

Still referring to FIG. 2, the multiplication problems derived from the multiplication grid 200 are divided into a first group 214, a second group 216, a third group 218, and a fourth group 220. The groups 214, 216, 218, and 220 contain the multiplicands and multipliers used to create the multiplication problems to be introduced to students in corresponding stages M1, M2, M3, and M4, respectively. The stages M1, M2, M3, and M4 are also referred to herein as phase M1, phase M2, phase M3, and phase M4, respectively.

Still referring to FIG. 2, the group 214 (corresponding to stage Ml) contains multiplicands and multipliers whose products do not exceed 20 (0×0=0, 0×1=0, 1×0=0, 0×2=02, 2+0=0 . . . 1×9=9, 9×1=9, 0×10=0, 10×0=0). As used herein, for the problem 5×3=15, 5 is the multiplicand, 3 is the multiplier, and 15 is the product. The stage M1 problems are suitable for introduction to students in the second grade. The group 216 (corresponding to stage M2) represents multiplication problems typically introduced to the students in the third grade level. The group 218 contains multiplicands and multipliers used to create multiplication problems typically introduced to students in the fourth, fifth, and sixth grade levels (stage M3). The group 220 contains multiplicands and multipliers used to create multiplication problems typically introduced to students in the seventh grade and beyond (stage M4).

It will be understood by one skilled in the art that the staged introduction of multiplication problems, beginning with the problems wherein the numbers to be multiplied are relatively smaller numbers and introducing relatively larger numbers over time, is a well-known and established teaching practice.

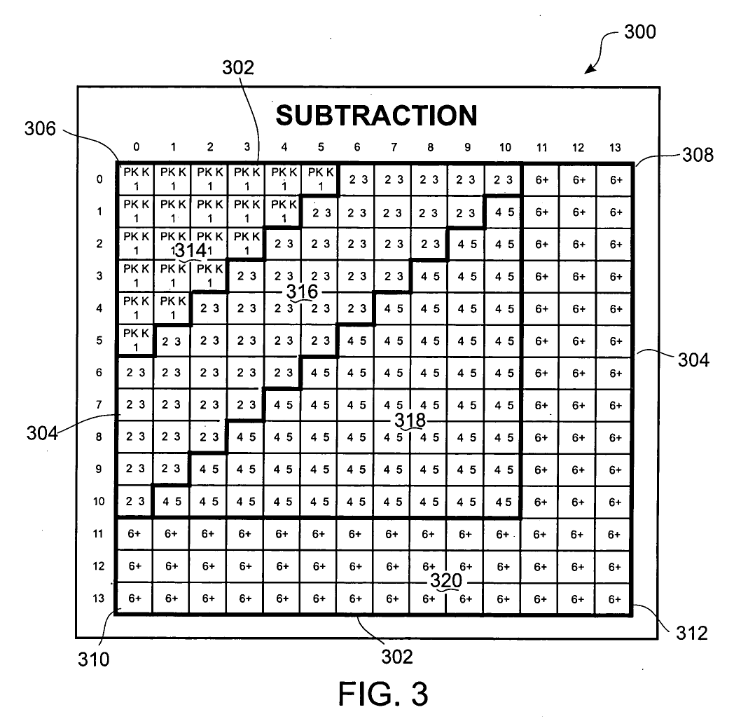

Referring now to FIG. 3, a subtraction grid 300 contains minuends and subtrahends from which subtraction problems are drawn for display to the student. As used herein, for the subtraction problem 5−3=2, 5 is the minuend, 3 is the subtrahend, and 2 is the difference. The subtraction grid 300 has a horizontal axis 302 (the x axis) and a vertical axis 304 (the y axis). The numbers along each axis represent the terms (i.e., the minuend and the subtrahend) of subtraction problems to be displayed to the student. The extremes are indicated by problems corresponding to positions 306 (0−0), 308 (13−0), 310 (0−13), and 312 (13−13).

Still referring to FIG. 3, the subtraction problems derived from the subtraction grid 300 are divided into a first group 314, a second group 316, a third group 318, and a fourth group 320. The groups 314, 316, 318, and 320 define the subtraction problems to be introduced to students in corresponding stages S1, S2, S3, and S4, respectively. The stages S1, S2, S3, and S4 may also be referred to herein as phase S1, phase S2, phase S3, and phase S4, respectively.

Still referring to FIG. 3, the group 314 (corresponding to stage S1) contains minuends and subtrahends used to generate subtraction problems wherein neither the minuend nor the subtrahend exceeds 10. The stage S1 problems are suitable for introduction to students in the pre-kindergarten, kindergarten, and first grade levels. The group 316 (corresponding to stage S2) contains terms used to create subtraction problems typically introduced to the students in the second and third grade levels. The group 318 contains terms used to create subtraction problems typically introduced to students in the fourth and fifth grade levels (stage S3), and the group 320 contains terms used to create subtraction problems typically introduced to students in the sixth grade and beyond (stage S4).

It will be understood by one skilled in the art that the staged introduction of subtraction problems, beginning with the problems wherein the terms (i.e., the minuend and the subtrahend) are relatively smaller numbers and introducing relatively larger terms over time, is a well-known and established teaching practice.

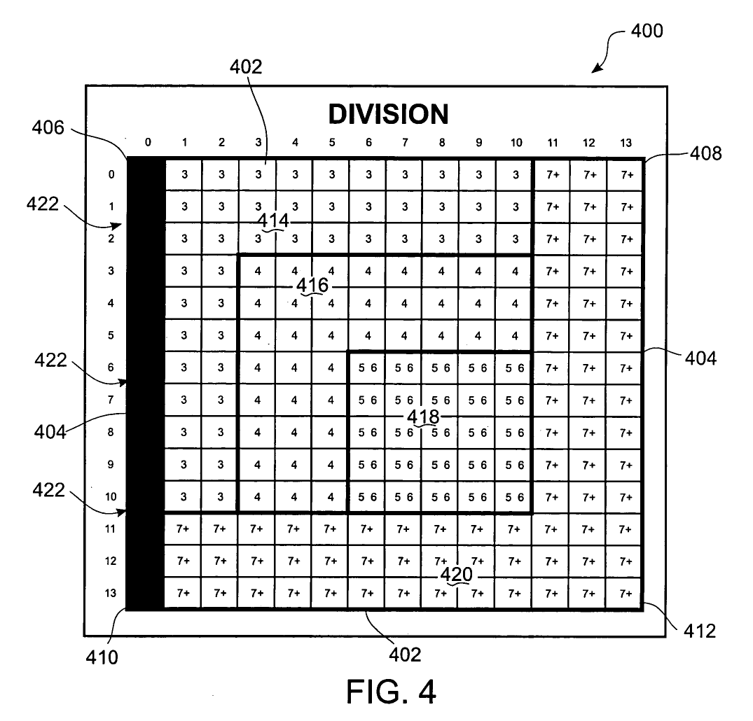

Referring now to FIG. 4, a division grid 400 contains terms (dividends and divisors) from which division problems are created for display to the student. As used herein for the division problem 8÷4=2, the 8 is the dividend, the 4 is the divisor, and the 2 is the quotient. The division grid 400 has a horizontal axis 402 (the x axis) and a vertical axis 404 (the y axis). The numbers along each axis contain the divisor and the quotient used to create division problems to be displayed to the student. The extremes are indicated by problems corresponding to positions 406 (0 divided by 0), 408 (13 divided by 0), 410 (0 divided by 13), and 412 (169 divided by 13).

Still referring to FIG. 4, the division problems derived from the division grid 400 are divided into a first group 414, a second group 416, a third group 418, and a fourth group 420. The groups 414, 416, 418, and 420 define the division problems to be introduced to students in corresponding stages D1, D2, D3, and D4, respectively. The stages D1, D2, D3, and D4 may also be referred to herein as phase D1, phase D2, phase D3, and phase D4, respectively. A fifth group 422 consists of the first vertical column of the division grid 400 and involves division by zero, which is not permitted.

Still referring to FIG. 4, the group 414 (corresponding to stage D1) contains dividends not exceeding 20. The stage D1 problems are suitable for introduction to students in the third grade. The group 416 (corresponding to stage D2) contains dividends, up to 50, associated with division problems typically introduced to the students in the fourth grade level. The group 418 contains dividends, up to 100, associated with division problems typically introduced to students in the fifth and sixth grade levels (stage D3), and the group 420 contains dividends, up to 169, associated with division problems typically introduced to students in the seventh grade and beyond (stage D4).

It will be understood by one skilled in the art that the staged introduction of division problems, beginning with the problems wherein the dividends are relatively smaller numbers and introducing relatively larger dividends over time, is a well-known and established teaching practice.

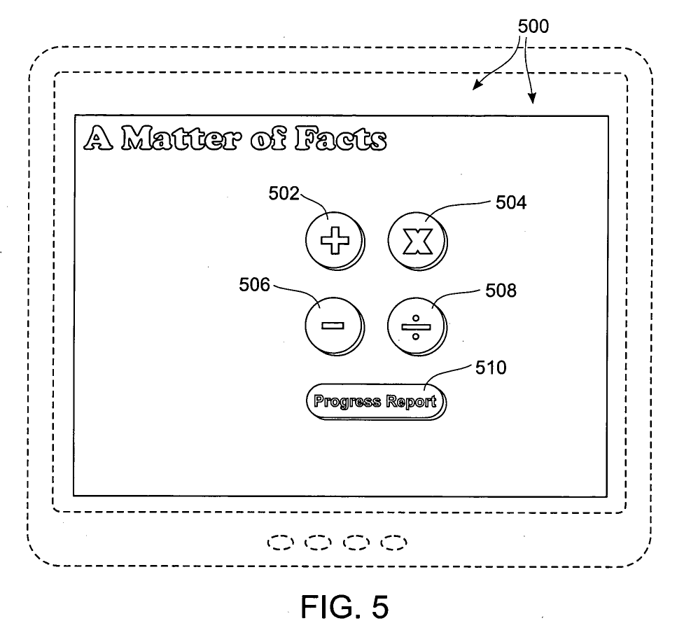

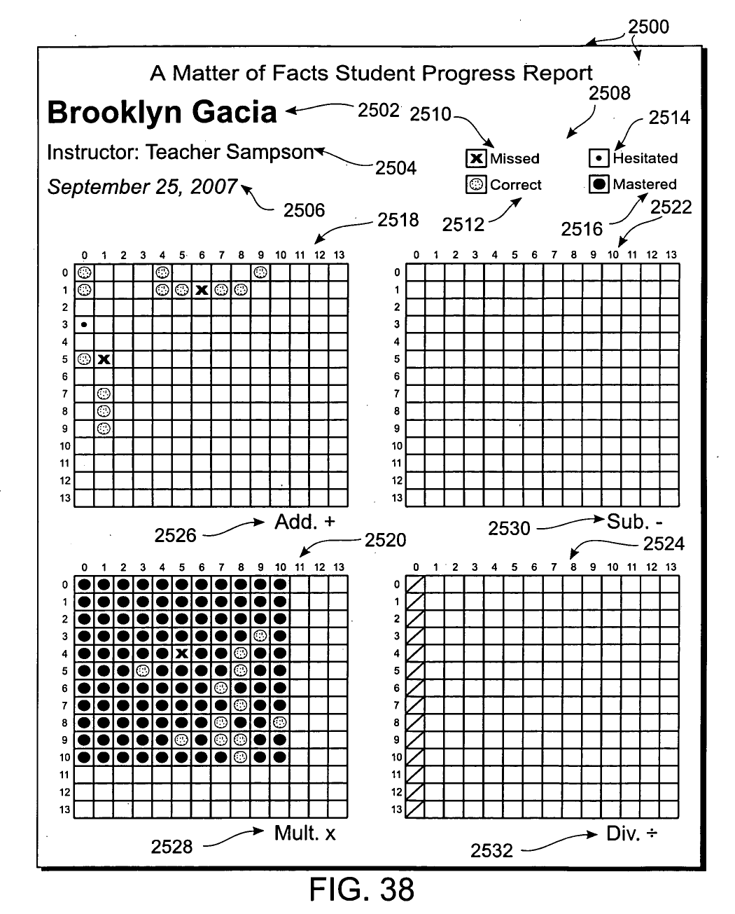

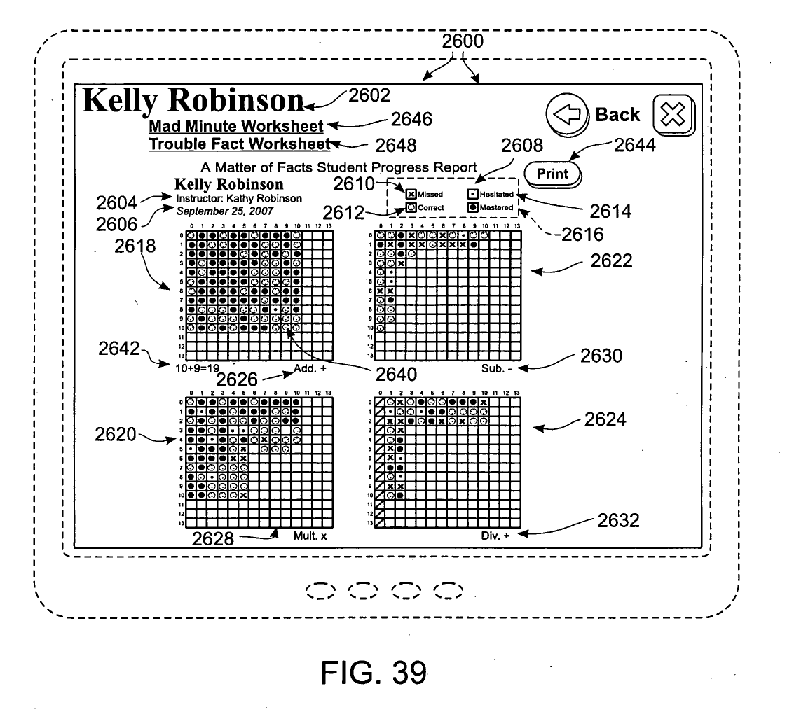

Referring now to FIG. 5, a selection screen 500 displayed at the beginning of a student session (following login) provides the student with five selection options represented by an addition icon 502, a multiplication icon 504, a subtraction icon 506, a division icon 508, and a Progress Report icon 510. As used herein, the term student session means at least one period of fact practice followed immediately by at least one period of game practice. The student's selection of the addition icon 502 initiates a fact practice period containing addition problems selected on the basis of the student's most recent Student Progress Report (See FIGS. 38 and 39). The student's selection of the multiplication icon 504 initiates a fact practice period containing multiplication problems selected on the basis of the student's most recent Student Progress Report (See FIGS. 38 and 39). The student's selection of the subtraction icon 506 initiates a fact practice period containing subtraction problems selected on the basis of the student's most recent Student Progress Report (See FIGS. 38-39). The student's selection of the division icon 508 initiates a fact practice period containing division problems selected on the basis of the student's most recent Student Progress Report (See FIGS. 38-39). The student's selection of the Progress Report icon 510 results in the display of the student's Student Progress Report (See FIGS. 38-39) on the student's computer display.

As discussed below with respect to FIG. 39, the student is encouraged to review the student's current Student Progress Report prior to initiating a student session. By reviewing the student's current Student Progress Report, the student can quickly identify those problems (facts) with which the student is currently struggling based on the student's most recent fact practice sessions. The term “trouble facts” is used herein to mean most frequently missed problems for a particular student for each operation based on data through the most recent student session.

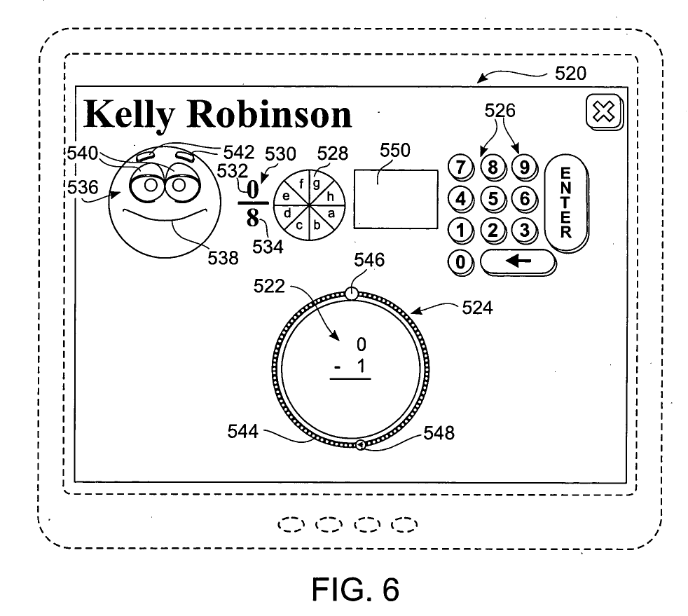

Referring now to FIG. 6, a screen display 520 is displaying a math facts addition problem 522 (in traditional vertical format) within a timer graphic 524. An on-screen number pad 526 enables entry of the answer using the mouse. If the student's computer is equipped with touch screen capabilities, the on-screen number pad 526 also functions as a touch pad, enabling the student to enter the answer by touching the numbers forming the answer and then touching the enter key on the on-screen number pad 526. A pie chart 528 has eight pie-chart segments 528a, 528b, 528c, 528d, 528e, 528f, 528g, and 528h. A fraction 530 has a numerator 532 and a denominator 534. A responsive face 536 includes a responsive mouth 538, responsive eyes 540, and responsive eyebrows 542. It will understood by one skilled in the art that the pie chart is on possible graphic representation of a progress indicator. Other possible graphic representations of a progress indicator include, without limitation, a horizontal progress bar, a vertical progress bar, a volume indicator (e.g., a glass of liquid wherein a full glass represents completion), or completion of a set (e.g., a set of keys, a set of tools, etc.).

Still referring to FIG. 6, the timer graphic 524 has a timer ring 544 which moves from a starting point 546 clockwise 360 degrees back to the starting point 546 to indicate the passage of time. The timer ring 544 is graphic representation of two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 548 within the timer ring 544 indicates the passage of time within each time period.

It will be understood by one skilled in the art that the first time period—the rapid recall response time period—provides sufficient time for the student to enter the correct answer only if the student knows the correct answer without calculation, i.e., if the student has stored the correct answer in what is sometimes called “rapid recall memory” or “rapid recall.” The student may answer the problem correctly during the second time period, thereby indicating the student hesitated before arriving at and entering the correct answer. If the student enters an incorrect answer or fails to enter an answer during the combined first time period and second time period (a total of 7 seconds), the student is deemed to have entered a wrong answer. As will be discussed in greater detail below, this distinction between (1) a correct answer entered within the initial 3-second time period, (2) a correct answer entered after expiration of the 3-second initial time period but prior to expiration of the following 4-second time period, and (3) an incorrect answer (or no answer) entered during either the initial time period or the second time period is an important feature of applicant's Method For Teaching Rapid Recall Of Facts invention. As used herein, a “correct” answer is an answer which is both (1) mathematically correct and also (2) entered with the 3-second initial time period. A “hesitated” answer is an answer which is mathematically correct but which was not entered within the 3-second initial time period. A “missed” answer is both (1) a mathematically incorrect answer entered within either the initial 3-second time period or the following 4-second time period and also (2) failure to enter an answer within the combined 3-second and 4-second time periods.

Referring again to FIG. 6, a region 550 in the display 520 is reserved for display of missed problems. In FIG. 6, it is apparent that the problem 522 in the display 520 is the first problem for this particular student session. The entry of the number zero in the numerator 532 of the fraction 530 and the absence of a darkened pie wedge in the pie chart 528 indicate the student has not yet entered a correct answer. The absence of the correct answer in the region 550 indicates the student has not yet entered a wrong answer. The position of the moving arrow 548 in the timer ring 544 indicates the elapse of about half the time for the particular time period.

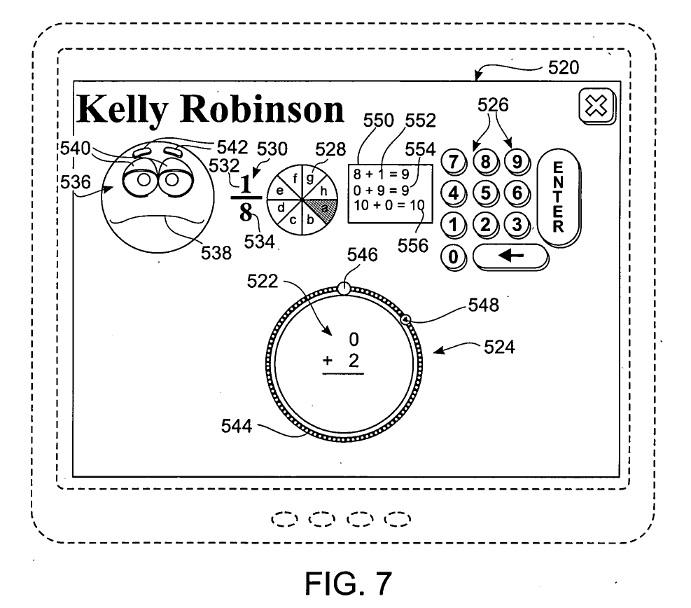

Referring now to FIG. 7, the screen display 520 is displaying a new math facts addition problem 522 (in traditional vertical format) within the timer graphic 524. The region 550 in the display 520 contains missed problems 552 (8+1=9), 554 (0+9=9), and 556 (10+0=0). Thus the problem 522 in the display 520 is not the first problem for this particular student session. The entry of the number one in the numerator 532 of the fraction 530 and the presence of a darkened pie wedge in section 528a of the pie chart 528 indicates the student has entered a single correct answer. The position of the moving arrow 548 in the timer ring 544 surrounding the current problem 522 indicates the invention awaits the student's entry of an answer to the current problem 522.

Still referring to FIG. 7, the responsive mouth 538, the responsive eyes 540, and the responsive eyebrows 542 create a relatively sad expression in the responsive face 536, thereby suggesting the student's last answer was probably incorrect (10+0=10).

Still referring to FIG. 7, the value of the denominator 534 of the fraction 530 indicates the criteria for completing the current fact practice session is 8 correct answers. The value (1) of the numerator 532 indicates the student has answered one problem correctly, so the student must answer 7 additional problems correctly to meet the fact practice ending criteria and obtain game practice time as a reward.

It will be understood by one skilled in the art that the inclusion of the pie chart 528 and the fraction 530 in the display 520 expose the student, at an early age, to these important concepts which will be introduced more directly later in the student's education. Although not shown in FIGS. 6-9, the fraction 530 will always be reduced to a simple fraction, i.e., two-eighths ( 2/8) will be displayed as one-fourth (¼), four-eighths ( 4/8) will be displayed as one-half (½), and six-eighths ( 6/8) will be displayed as three-fourths (¾).

It will be further understood by one skilled in the art that display of missed problems in the region 550 of the display 520 facilitates student learning. Studies have shown that the display of the problem (e.g., 8+1=) without the answer (9) does not promote learning. Rather, the display of the problem without the answer merely emphasizes to the student that the student does not know the answer to the particular problem. The present Method For Teaching Rapid Recall Of Facts invention displays the problem and the solution immediately after the student enters a wrong answer, thereby serving to impress the correct answer to the problem on the student in real time.

It will be further understood by one skilled in the art that the changing screen with respect to the responsive face, the pie chart, the fraction, and the location of the problem within the timer graphic serve to keep the student's interest and attention, thereby contributing to more rapid mastery of the rapid-recall facts. Moreover, research has shown that visual images are critical to embedding information in long-term memory. The visual images provided according to the present Method For Teaching Rapid Recall Of Facts invention contribute to the student's mastery of the rapid-recall facts.

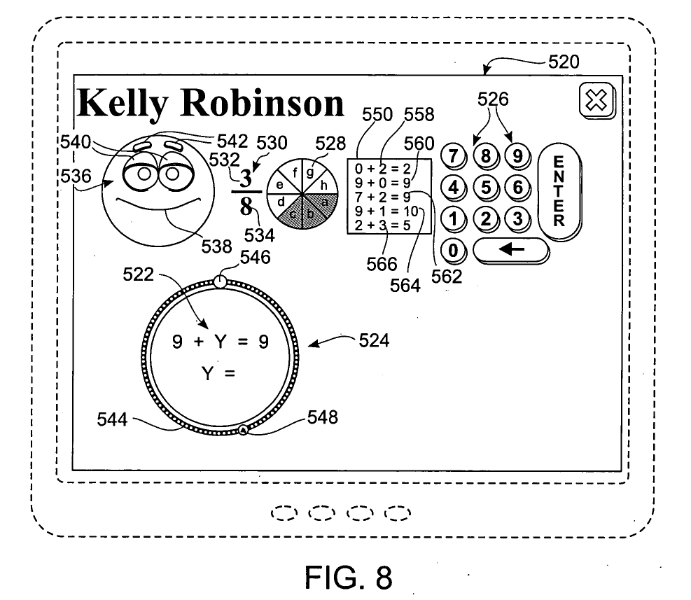

Referring now to FIG. 8, the screen display 520 is displaying a new math facts addition problem 522 (in algebraic format) within the timer graphic 524. The region 550 in the display 520 contains missed problems 558 (0+2=2), 560 (9+0=9), 562 (7+2=9), 564 (9+1=10), and 566 (2+3=5). Thus the problem 522 in the display 520 is not the first problem for this particular fact practice session. The entry of the number three in the numerator 532 of the fraction 530 and the presence of three darkened pie wedges in sections 528a, 528b, and 528c of the pie chart 528 indicates the student has entered three correct answers. The position of the moving arrow 548 in the timer ring 544 surrounding the current problem 522 indicates the invention awaits the student's entry of an answer to the current problem 522.

Still referring to FIG. 8, as compared to FIG. 7, the responsive mouth 538, the responsive eyes 540, and the responsive eyebrows 542 create a relatively happier expression in the responsive face 536, thereby suggesting the student's last answer was probably correct (and, therefore, not displayed in the region 550).

Still referring to FIG. 8, the value of the denominator 534 of the fraction 530 indicates the criteria for completing the current fact practice session is 8 correct answers. The value of the numerator 532 indicates the student has answered three problems correctly, so the student must answer five additional problems correctly to meet the fact practice ending criteria and obtain game practice time as a reward.

As previously stated, the problem 522 displayed within the timer graphic 524 in FIG. 8 is in algebraic form, whereas the addition problems 322 and 422 shown in FIGS. 6 and 7 are displayed in traditional horizontal format. This illustrates another feature of the present Method For Teaching Rapid Recall Of Facts invention. At the election of the teacher or administrator, problems can be presented in any one of several forms, including traditional horizontal form, traditional vertical form, pre-algebraic form, and algebraic form. At the election of the teacher or administrator, the form of the problem displayed to the student will vary so the student is introduced, at an early age, to various expressions of the same problem. Thus the Method For Teaching Rapid Recall Of Facts invention also prepares students for the sometimes difficult transition from arithmetic, involving primarily computational skills, to more rigorous mathematical challenges.

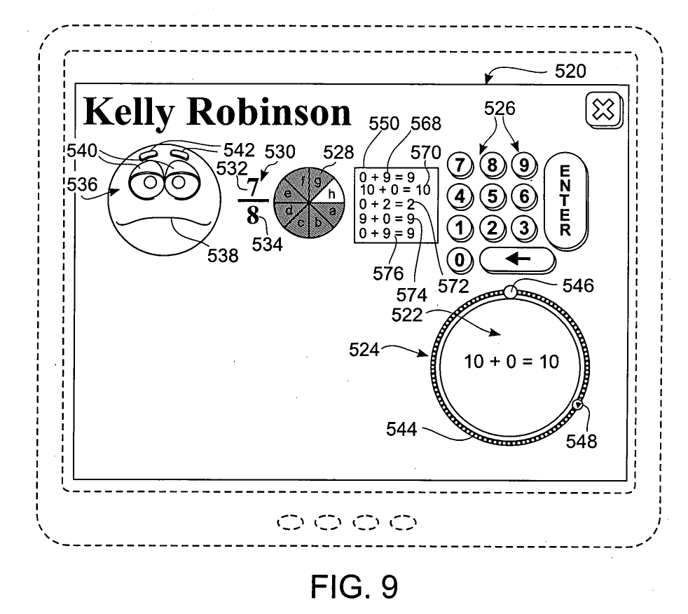

Referring now to FIG. 9, the screen display 520 is displaying a new math facts addition problem 522 (10+0=) within the timer graphic 524. The region 550 in the display 520 contains missed problems 568 (0+9=9), 570 (10+0=10), 572 (0+2=2), 574 (9+0=9), and 576 (0+9=9). Thus the problem 522 in the display 520 is not the first problem for this particular fact practice session. The entry of the number “7” in the numerator 532 of the fraction 530 and the presence of seven darkened pie wedges in sections 528a, 528b, 528c, 528d, 528e, 528f, and 528g of the pie chart 528 indicates the student has entered seven correct answers. The position of the moving arrow 548 in the timer ring 544 surrounding the current problem 522 indicates the invention awaits the student's entry of an answer to the current problem 522.

Still referring to FIG. 9, as compared to FIG. 8, the responsive mouth 538, the responsive eyes 540, and the responsive eyebrows 542 create a relatively sadder expression in the responsive face 536, thereby suggesting the student's last answer was probably incorrect (0+9=9).

Still referring to FIG. 9, the value of the denominator 534 of the fraction 530 indicates the criteria for completing the current fact practice session is 8 correct answers. The value of the numerator 532 indicates the student has answered seven problems correctly, so the student must answer only one additional problem correctly to meet the fact practice ending criteria and move to the game practice portion of the student session.

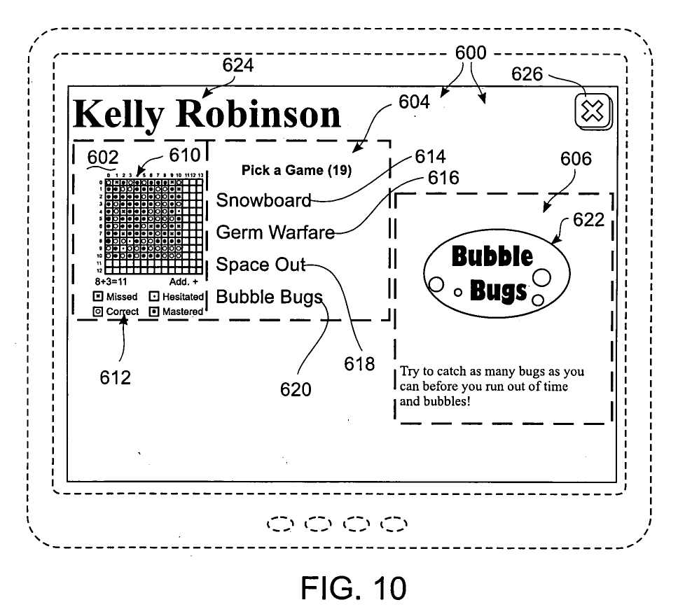

Referring now to FIG. 10, an illustration of the screen 600 displayed on the student's when the student satisfies the end-of-session criteria (8 correct answers in FIGS. 6-9) includes an interactive Student Progress Report section 602 (See further discussion regarding FIG. 39, below), a game menu section 604, and a game graphic section 606. The Student Progress Report section 602 includes a student-specific addition grid 610 showing the student's progress through the just-completed fact practice session. Each square in the grid represents an addition problem 522 (See FIGS. 6-9). As indicated by a legend 612, a missed problem (i.e., a problem to which the student gave either a wrong answer or no answer), is indicated by an “x” in the square. A correct answer (i.e., a correct answer within 3 seconds, the initial time period) is indicated by a large gray dot. An answer which was correctly entered in the second time period (i.e., after the expiration of 3 seconds and prior to the expiration of 7 seconds) is indicated by a small dot.

Still referring to FIG. 10 and to the Student Progress Report section 602, a large black dot in a square of the student-specific addition grid 610 indicates mastery of that particular problem/fact. As used in the present Method For Teaching Rapid Recall Of Facts invention, mastery means the student entered the correct answer for that particular problem within the initial 3-second time period (the rapid recall time period) on three successive occasions. Stated another way, a student has mastered a particular fact if the student had no misses in the student's last 3 attempts. Blank squares indicate problems which have not yet been presented to the student.

Referring now to FIG. 10 and the student-specific addition grid 610 in conjunction with the addition grid 100 shown in FIG. 1, it is apparent that the student whose results are presented in the student-specific addition grid 610 has not yet been introduced to Stage A4 problems (i.e., addition problems involving the numbers 11, 12, and 13). The student-specific addition grid 610 provides the student with real-time feedback on the student's continuing efforts to master addition problems from groups 114, 116, and 118 (Stages A1, A2, and A3). The graphic representation provided by the student-specific addition grid 610 will change over time as the student attains more large black dots, thereby providing a growing sense of satisfaction to the progressing student.

Still referring to the student-specific addition grid 610 in conjunction with the addition grid 100 shown in FIG. 1, the groups 114, 116, 118, and 120, corresponding to stages A1, A2, A3, and A4, respectively, are not apparent in the student-specific addition grid 610. Thus, the automatic introduction of problems in stages is invisible to the student.

Still referring to FIG. 10, the game menu section 604 provides a list of games 614, 616, 618, 620 wherein the highlighted game (selectable by mouse or keystrokes) is illustrated in a game graphic 622 appearing within the game graphic section 606. A text entry 624 identifies the student by name, and a navigation button 626 is provided to permit the student to close out the screen 600 and return to the selection screen 500 (See FIG. 5).

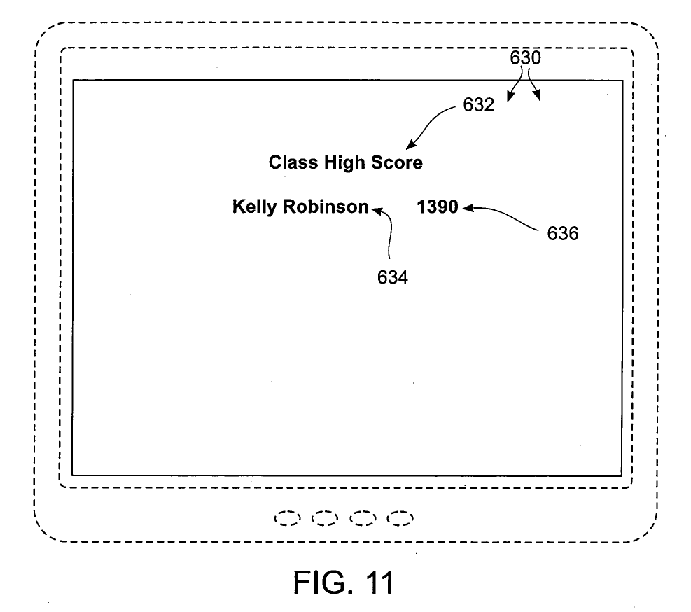

Referring now to FIG. 11, another screen display 630 includes a title 632 and a listing of the names and corresponding game scores of the students in the particular student's grade and class. In the screen display 630, the name 634 (Kelly Robinson) is shown to have a score 636 (1390) which is the highest in Kelly's grade and class. In this illustration, Kelly is the only student in Kelly's grade to play the game thus far, so Kelly has the highest (and only) score. According to the present Method For Teaching Rapid Recall Of Facts invention, the top ten students will always be listed in the list of top ten scores for the student's grade. If the group involves less than 10 participating students, all students (and their scores) will be listed.

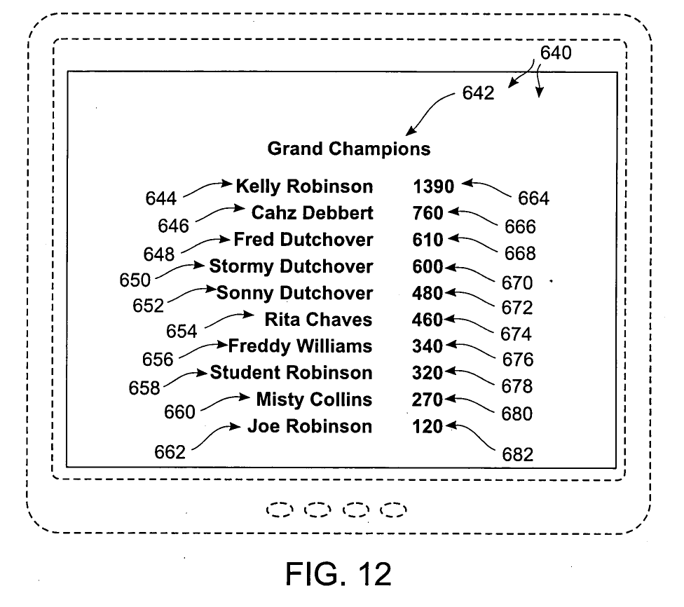

Referring now to FIG. 12, an illustration of a Grand Champions display 640 includes a title 642 and a list of the top ten scorers school-wide 644, 646, 648, 650, 652, 654, 656, 658, 660, and 662, together with their corresponding scores 664, 666, 668, 670, 672, 674, 676, 678, 680, 682, respectively, for the particular arcade-style game just completed by the student.

It will be appreciated by one skilled in the art that the arcade-style games incorporated into the present Method For Teaching Rapid Recall Of Facts invention are pure games, i.e., the arcade-style games are not additional math problems disguised as games. Game time is limited, however, and earned by the student's progress in mastering the rapid-recall facts. Thus the game time earned by the student and provided by the present method is a reward in the purest sense. As a result, students exposed to the present Method For Teaching Rapid Recall Of Facts invention are universally enthusiastic about participating in the fact practice sessions so they can earn additional game practice time.

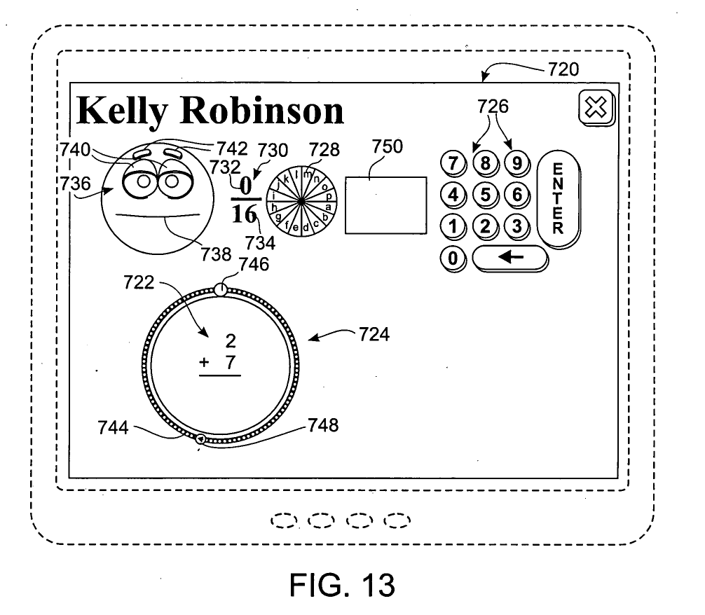

Referring now to FIG. 13, a screen display 720 is displaying a math facts addition problem 722 (in traditional vertical format) within a timer graphic 724. An on-screen number pad 726 enables entry of the answer using the mouse. If the student's computer is equipped with touch screen capabilities, the on-screen number pad 726 also functions as a touch pad, enabling the student to enter the answer by touching the numbers forming the answer and then touching the enter key on the on-screen number pad 726. A pie chart 728 has sixteen pie-chart segments 728a, 728b, 728c, 728d, 728e, 728f, 728g, 728h, 728i, 728j, 728k, 728l, 728m, 728n, 728o, and 728p. A fraction 730 has a numerator 732 and a denominator 734. A responsive face 736 includes a responsive mouth 738, responsive eyes 740, and responsive eyebrows 742.

Still referring to FIG. 13, a timer graphic 724 has a timer ring 744 which moves from a starting point 746 clockwise 360 degrees back to the starting point 746 to indicate the passage of time. The timer ring 744 measures two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 748 within the timer ring 744 indicates the passage of time within each time period.

Referring again to FIG. 13, a region 750 in the display 720 is dedicated for display of missed problems. In FIG. 13, it is apparent that the problem 722 in the display 720 is the first problem for this particular fact practice session. The entry of the number zero in the numerator 732 of the fraction 730 and the absence of a darkened pie wedge in the pie chart 728 indicate the student has not yet entered a correct answer. The absence of the correct answer in the region 750 indicates the student has not yet entered a wrong answer. The position of the moving arrow 748 in the timer ring 744 indicates the elapse of about half the time for the particular time period.

Still referring to FIG. 13, the value of the denominator 734 of the fraction 730 is 16, indicating the criteria for completing the current fact practice session is 16 correct answers. The value of the numerator 732 indicates the student has not yet answered a problem, so the student must answer 16 problems correctly to meet the end-of-session criteria and obtain a reward (playing time in an arcade-style game).

It will be understood by one skilled in the art that the value of the denominator 734 can be altered by the teacher or administrator to shift the balance between fact practice and game practice. In FIGS. 6-9, the denominator 534 is assigned a value of 8, thus requiring 8 correct answers (i.e., the answer to the problem entered within 3 seconds) to earn playing time in an arcade-style game. For students in early grades, a requirement of 8 correct answers is typical. The value of 16 for the denominator 734 is more appropriate for students in grade levels four and above. As the value of the denominator increases, the balance between fact practice and game practice is shifted toward fact practice. As the value of the denominator decreases, the balance between fact practice and game practice is shifted toward game practice. Based on student progress, the teacher or administrator can alter the value of the denominator and, thereby, adjust the balance between fact practice and game practice.

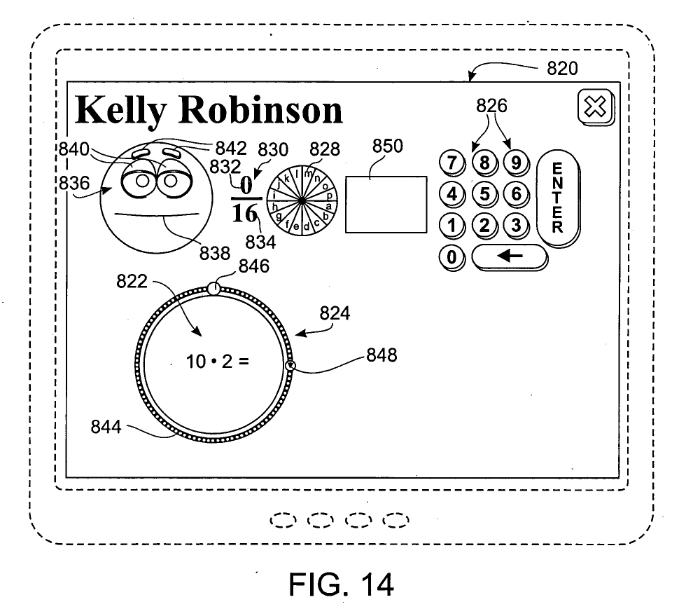

Referring now to FIG. 14, a screen display 820 is displaying a math facts multiplication problem 822 within a timer graphic 824. An on-screen number pad 826 enables entry of the answer using the mouse. If the student's computer is equipped with touch screen capabilities, the on-screen number pad 826 also functions as a touch pad, enabling the student to enter the answer by touching the numbers forming the answer and then touching the enter key on the on-screen number pad 826. A pie chart 828 has sixteen pie-chart segments 828a, 828b, 828c, 828d, 828e, 828f, 828g, 828h, 828i, 828j, 828k, 828l, 828m, 828n, 828o, and 828p. A fraction 830 has a numerator 832 and a denominator 834. A responsive face 836 includes a responsive mouth 838, responsive eyes 840, and responsive eyebrows 842.

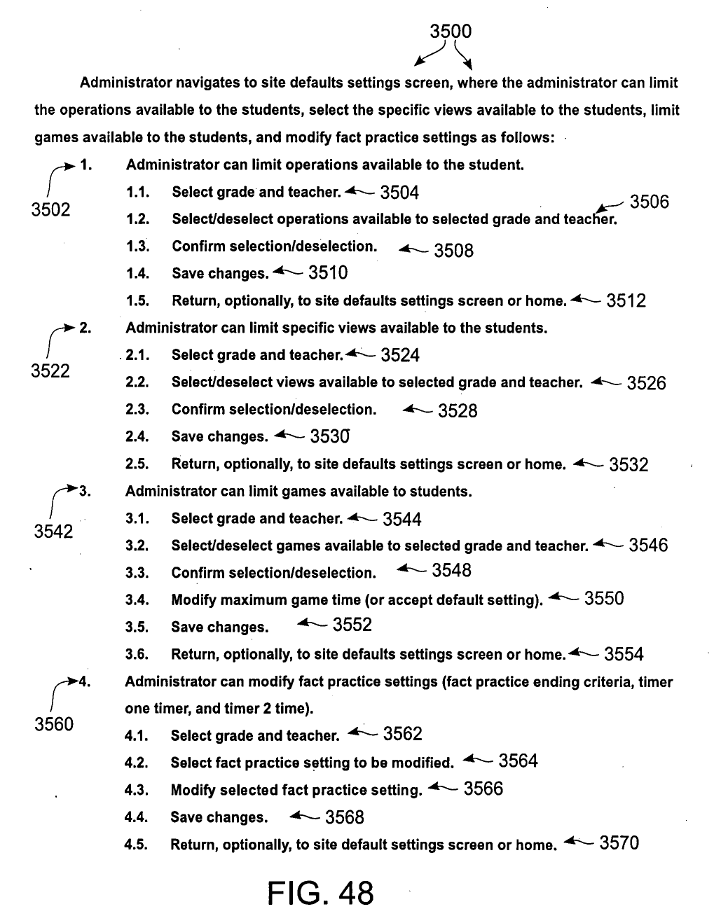

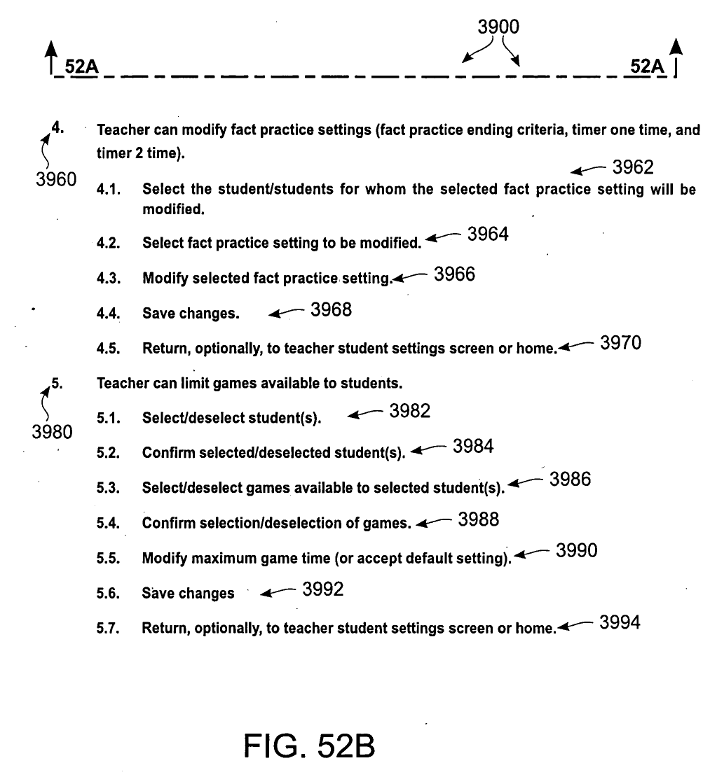

Still referring to FIG. 14, a timer graphic 824 has a timer ring 844 which moves from a starting point 846 clockwise 360 degrees back to the starting point 946 to indicate the passage of time. The timer ring 844 measures two pre-set time periods—a first rapid recall elapsed time period and a second time period. In the presently preferred embodiment of applicant's Method For Teaching Rapid Recall Of Facts invention, the first time period is three seconds and the second time period is four seconds. The pre-set time periods can be varied at the election of the administrator (See FIG. 48) or teacher (See FIG. 52) based on special circumstances, however. For example, a special education student having relatively poorer small motor skills may require 6 seconds to enter an answer from rapid recall memory using the touch pad, so the teacher has the option of changing the pre-set first rapid recall elapsed time period to 6 seconds or another time period based on the teacher's observation. Similarly, the teacher may change the second time period (wherein correct answers are derived from the student's long-term memory) to 10 seconds or more. A moving arrow 848 within the timer ring 844 indicates the passage of time within each time period.

Referring again to FIG. 14, a region 850 in the display 820 is dedicated for display of missed problems. In FIG. 14, it is apparent that the problem 822 in the display 820 is the first problem for this particular fact practice session. The entry of the number zero in the numerator 832 of the fraction 830 and the absence of a darkened pie wedge in the pie chart 828 indicate the student has not yet entered a correct answer. The absence of the correct answer in the region 850 indicates the student has not yet entered a wrong answer. The position of the moving arrow 848 in the timer ring 844 indicates the elapse of about one-fourth the time for the particular time period.

Still referring to FIG. 14, the value of the denominator 834 of the fraction 830 is 16, indicating the criteria for completing the current fact practice session is 16 correct answers. The value of the numerator 832, together with the absence of wedges in the pie chart 828 and the absence of problems answered improperly in the region 850, indicates the student has not yet answered a problem. The student must answer 16 problems correctly to meet the fact practice ending criteria and obtain game practice time in an arcade-style game as a reward.

Still referring to FIG. 14, the problem 822 is displayed in algebraic format, illustrating the capacity of the present Method For Teaching Rapid Recall Of Facts invention to vary the format of the problems, thereby exposing the student to various forms of mathematical notation.

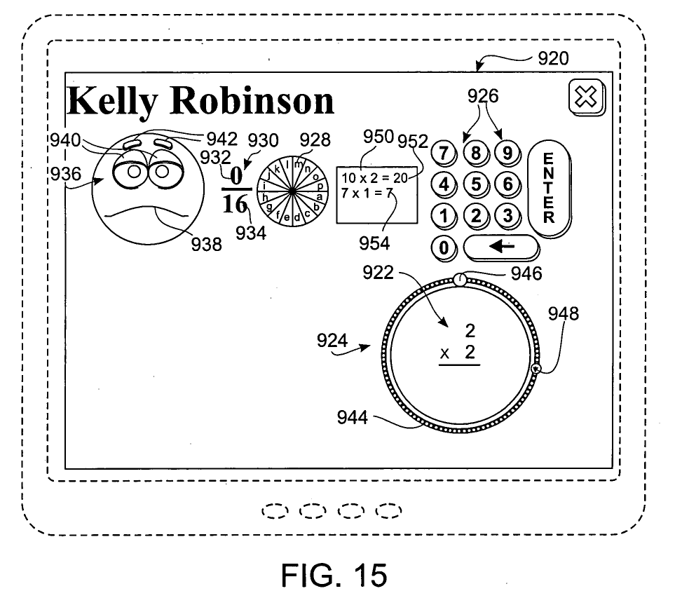

Referring now to FIG. 15, a screen display 920 is displaying a math facts multiplication problem 922 within a timer graphic 924. An on-screen number pad 926 enables entry of the answer using the mouse. If the student's computer is equipped with touch screen capabilities, the on-screen number pad 926 also functions as a touch pad, enabling the student to enter the answer by touching the numbers forming the answer and then touching the enter key on the on-screen number pad 926. A pie chart 928 has sixteen pie-chart segments 928a, 928b, 928c, 928d, 928e, 928f, 928g, 928h, 928i, 928j, 928k, 928l, 928m, 928n, 928o, and 928p. A fraction 930 has a numerator 932 and a denominator 934. A responsive face 936 includes a responsive mouth 938, responsive eyes 940, and responsive eyebrows 942.

Still referring to FIG. 15, a timer graphic 924 has a timer ring 944 which moves from a starting point 946 clockwise 360 degrees back to the starting point 946 to indicate the passage of time. The timer ring 944 measures two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 948 within the timer ring 944 indicates the passage of time within each time period.

Referring again to FIG. 15, a region 950 in the display 920 is dedicated for display of missed problems. In FIG. 15, it is apparent that the problem 922 in the display 920 is the first problem for this particular fact practice session. The entry of the number zero in the numerator 932 of the fraction 930 and the absence of a darkened pie wedge in the pie chart 928 indicate the student has not yet entered a correct answer. The presence of two correct answers (to missed problems) in the region 950 indicates the student has entered two wrongs answers. The position of the moving arrow 948 in the timer ring 944 indicates the elapse of about one-fourth the time for the particular time period.

Still referring to FIG. 15, the value of the denominator 934 of the fraction 930 is 16, indicating the criteria for completing the current fact practice session is 16 correct answers. The value of the numerator 932, together with the absence of wedges in the pie chart 928 and the absence of problems answered improperly in the region 950, indicates the student has not yet answered a problem correctly. The student must answer 16 problems correctly to meet the fact practice ending criteria and obtain a reward (game practice time in an arcade-style game).

Still referring to FIG. 15, the multiplication problem 922 is displayed in traditional vertical format, illustrating the capacity of the present Method For Teaching Rapid Recall Of Facts invention to vary the format of the problems, thereby exposing the student to various forms of mathematical notation.

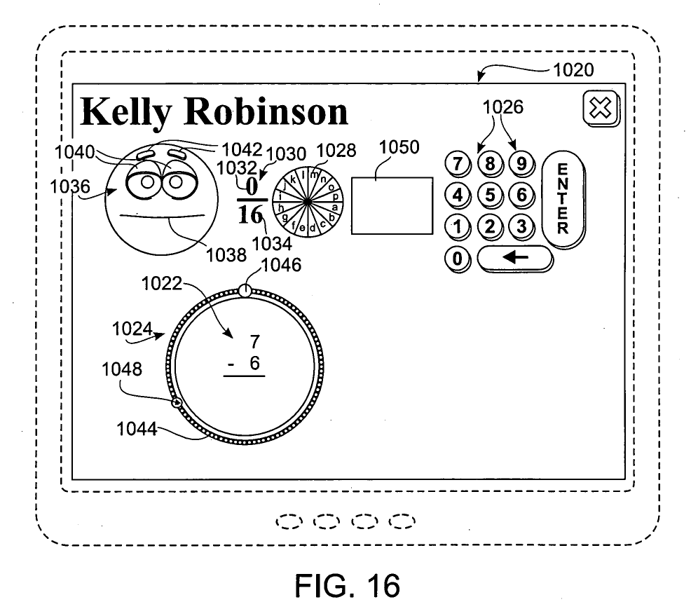

Referring now to FIG. 16, a screen display 1020 is displaying a math facts subtraction problem 1022 (in traditional vertical format) within a timer graphic 1024. An on-screen number pad 1026 enables entry of the answer using the mouse. If the student's computer is equipped with touch screen capabilities, the on-screen number pad 1026 also functions as a touch pad, enabling the student to enter the answer by touching the numbers forming the answer and then touching the enter key on the on-screen number pad 1026. A pie chart 1028 has sixteen pie-chart segments 1028a, 1028b, 1028c, 1028d, 1028e, 1028f, 1028g, 1028h, 1028i, 1028j, 1028k, 1028l, 1028m, 1028n, 1028o, and 1028p. A fraction 1030 has a numerator 1032 and a denominator 1034. A responsive face 1036 includes a responsive mouth 1038, responsive eyes 1040, and responsive eyebrows 1042.

Still referring to FIG. 16, a timer graphic 1024 has a timer ring 1044 which moves from a starting point 1046 clockwise 360 degrees back to the starting point 1046 to indicate the passage of time. The timer ring 1044 measures two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 1048 within the timer ring 1044 indicates the passage of time within each time period.

Referring again to FIG. 16, a region 1050 in the display 1020 is dedicated for display of missed subtraction problems. In FIG. 16, it is apparent that the problem 1022 in the display 1020 is the first subtraction problem for this particular student session. The entry of the number zero in the numerator 1032 of the fraction 1030 and the absence of a darkened pie wedge in the pie chart 1028 indicate the student has not yet entered a correct answer. The absence of a correct answer in the region 1050 indicates the student has not yet entered a wrong answer. The position of the moving arrow 1048 in the timer ring 1044 indicates the elapse of over one-half the total time for the particular time period.

Still referring to FIG. 16, the value of the denominator 1034 of the fraction 1030 is 16, indicating the criteria for completing the current fact practice session is 16 correct answers. The value of the numerator 1032, together with the absence of wedges in the pie chart 1028 and the absence of subtraction problems answered improperly in the region 1050, indicates the student has not yet answered a problem. The student must answer 16 subtraction problems correctly to meet the fact practice ending criteria and obtain a reward (game practice time in an arcade-style game).

Still referring to FIG. 16, the subtraction problem 1022 is displayed in traditional vertical format, illustrating the capacity of the present Method For Teaching Rapid Recall Of Facts invention to vary the format of the problems, thereby exposing the student to various forms of mathematical notation.

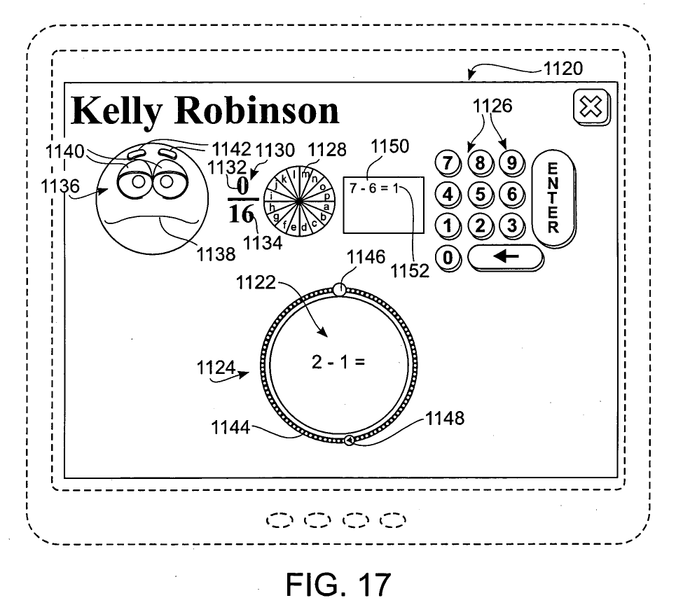

Referring now to FIG. 17, a screen display 1120 is displaying a math facts subtraction problem 1122 (in traditional horizontal format) within a timer graphic 1124. An on-screen number pad 1126 enables entry of the answer using the mouse. If the student's computer is equipped with touch screen capabilities, the on-screen number pad 1126 also functions as a touch pad, enabling the student to enter the answer by touching the numbers forming the answer and then touching the enter key on the on-screen number pad 1126. A pie chart 1128 has sixteen pie-chart segments 1128a, 1128b, 1128c, 1128d, 1128e, 1128f, 1128g, 1128h, 1128i, 1128j, 1128k, 1128l, 1128m, 1128n, 1128o, and 1128p. A fraction 1130 has a numerator 1132 and a denominator 1134. A responsive face 1136 includes a responsive mouth 1138, responsive eyes 1140, and responsive eyebrows 1142.

Still referring to FIG. 17, a timer graphic 1124 has a timer ring 1144 which moves from a starting point 1146 clockwise 360 degrees back to the starting point 1146 to indicate the passage of time. The timer ring 1144 measures two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 1148 within the timer ring 1144 indicates the passage of time within each time period.

Referring again to FIG. 17, a region 1150 in the display 1120 is reserved for display of missed subtraction problems. In FIG. 17, it is apparent that the problem 1122 in the display 1120 is not the first subtraction problem for this particular fact practice session. The entry of the number zero in the numerator 1132 of the fraction 1130 and the absence of a darkened pie wedge in the pie chart 1128 indicate the student has not yet entered a correct answer. The presence of a problem (complete with correct answer) 1152 in the region 1150 indicates the student has answered one subtraction problem incorrectly. The position of the moving arrow 1148 in the timer ring 1144 indicates the elapse of about one-half the total time for the particular time period.

Still referring to FIG. 17, the value of the denominator 1134 of the fraction 1130 is 16, indicating the criteria for completing the current fact practice session is 16 correct answers. The value of the numerator 1132, together with the absence of wedges in the pie chart 1128 and the presence of a subtraction problem answered improperly in the region 1150, indicates the student has not yet answered a problem (7−6=1) correctly but has answered one problem incorrectly. The student must answer 16 subtraction problems correctly to meet the fact practice ending criteria and obtain a reward (playing time in an arcade-style game).

Still referring to FIG. 17, the subtraction problem 1122 is displayed in traditional horizontal format, illustrating the capacity of the present Method For Teaching Rapid Recall Of Facts invention to vary the format of the problems, thereby exposing the student to various forms of mathematical notation.

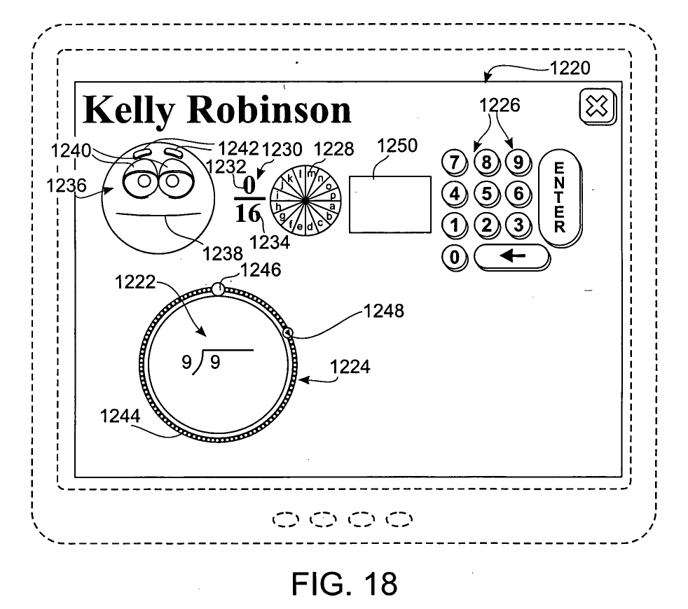

Referring now to FIG. 18, a screen display 1220 is displaying a math facts division problem 1222 within a timer graphic 1224. An on-screen number pad 1226 enables entry of the answer using the mouse. If the student's computer is equipped with touch screen capabilities, the on-screen number pad 1226 also functions as a touch pad, enabling the student to enter the answer by touching the numbers forming the answer and then touching the enter key on the on-screen number pad 1226. A pie chart 1228 has sixteen pie-chart segments 1228a, 1228b, 1228c, 1228d, 1228e, 1228f, 1228g, 1228h, 1228i, 1228j, 1228k, 1228l, 1228m, 1228n, 1228o, and 1228p. A fraction 1230 has a numerator 1232 and a denominator 1234. A responsive face 1236 includes a responsive mouth 1238, responsive eyes 1240, and responsive eyebrows 1242.

Still referring to FIG. 18, a timer graphic 1224 has a timer ring 1244 which moves from a starting point 1246 clockwise 360 degrees back to the starting point 1246 to indicate the passage of time. The timer ring 1244 measures two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 1248 within the timer ring 1244 indicates the passage of time within each time period.

Referring again to FIG. 18, a region 1250 in the display 1220 is reserved for display of missed division problems. In FIG. 18, it is apparent that the problem 1222 in the display 1220 is the first division problem for this particular fact practice portion of a student session. The entry of the number zero in the numerator 1232 of the fraction 1230 and the absence of a darkened pie wedge in the pie chart 1228 indicate the student has not yet entered a correct answer. The absence of a correct answer to a missed problem in the region 1250 indicates the student has not answered any division problems incorrectly. The position of the moving arrow 1248 in the timer ring 1244 indicates the elapse of a little less than one-fourth the total time for the particular time period.

Still referring to FIG. 18, the value of the denominator 1234 of the fraction 1230 is 16, indicating the criteria for completing the current fact practice session is 16 correct answers. The value of the numerator 1232, together with the absence of wedges in the pie chart 1228 and the absence of division problems answered improperly in the region 1250, indicate the division problem 1222 displayed is the first problem. The student must answer 16 division problems correctly to meet the fact practice end-of-session criteria and obtain a reward (playing time in an arcade-style game).

Still referring to FIG. 18, the division problem 1222 is displayed in one of several available formats (e.g., 9÷9=1, 9/9=N, 9/N=1), illustrating the capacity of the present Method For Teaching Rapid Recall Of Facts invention to vary the format of the problems, thereby exposing the student to various forms of mathematical notation.

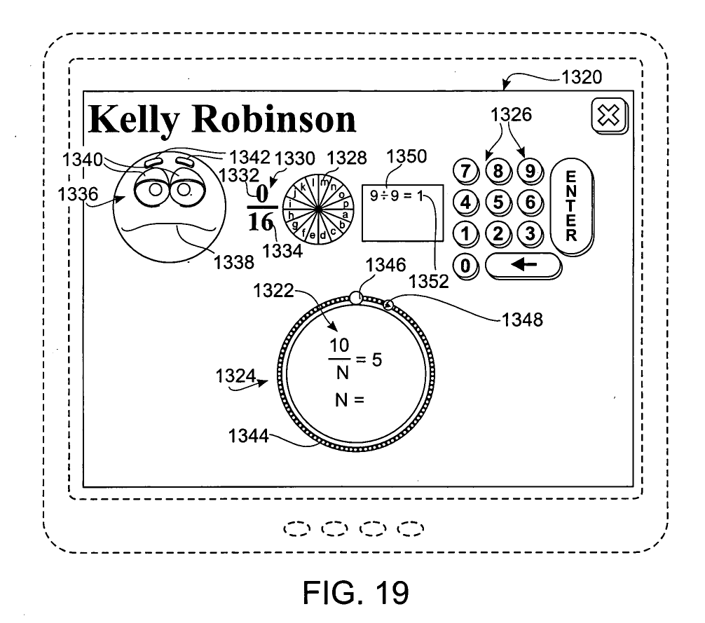

Referring now to FIG. 19, a screen display 1320 is displaying another math facts division problem 1322 within a timer graphic 1324. An on-screen number pad 1326 enables entry of the answer using the mouse. If the student's computer is equipped with touch screen capabilities, the on-screen number pad 1326 also functions as a touch pad, enabling the student to enter the answer by touching the numbers forming the answer and then touching the enter key on the on-screen number pad 1326. A pie chart 1328 has sixteen pie-chart segments 1328a, 1328b, 1328c, 1328d, 1328e, 1328f, 1328g, 1328h, 1328i, 1328j, 1328k, 1328l, 1328m, 1328n, 1328o, and 1328p. A fraction 1330 has a numerator 1332 and a denominator 1334. A responsive face 1336 includes a responsive mouth 1338, responsive eyes 1340, and responsive eyebrows 1342.

Still referring to FIG. 19, a timer graphic 1324 has a timer ring 1344 which moves from a starting point 1346 clockwise 360 degrees back to the starting point 1346 to indicate the passage of time. The timer ring 1344 measures two pre-set time periods—a first rapid recall elapsed time period and a second time period. In the presently preferred embodiment of applicant's Method For Teaching Rapid Recall Of Facts invention, the first time period is three seconds and the second time period is four seconds. A moving arrow 1348 within the timer ring 1344 indicates the passage of time within each time period.

Referring again to FIG. 19, a region 1350 in the display 1320 is reserved for display of missed division problems. In FIG. 19, it is apparent that the division problem 1322 in the display 1320 is not the first division problem for this particular fact practice session. The entry of the number zero in the numerator 1332 of the fraction 1330 and the absence of a darkened pie wedge in the pie chart 1328 indicate the student has not yet entered a correct answer. The presence of a division problem (complete with answer) 1352 in the region 1350 indicates the student has answered one division problem incorrectly. The position of the moving arrow 1348 in the timer ring 1344 indicates the elapse of about one-half the total time for the particular time period.

Still referring to FIG. 19, the value of the denominator 1334 of the fraction 1330 is 16, indicating the criteria for completing the current fact practice session is 16 correct answers. The value of the numerator 1332, together with the absence of wedges in the pie chart 1328 and the absence of division problems answered improperly in the region 1350, indicates the student has not yet answered a problem correctly. The student must answer 16 division problems correctly to meet the fact practice end-of-session criteria and obtain a reward (playing time in an arcade-style game).

Still referring to FIG. 19, the division problem 1322 is displayed in algebraic format, illustrating the capacity of the present Method For Teaching Rapid Recall Of Facts invention to vary the format of the problems, thereby exposing the student to various forms of mathematical notation.

Turning now from the student interface, the present Method For Teaching Rapid Recall Of Facts invention provides student-specific and generalized reports for students, teachers, and administrators. In addition, the present Method provides student-specific study aids, student-specific teaching aids, and student-specific teacher diagnostic reports. Finally, the Method For Teaching Rapid Recall Of Facts provides invention tracking reports for classes, grades, schools, and entire school districts. Whether for an individual student or a large group of students, the study aids, teaching aids, diagnostic tools, and tracking reports are on-demand and real-time, i.e., the teaching aids, diagnostic tools, and tracking reports can be generated at any time at the request of the teacher or administrator. The teaching aids, diagnostic tools, and tracking reports are current as of the most recent student session. A student and the student's parents have access to study aids and Student Progress reports for that student only. A teacher normally has access to study aids, teaching aids, diagnostic tools, and tracking reports only for that particular teacher's students. Administrators normally have access to all information and reports regarding all students, all teachers, and all classes.

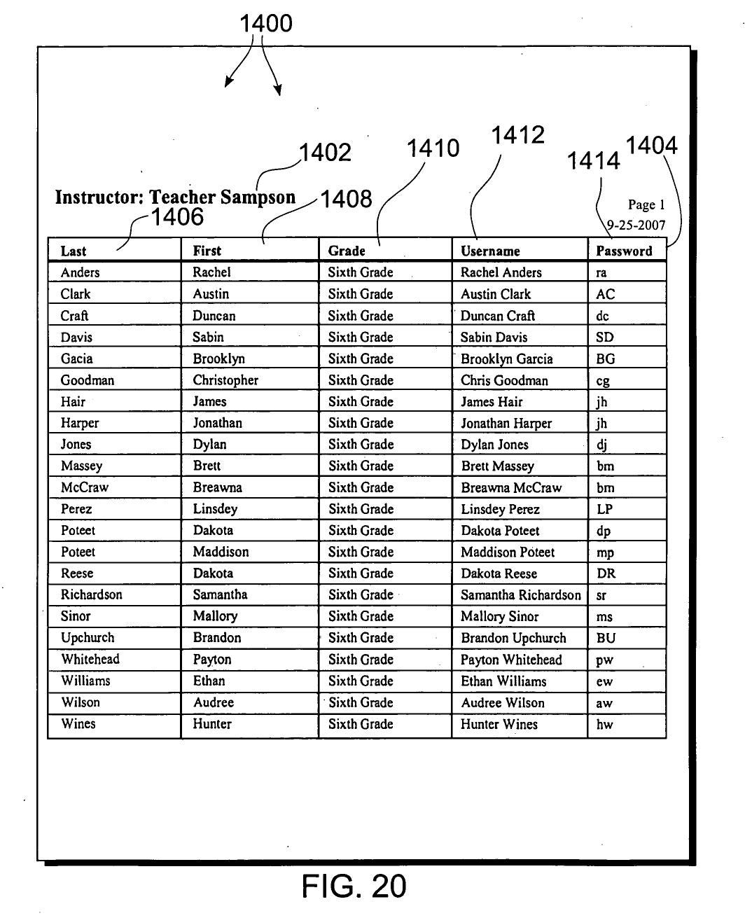

Referring now to FIG. 20, an illustration of a Student User Report 1400 provides information relating to a particular class of students. The User Report 1400 contains teacher identifying text 1402 (Teacher Sampson), a report date 1404 (9-25-2007), a student last name column heading 1406 (Last), a student first name column heading 1408 (First), a Grade column heading 1410, a User name column heading 1412, and a Password column heading 1414. Information corresponding to the column headings is provided for each student in the class.

Still referring to FIG. 20, the Student User Report 1400 has great value when a class of students goes to a computer lab for student sessions. Invariably, one or more students forgets a user name or password. The on-demand, real-time Student User Report 1400 provides the teacher with the necessary information to assist the students in the computer lab. The Student User Report 1400 contains information originally entered by a teacher or administrator.

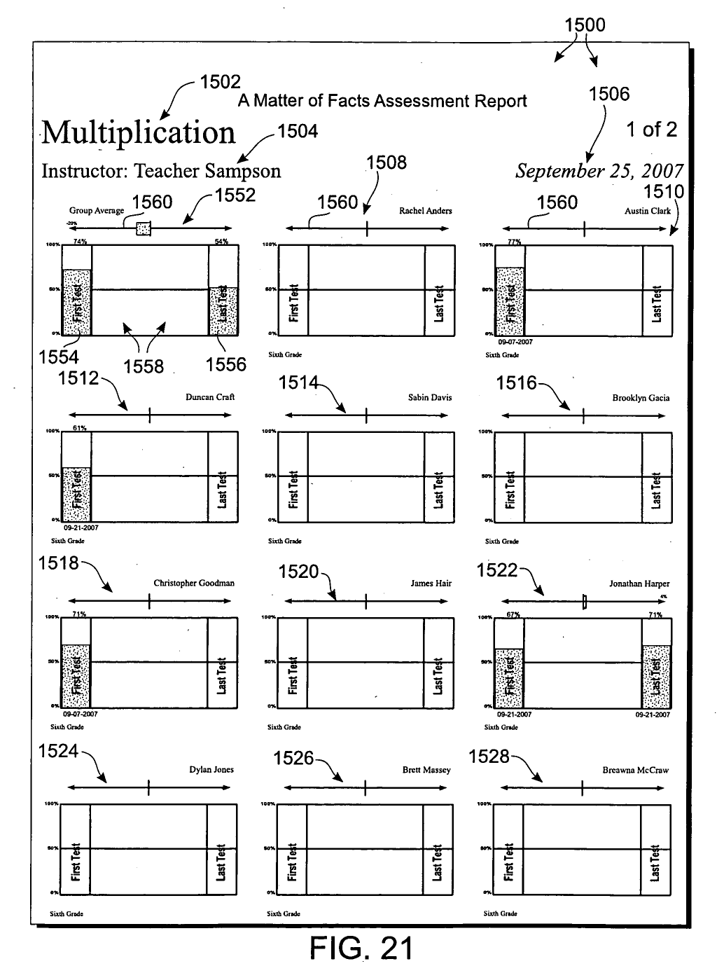

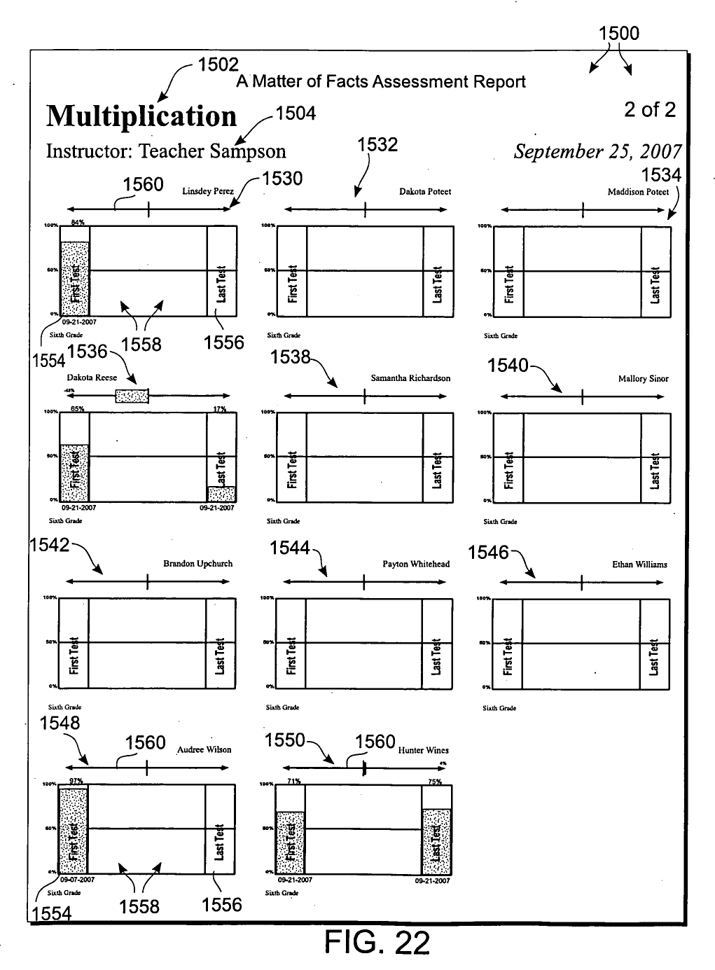

Referring now to FIGS. 21-22, a 2-page Assessment Report 1500 provided by the present Method For Teaching Rapid Recall Of Facts includes identifying text indicating the operation 1502 (multiplication), the class instructor 1504 (Mr. Sampson), and the report date 1506 (Sep. 25, 2007). Student-specific graphic representations 1508, 1510, 1512, 1514, 1516, 1518, 1520, 1522, 1524, 1526, 1528, 1530, 1532, 1534, 1536, 1538, 1540, 1542, 1544, 1546, 1548, and 1550 show the progress of students Rachel Anders, Austin Clark, Duncan Craft, Sabin Davis, Brooklyn Gacia, Christopher Goodman, James Hair, Jonathan Harper, Dylan Jones, Brett Massey, Breawna McCraw, Linsdey Perez, Dakota Poteet, Maddison Poteet, Dakota Reese, Samantha Richardson, Mallory Sinor, Brandon Upchurch, Payton Whitehead, Ethan Williams, AudreeWilson, and Hunter Wines, respectively (the same students listed in the Student User Report 1400 of FIG. 20). In addition, a graphic representation 1552 shows the progress of the teacher-selected group as a whole. Depending on the interest and purpose of the Assessment Report 1500, the reference group may be the students' class (Sampson), a grade level at a particular school, a grade level at all schools in the school district, all students at a particular school, or all students in the school district. The Assessment Report 1500 can be generated at any time by an authorized teacher or administrator, and the information contained in the Assessment Report 1500 is current through the most recent student assessment.

In the Assessment Report 1500 illustrated in FIGS. 21-22, each student-specific graphic representation shows, on a vertical scale, the results of a First Assessment Test 1554 (“First Test”), the results of the most recent assessment 1556 (“Last Test”), and the results of intervening assessments (none shown) in the space 1558 between the results of the First Assessment Test 1554 and the results of the most recent assessment 1556. The change between the First Test results 1554 and the Last Test results 1556 are summarized by a horizontal graphic representation 1560. The results of the First Test 1554, the results of intervening assessments, the results of the Last Test 1556, and the horizontal graphic representation 1560 showing the change between the First Test results 1554 and the Last Test results 1556 are also displayed for the Group 1552.

It will be understood by one skilled in the art that, due to absences or other reasons, not every student will have taken the same number of assessments. Yet the Assessment Report 1500 is an important teaching and tracking tool for teachers and administrators.

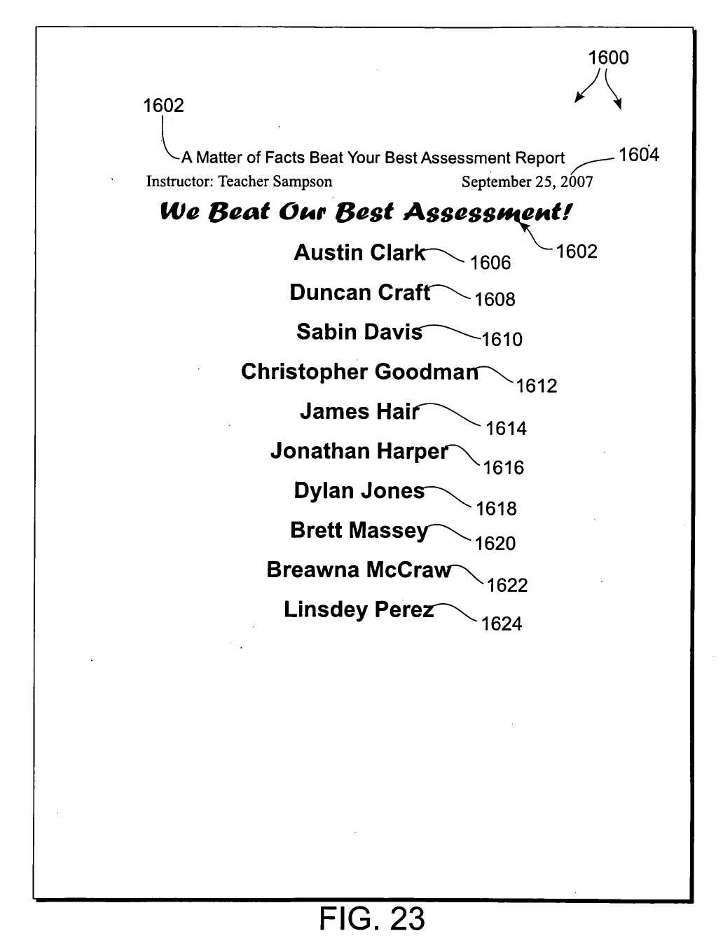

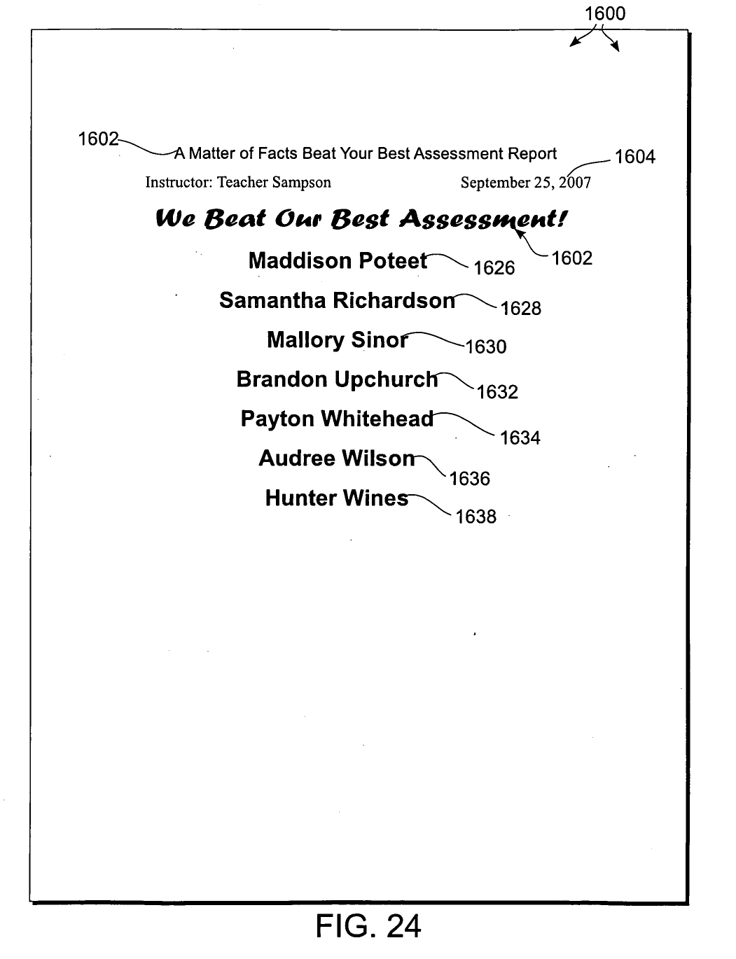

Referring now to FIGS. 23-24, a 2-page “We Beat Our Best Assessment!” report 1600 contains a title 1602 and a report date 1604, together with a listing 1606, 1608, 1610, 1612, 1614, 1616, 1618, 1620, 1622, 1624, 1626, 1628, 1630, 1632, 1634, 1636, and 1638 of each student in the class (See FIG. 20) who scored a personal best on the most recent assessment. The “We Beat Our Best Assessment!” report 1600 does not list the actual student scores because the students are not being compared to each other. Instead, the “We Beat Our Best Assessment!” report 1600 recognizes improvement. In theory, every student in the class could be recognized and appear on the “We Beat Our Best Assessment!” report 1600.

Still referring to FIGS. 23-24, the “We Beat Our Best Assessment!” report 1600 offers great opportunities for team building. The teacher can, optionally, reward each student who achieves a personal best or reward the class as a whole when the number of personal bests matches a target goal. The “We Beat Our Best Assessment!” report 1600 according to the present Method is available on-demand at the request of a teacher or administrator. The present Method For Teaching Rapid Recall Of Facts invention automatically tracks each student's performance, so the printing and posting of a “We Beat Our Best Assessment!” report 1600 requires no effort from teachers or administrators.

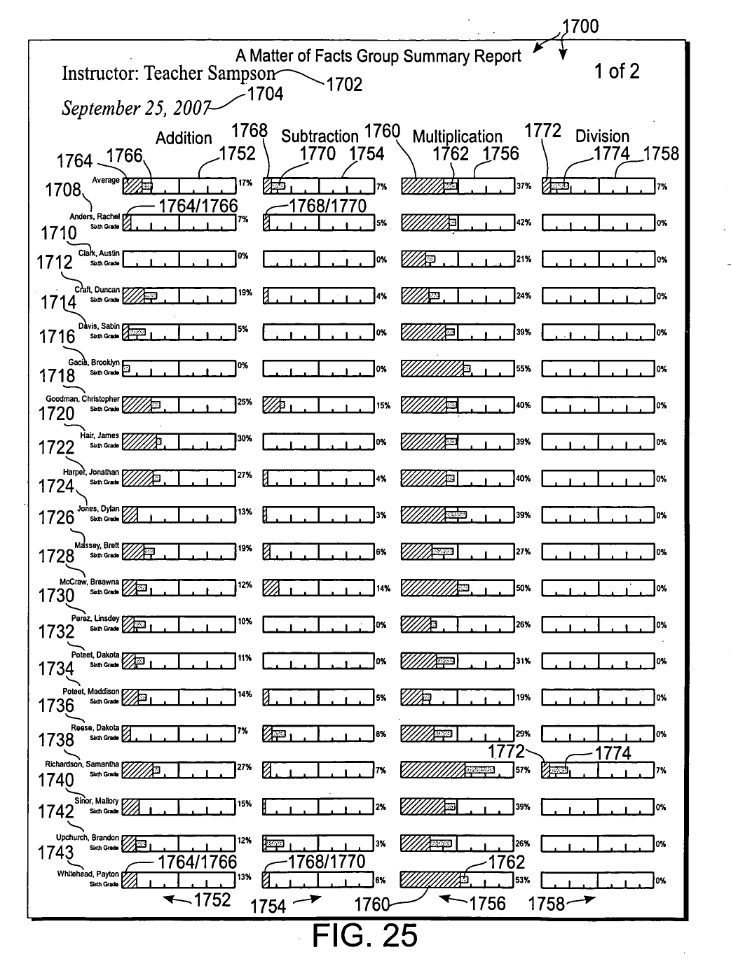

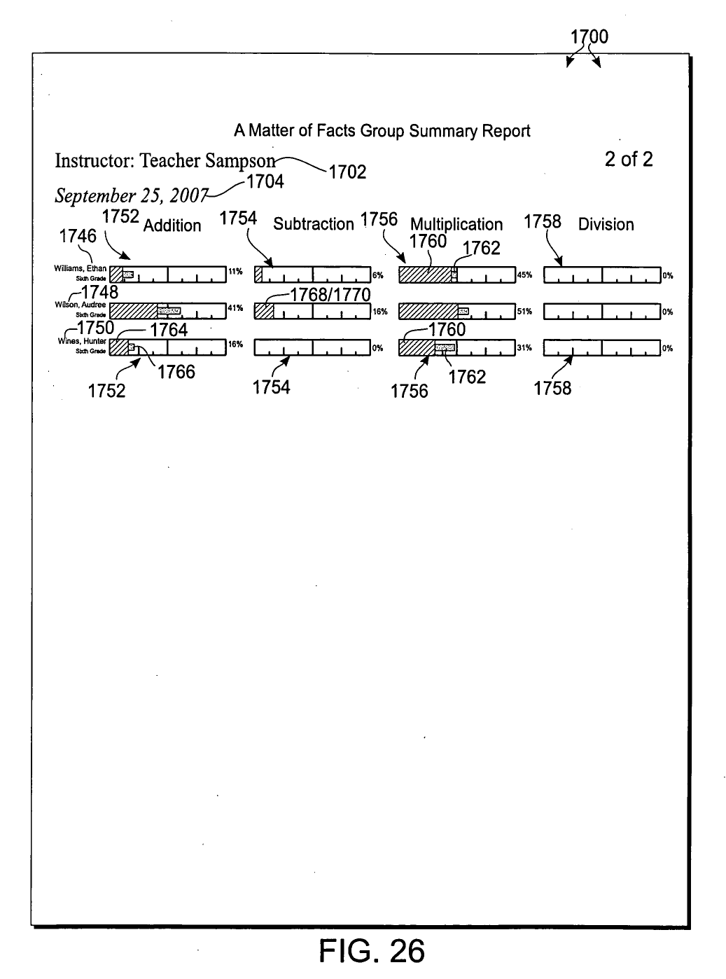

Referring now to FIGS. 25-26, illustrated therein is a 2-page Group Summary Report 1700. The Group Summary Report 1700 contains instructor identification material (text) 1702 (Sampson) and a report date 1704 (Sep. 25, 2007). The Group Summary Report 1700 is a real-time, on-demand snapshot of each student's progress in mastering rapid recall of addition, subtraction, multiplication, and division facts. Moving from top to bottom, an entry for the class average 1706 is followed by a listing of student and grade 1708 (Anders, Rachel; sixth grade), 1710 (Clark, Austin; sixth grade), 1712 (Craft, Duncan; sixth grade), 1714 (Davis, Sabin; sixth grade), 1716 (Gacia, Brooklyn; sixth grade), 1718 (Goodman, Christopher; sixth grade), 1720 (Hair, James; sixth grade), 1722 (Harper, Jonathan; sixth grade), 1724 (Jones, Dylan; sixth grade), 1726 (Massey, Brett; sixth grade), 1728 (McCraw, Breawna; sixth grade), 1730 (Perez, Linsdey; sixth grade), 1732 (Poteet, Dakota; sixth grade), 1734 (Poteet, Madison; sixth grade), 1736 (Reese, Dakota; sixth grade), 1738 (Richardson, Samantha; sixth grade), 1740 (Sinor, Mallory; sixth grade), 1742 (Upchurch, Brandon; sixth grade), 1744 (Whitehead, Payton; sixth grade), 1746 (Williams, Ethan; sixth grade), 1748 (Wilson, Audree; sixth grade), and 1750 (Wines, Hunter; sixth grade).

Still referring to FIGS. 25-26, extending to the right of each student's name are a graphic representation of the student's progress with respect to addition 1752, a graphic representation of the student's progress with respect to subtraction 1754, a graphic representation of the student's progress with respect to multiplication 1756, and a graphic representation of the student's progress with respect to division 1758.

Still referring to FIGS. 25-26 and, more specifically, to the graphic representations 1756 of student progress in mastering rapid recall of multiplication facts, each multiplication graphic 1756 contains a relatively wider horizontal band 1760 and a relatively narrower horizontal band 1762. The wider horizontal band 1760 indicates, for each student, the student's mastery of multiplication facts. The narrower horizontal band 1762, extending to the right beyond the wider horizontal band 1760, indicates the extent to which the student has answered multiplication problems correctly (i.e., a correct answer within the 3-second initial time period) but has not done so three times in a row (the definition of mastery according to the present invention). Class averages are also provided across for entry 1706 (Average).

Still referring to FIGS. 25-26 and to the multiplication graphic 1756 for entry 1708, Rachel Anders has mastered 42% of math facts multiplication problems, and Rachel answered an additional approximately 10% of the math facts multiplication problems correctly at least once as of Rachel's last student session. Referring to the multiplication graphic 1756 information for entry 1706, the class, on average, has mastered 37% of the math facts multiplication problems and answered an additional approximately 10% of the math facts multiplication problems correctly at least once.

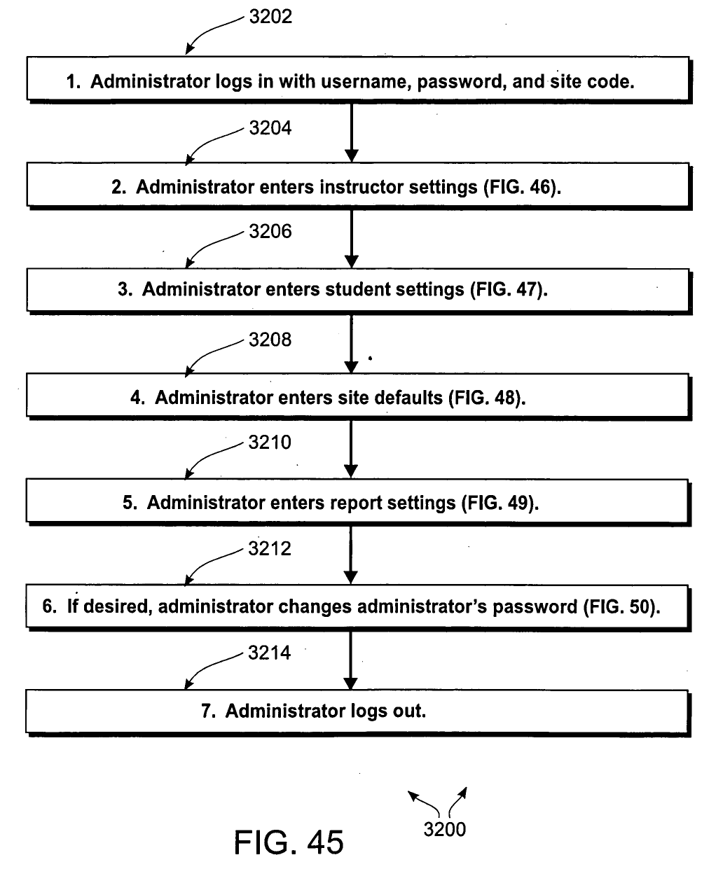

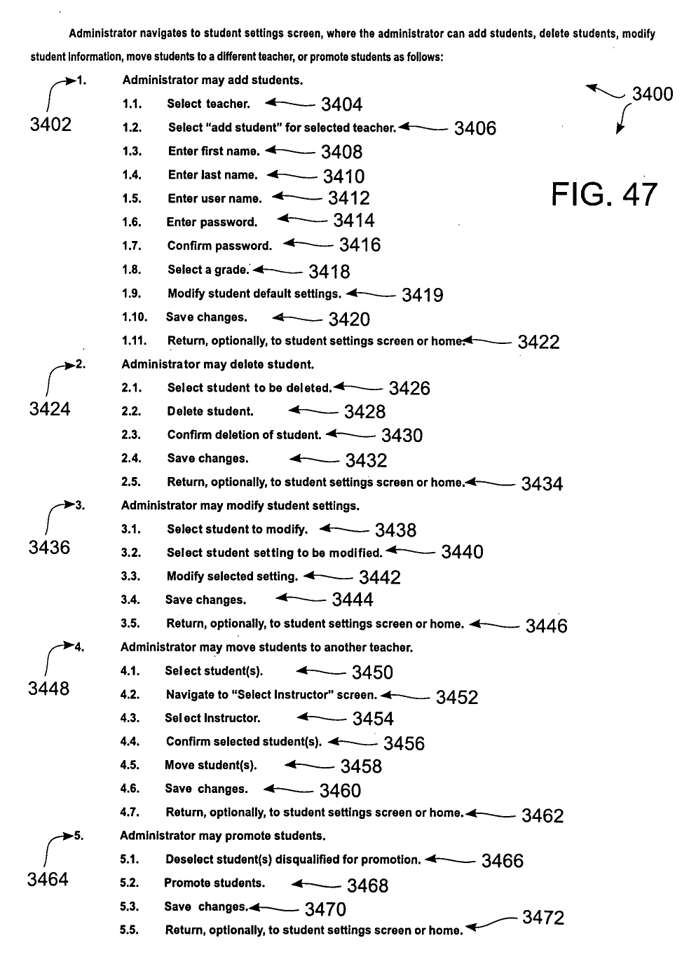

Still referring to FIGS. 25-26 and to the multiplication graphic 1756 for entry 1746 (Ethan Williams), the multiplication graphic 1756 indicates mastery of 45% of multiplication facts with little progress beyond those facts mastered. From these results, the teacher may conclude that Ethan is currently ahead of the class and is not being introduced to multiplication problems whose answers are not already in rapid recall memory. In these circumstances, the teacher may change Ethan's student settings (See FIGS. 45 and 47) so Ethan is introduced to higher stage multiplication problems.

Still referring to FIGS. 25-26 and, more specifically, to the graphic representations 1752 of student progress in mastering rapid recall of addition facts, each addition graphic 1752 contains a relatively wider horizontal band 1764 and a relatively narrower horizontal band 1766. The wider horizontal band 1764 indicates, for each student, the student's mastery of addition facts. The narrower horizontal band 1766, extending to the right beyond the wider horizontal band 1760, indicates the extent to which the student has answered addition problems correctly (i.e., a correct answer within the 3-second initial time period) but has not done so three times in a row (the definition of mastery according to the present invention). The addition graphic 1764 for the entry 1706 indicates the class averages with respect to addition problems.

Still referring to FIGS. 25-26 and, more specifically, to the graphic representations 1754 of student progress in mastering rapid recall of subtraction facts, each subtraction graphic 1752 contains a relatively wider horizontal band 1768 and a relatively narrower horizontal band 1770. The wider horizontal band 1768 indicates, for each student, the student's mastery of subtraction facts. The narrower horizontal band 1770, extending to the right beyond the wider horizontal band 1768, indicates the extent to which the student has answered subtraction problems correctly (i.e., a correct answer within the 3-second initial time period) but has not done so three times in a row (the definition of mastery according to the present invention). The subtraction graphic 1768 for the entry 1706 indicates the class averages with respect to subtraction problems.

Still referring to FIGS. 25-26 and, more specifically, to the graphic representations 1758 of student progress in mastering rapid recall of division facts, each division graphic 1758 contains a relatively wider horizontal band 1772 and a relatively narrower horizontal band 1774. The wider horizontal band 1772 indicates, for each student, the student's mastery of division facts. The narrower horizontal band 1774, extending to the right beyond the wider horizontal band 1772, indicates the extent to which the student has answered division problems correctly (i.e., a correct answer within the 3-second initial time period) but has not done so three times in a row (the definition of mastery according to the present invention). The division graphic 1758 for the entry 1706 indicates the class averages with respect to division problems.

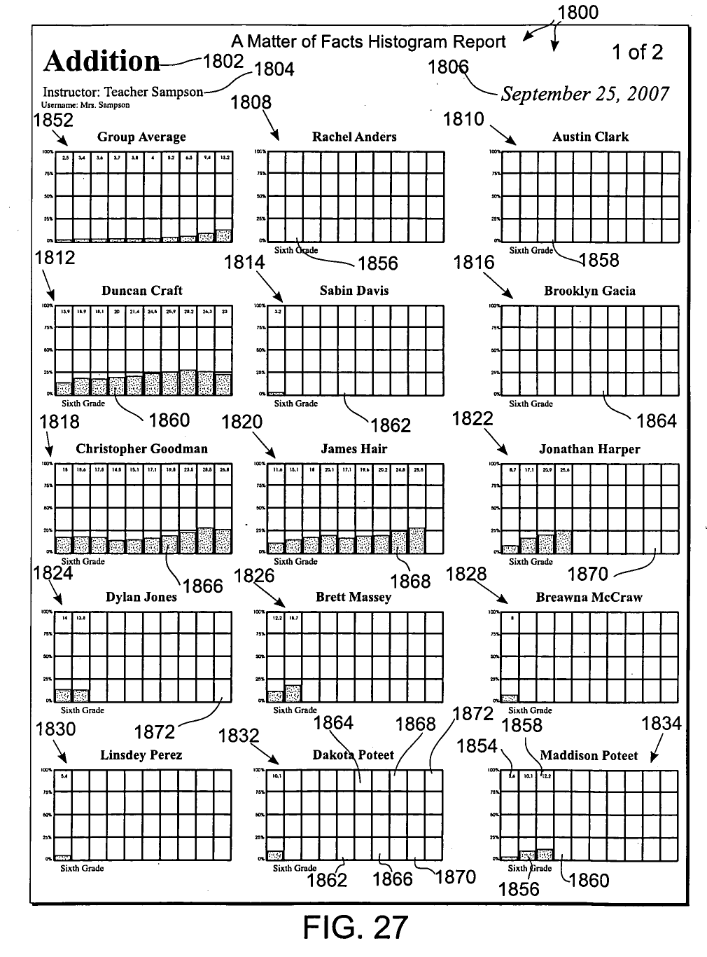

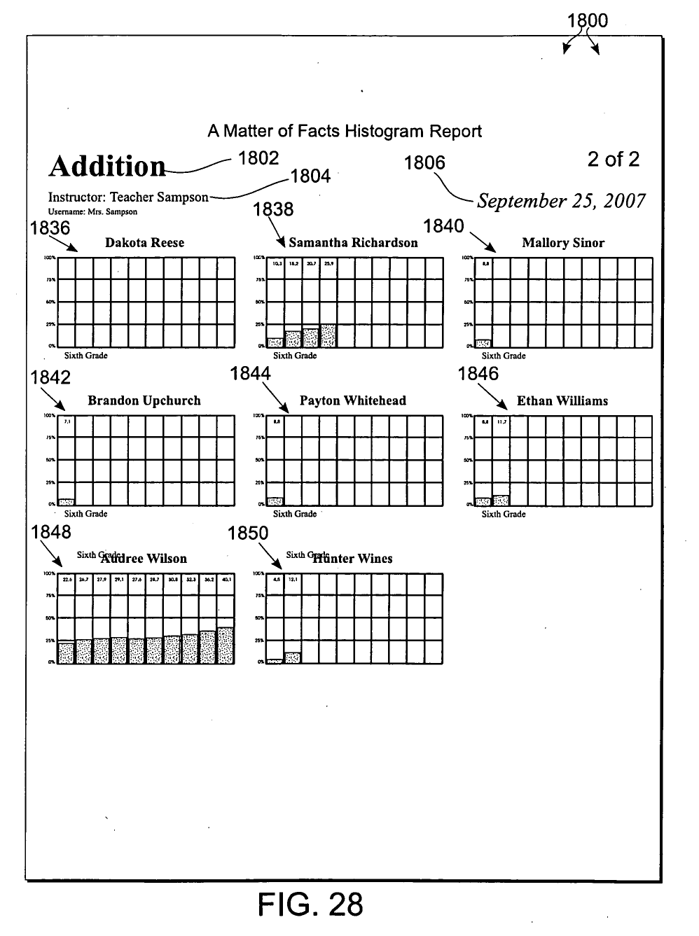

Referring now to FIGS. 27-28, a 2-page Histogram Report 1800 includes identifying information (text) indicating the operation 1802 (addition), the class instructor 1804 (Sampson), and the report date 1806 (Sep. 25, 2007). Moving from left to right and from top to bottom, an entry for the class average 1852 is followed by a listing of student and grade 1808 (Anders, Rachel; sixth grade), 1810 (Clark, Austin; sixth grade), 1812 (Craft, Duncan; sixth grade), 1814 (Davis, Sabin; sixth grade), 1816 (Gacia, Brooklyn; sixth grade), 1818 (Goodman, Christopher; sixth grade), 1820 (Hair, James; sixth grade), 1822 (Harper, Jonathan; sixth grade), 1824 (Jones, Dylan; sixth grade), 1826 (Massey, Brett; sixth grade), 1828 (McCraw, Breawna; sixth grade), 1830 (Perez, Linsdey; sixth grade), 1832 (Poteet, Dakota; sixth grade), 1834 (Poteet, Madison; sixth grade), 1836 (Reese, Dakota; sixth grade), 1838 (Richardson, Samantha; sixth grade), 1840 (Sinor, Mallory; sixth grade), 1842 (Upchurch, Brandon; sixth grade), 1844 (Whitehead, Payton; sixth grade), 1846 (Williams, Ethan; sixth grade), 1848 (Wilson, Audree; sixth grade), and 1850 (Wines, Hunter; sixth grade). Depending on the interest and purpose of the Histogram Report 1800, the reference group related to the graphic 1852 may be the student's class, a grade level at a particular school, a grade level at all schools in the school district, all students at a particular school, or all students in the school district. The Histogram Report 1800 can be generated at any time by an authorized teacher or administrator, and the information contained in the Histogram Report 1800 is current through the most recent student session.

In the Histogram Report 1800 illustrated in FIGS. 27-28, each student-specific graphic shows, on a vertical scale, the results of a series of student sessions (from left to right) 1854, 1856, 1858, 1860, 1862, 1864, 1866, 1868, 1870, and 1872. Optionally, and at the election of the teacher or administrator, each student result 1854, 1856, 1858, 1860, 1862, 1864, 1866, 1868, 1870, and 1872 can be an average of a specified number of consecutive student sessions (e.g., six consecutive student sessions)for a particular operation. The student-specific graphic representations 1808 . . . 1850 provide an indication of each student's progress over time. The graphic 1852 provides an indication of the group's progress over time.

It will be understood by one skilled in the art that, due to absences or other reasons, not every student will have taken every intervening assessment 1854-1872. Yet the Histogram Report 1800 is a valuable teaching, tracking, and diagnostic tool for students, teachers, and administrators alike. It will be further understood by one skilled in the art that the Histogram Report 1800 is available, on demand to the teacher or administrator, for each operation (addition, multiplication, subtraction, and division).

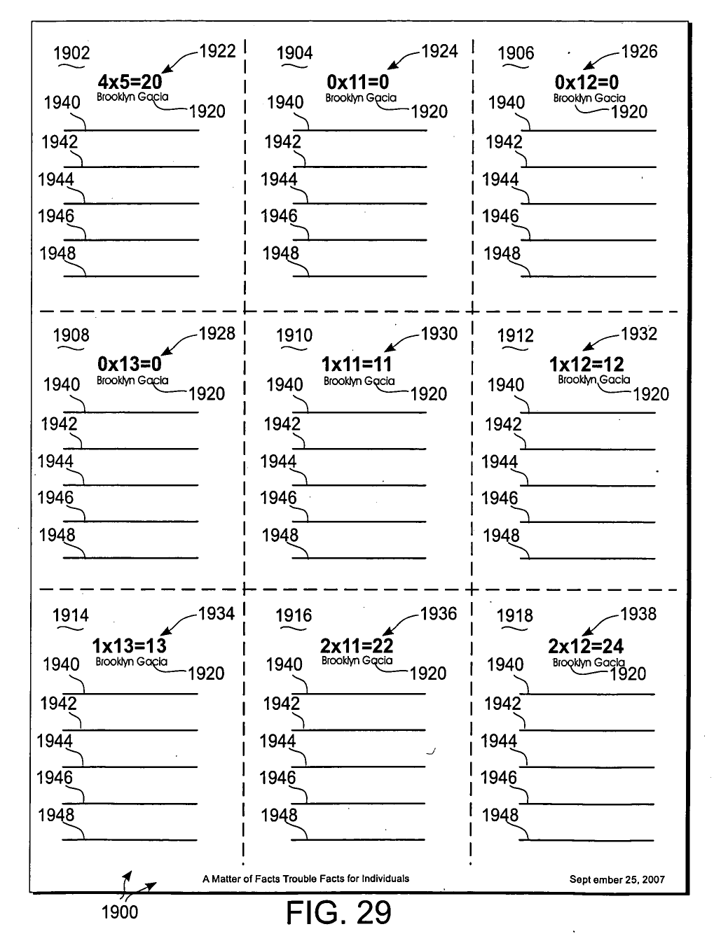

Referring now to FIG. 29, shown therein is a student-specific Individual Trouble Facts report 1900, in flash card format, provided by the present Method For Teaching Rapid Recall Of Facts invention. The Individual Trouble Facts report 1900 contains nine regions 1902, 1904, 1906, 1908, 1910, 1912, 1914, 1916, and 1918. Each region 1902, 1904, 1906, 1908, 1910, 1912, 1914, 1916, and 1918 contains a student identifier 1920 (Brooklyn Gacia), one of nine most-missed multiplication facts 1922, 1924, 1926, 1928, 1930, 1932, 1934, 1936, and 1938, respectively, and five lines 1940, 1942, 1944, 1946, and 1948 for use by the student. While the number of problems included in the Individual Trouble Facts report 1900 is selectable by the teacher, nine Trouble Facts problems fit conveniently on a single page.

Still referring to FIG. 29, the Individual Trouble Facts report 1900 is suitable for cutting into individual flash cards wherein each region 1902, 1904, 1906, 1908, 1910, 1912, 1914, 1916, and 1918 becomes a separate flash card. The student then reviews the problems identified as that particular student's trouble facts and, for each problem, writes the entire problem on the lines 1940, 1942, 1944, 1946, and 1948. While the separated regions have the appearance of traditional flash cards, in fact they differ because the answer is shown along with the problem.

It will be understood by one skilled in the art that the inclusion of the answer along with the problem is an effective method of teaching teach rapid recall of specific facts. This method is preferred over the use of traditional flash cards which provide the problem on one side of the flash card and the answer to the problem on the opposite side of the flash card. If the student is to develop rapid recall of math facts (addition, subtraction, multiplication, and division) or other factual content, the student must be able to recall the answer from memory almost instantaneously. This type of memory, sometimes referred to as rapid recall memory (or “rapid recall” for short), has been shown, in scholarly studies, to produce the answer in about 0.6 seconds (i.e., six-tenths of a second) and requires no analytical thinking or calculation. Thus the display of the entire problem, complete with answer, assists the student in the process of embedding the multiplication fact in the student's rapid recall memory.

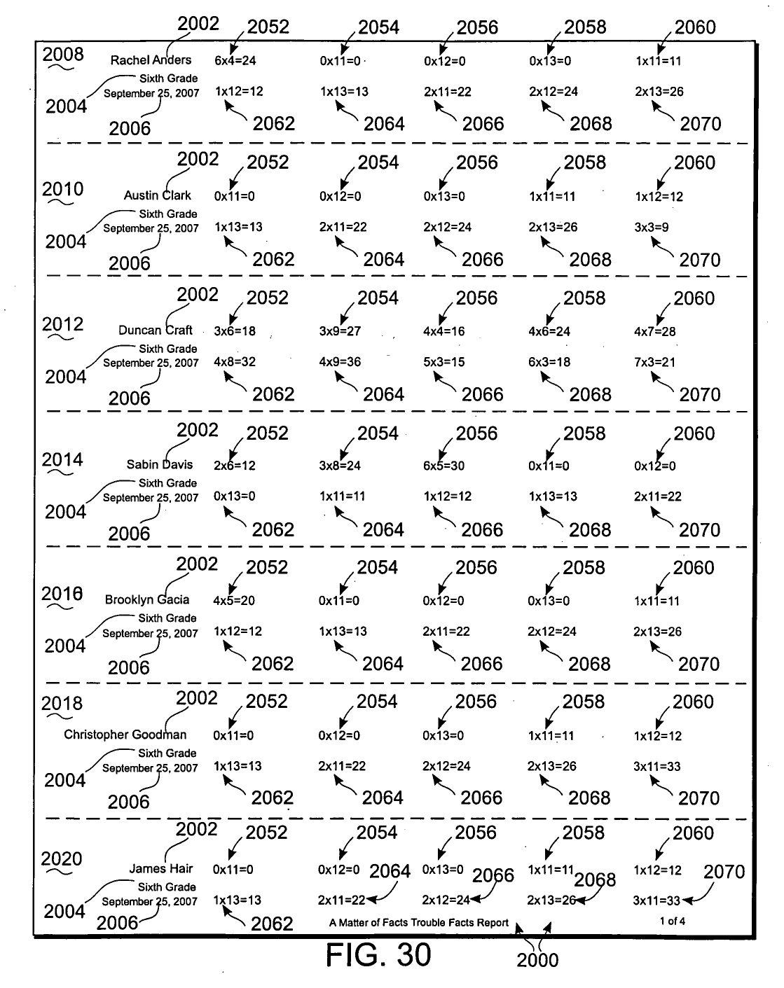

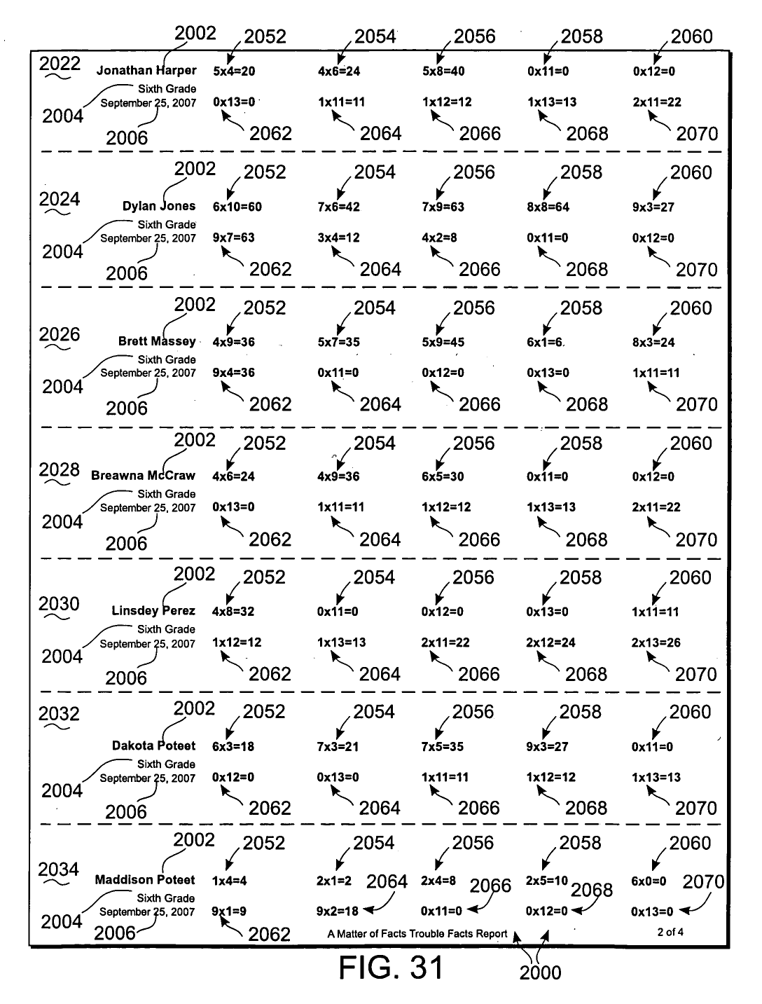

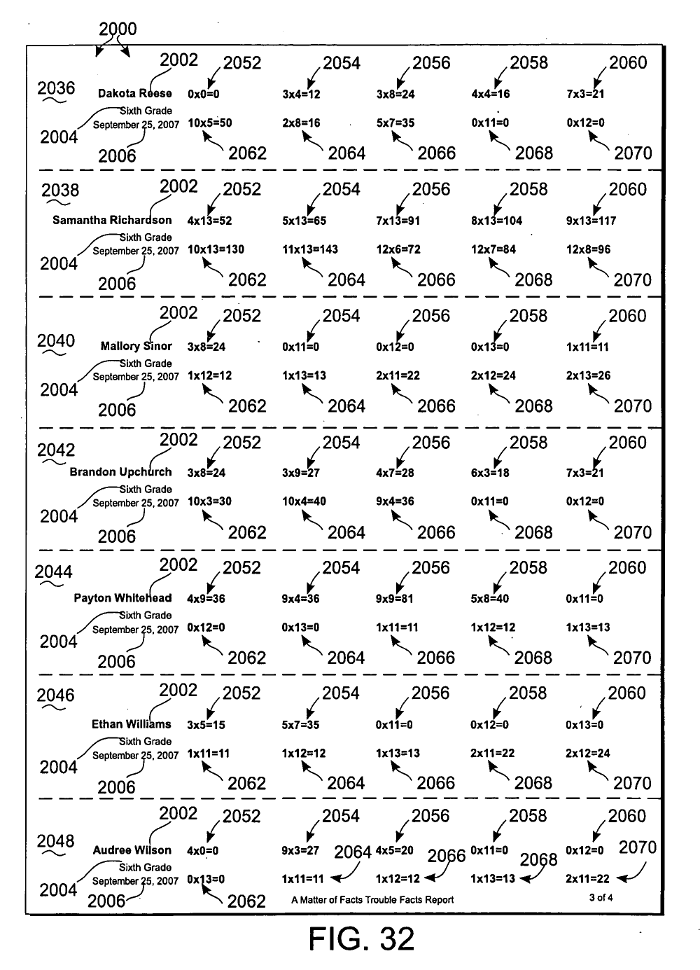

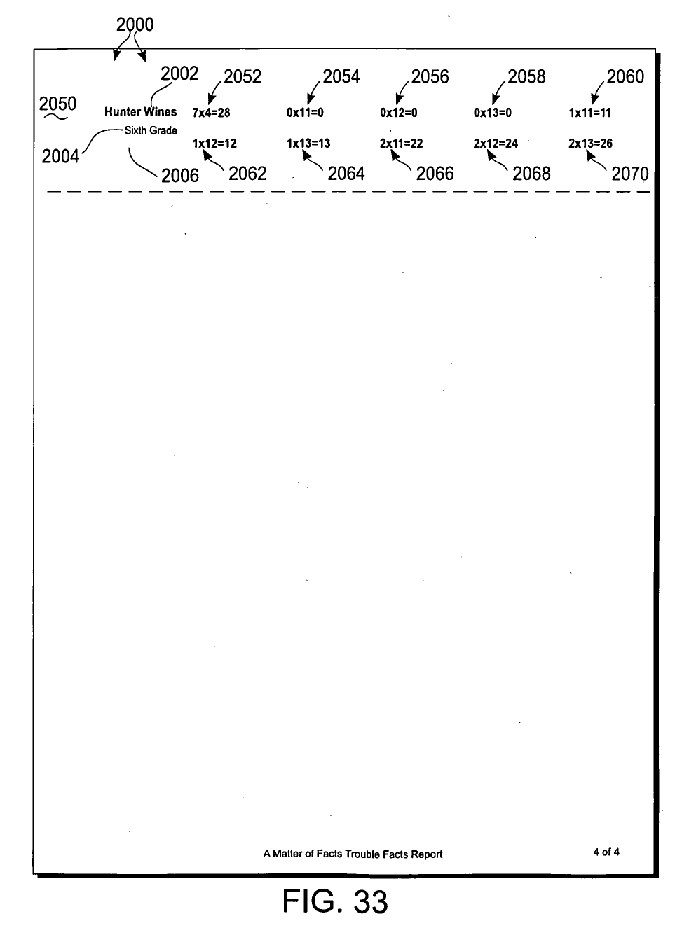

Referring now to FIGS. 30-33, illustrated therein is a 4-page Group Trouble Facts Report 2000 in strip format. The Trouble Facts Report 2000 is printed in regions 2008, 2010, 2012, 2014, 2016, 2018, 2020, 2022, 2024, 2026, 2028, 2030, 2032, 2034, 2036, 2038, 2040, 2042, 2044, 2046, 2048, and 2050. Each region (strip) 2008, 2010, 2012, 2014, 2016, 2018, 2020, 2022, 2024, 2026, 2028, 2030, 2032, 2034, 2036, 2038, 2040, 2042, 2044, 2046, 2048, and 2050 contains a student identifier 2002, a student grade identifier 2004, a date identifier 2006, and ten trouble facts 2052-2070 specific to the identified student. Whereas the Trouble Facts Report 1900 (See FIG. 3) presents nine student-specific trouble facts in a flash-card format, the Trouble Facts Report 2000 displays ten student-specific trouble facts 2052-2070 (or any other number of student-specific facts based on the teacher's preference) in strips which can be cut or torn apart and provided to the students. As illustrated in FIGS. 30-33, each student receives ten problems corresponding to the student's ten most-missed problems for a particular operations. Each trouble facts problem includes the answer to assist the student in embedding the multiplication fact in the student's rapid recall memory.

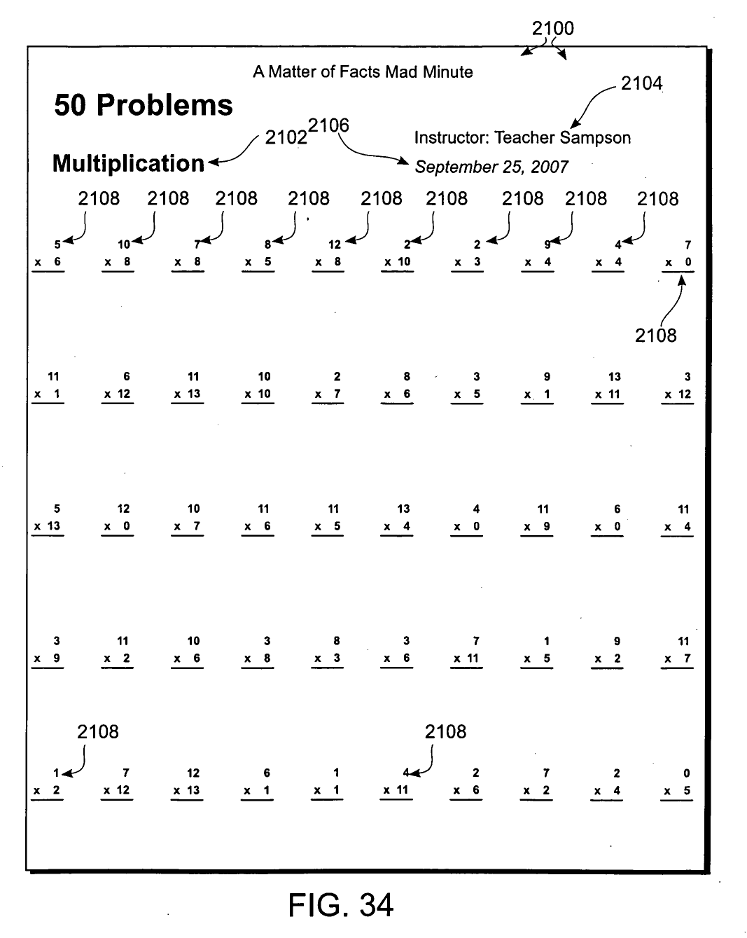

Referring now to FIG. 34, a generic 50-problem Mad Minute work sheet 2100 provided by the present Method For Teaching Rapid Recall Of Facts includes identifying information (text) indicating the operation 2102 (multiplication), the class instructor 2104 (Sampson), and the report date 2106 (Sep. 25, 2007). Randomly generated multiplication problems 2108 provide students in the class with practice working multiplication problems drawn from teacher-selected group(s) 214, 216, 218, and 220 (See multiplication grid 200, FIG. 2) of multiplicands and multipliers. The randomly generated multiplication problems 2108 include multiplicands and multipliers from all groups 214, 216, 218, 220.

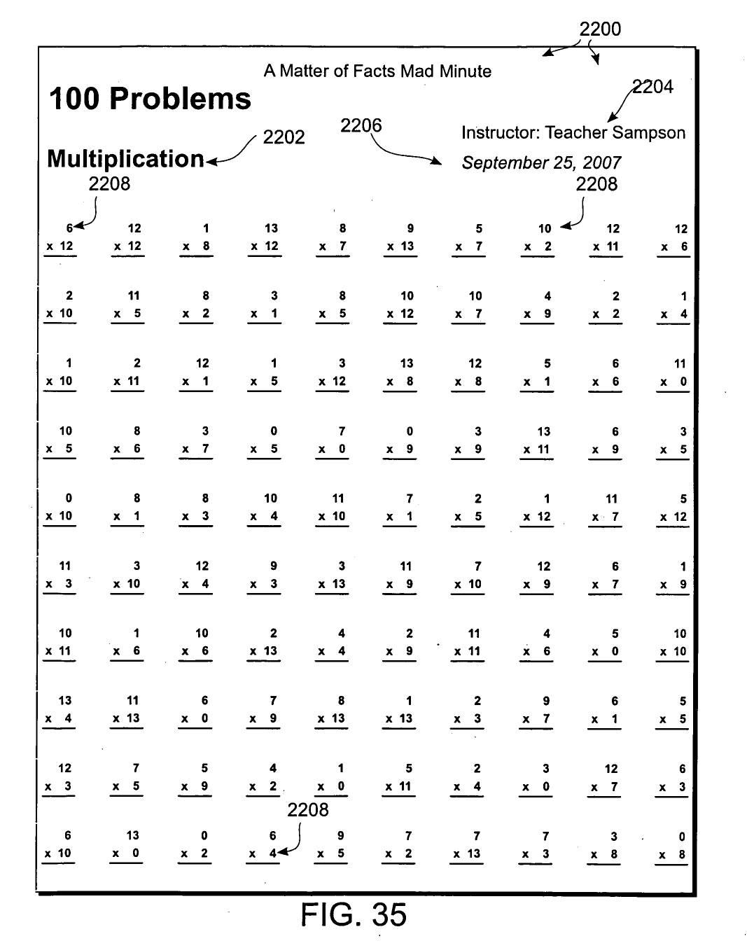

Referring now to FIG. 35, a generic 100-problem Mad Minute work sheet 2200 provided by the present Method For Teaching Rapid Recall Of Facts includes identifying information (text) indicating the operation 2202 (multiplication), the class instructor 2204 (Sampson), and the report date 2206 (Sep. 25, 2007). Randomly generated multiplication problems 2208 provide students in the class with practice working multiplication problems drawn from teacher-selectable groups 214, 216, 218, 220 (See multiplication grid 200, FIG. 2) of multiplicands and multipliers. The randomly generated multiplication problems 2208 include multiplicands and multipliers from all groups 214, 216, 218, 220.

It will be understood by one skilled in the art that work sheets of the type illustrated in FIGS. 34 and 35 are important teaching tools used universally in the classroom. With the present Method For Teaching Rapid Recall Of Facts, the teacher (or administrator) can generate a Mad Minute work sheet for any mathematical operation whenever the teacher feels a work sheet is appropriate.

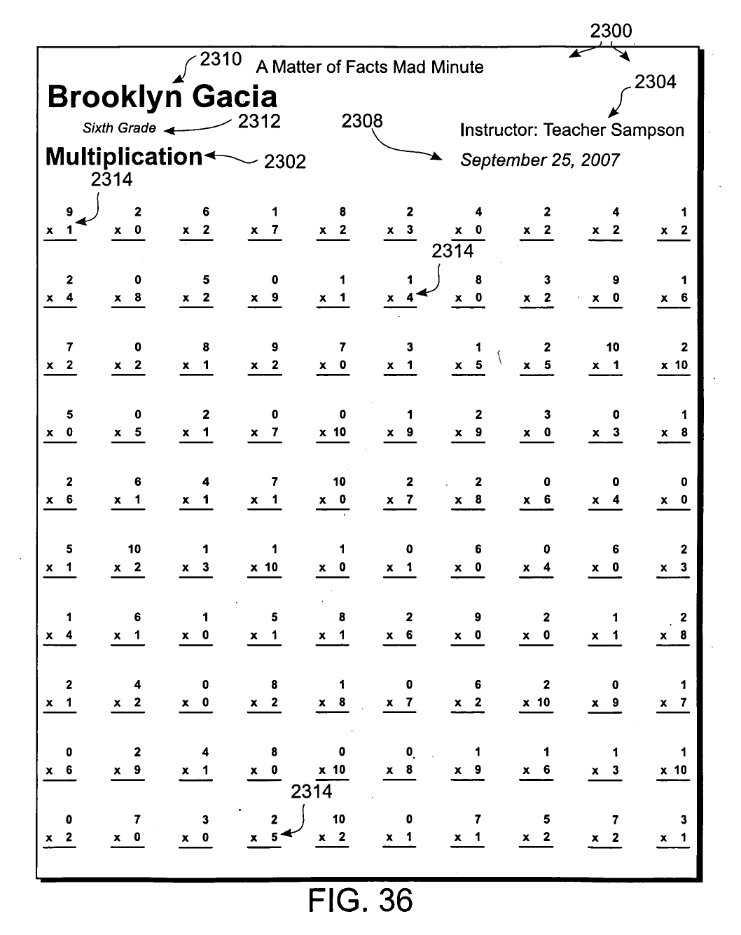

Referring now to FIG. 36, a student-specific Mad Minute work sheet 2300 provided by the present Method For Teaching Rapid Recall Of Facts includes identifying information (text) indicating the operation 2302 (multiplication), the class instructor 2304 (Sampson), the report date 2308 (Sep. 25, 2007), the name of the student 2310 (Brooklyn Gacia), and the student's grade level 2312 (Sixth Grade). Multiplication problems 2314 provide students in the class with practice working multiplication problems drawn from teacher-selectable groups 214, 216, 218, 220 (See multiplication grid 200, FIG. 2) of multiplicands and multipliers. The multiplication problems 2314 in the student-specific Mad Minute work sheet 2300 shown in FIG. 36 include multiplicands and multipliers from groups 214, 216, and 218, but not from group 220.

As will be discussed in greater detail below, the problems 2314 contained in the student-specific Mad Minute work sheet 2300 are generated based on information reflected in the student's most recent Student Progress Report (See FIGS. 10, 38, and 56-58) in accordance with the problem

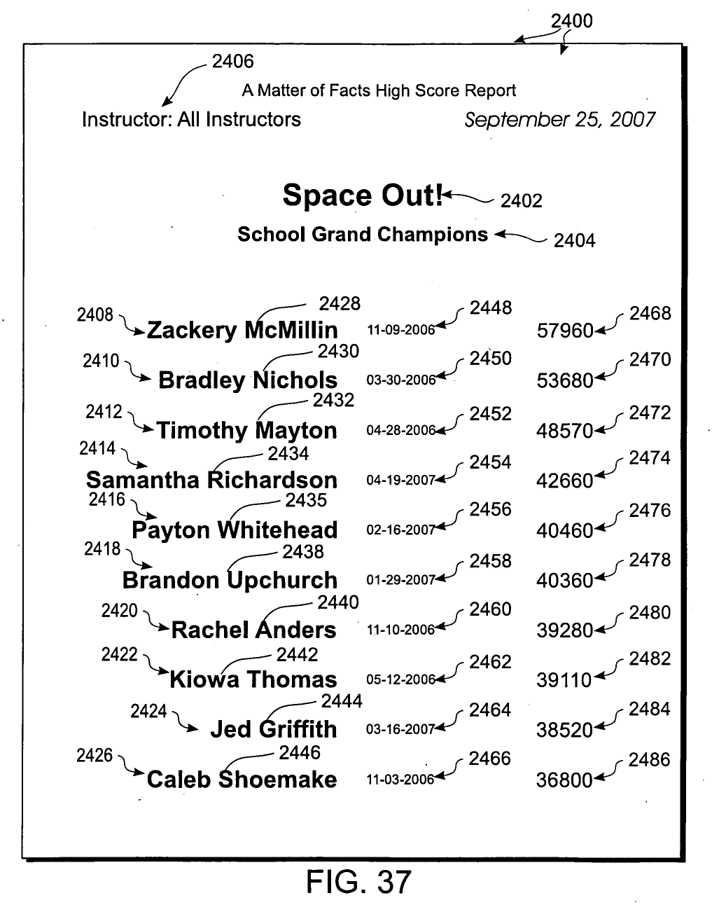

Referring now to FIG. 37, a High Score Report 2400 provided by the present Method For Teaching Rapid Recall of Facts includes identifying material (text) indicating the name of the particular arcade-style game 2402 (Space Out!), title 2404 (School Grand Champions), and the instructor 2406 (All Instructors). Entries of the top ten scores in descending order 2408, 2410, 2412, 2414, 2416, 2418, 2420, 2422, 2424, and 2426 contain, for each entry, the student's name 2428, 2430, 2432, 2434, 2436, 2438, 2440, 2442, 2444, and 2446, the date of the top-ten score 2448, 2450, 2452, 2454, 2456, 2458, 2460, 2462, 2464, and 2466, and the top-ten scores 2468, 2470, 2472, 2474, 2476, 2478, 2480, 2482, 2484, and 2486, respectively. The High Score Report 2400 shown in FIG. 37 is typically posted in various classrooms of the particular school.

Still referring to FIG. 37, the High Score Report 2400 is a powerful motivator for many students. The arcade-style games provided by the present Method For Teaching Rapid Recall Of Facts invention are pure entertainment, and the recognition that comes with a top-ten score relates to the student's game skills. Game skills are developed by playing the game, however, and the student must demonstrate rapid recall of facts in fact practice sessions to earn game practice time. Moreover, the game practice time earned by the student is limited. It would be highly unlikely for a student to achieve a top-ten game score unless the student has also performed well in the fact practice sessions. With respect to game scores, practice makes perfect. Game practice is earned by success in rapid recall of facts, where fact practice also makes perfect.

Still referring to FIG. 37, the instructor identifier 2406 defaults to “All Instructors,” indicating the High Score Report 2400 list includes the top ten scores for all students in all grades within the school district. Only the administrator can change the default from “All Instructors” to a particular instructor (See FIGS. 45 and 48). As stated above, the game scores are related to game practice time, and game practice time is earned by demonstrating progress toward mastery of rapid recall facts. Generally, an administrator would expect the top ten scores to be distributed randomly among all students from all schools. If students having a common instructor or from the same school dominate the High Score Report 2400, the administrator might wish to inquire further. A particular instructor (or school) may be providing more access to a computer lab or doing something different with respect to the student-specific Trouble Facts reports 1900, 2000 (See FIGS. 29 and 30-33) and the student-specific Mad Minute work sheets 2300 (See FIG. 36). Conversely, the total absence of students from one particular school or of students one particular instructor may suggest the school or instructor is not obtaining the benefits of the present Method For Teaching Rapid Recall Of Facts. From the administrator's side, therefore, the High Score Report 2400 provides real-time, on-demand information regarding teacher activity.

Referring now to FIG. 38, a Student Progress Report 2500 includes identifying material (text) indicating the name of the student 2502 (Brooklyn Gacia), the name of the instructor 2504 (Sampson) and the date 2506 (Sep. 25, 2007). A legend 2508 provides details 2510, 2512, 2514, and 2516 of entries in an addition grid 2518, a multiplication grid 2520, a subtraction grid 2522, and a division grid 2524. The detail 2510 in the legend 2508 indicates a “missed” question (i.e., an incorrect answer to a problem) will be indicated by an “x.” The detail 2512 in the legend 2508 indicates a “correct” answer will be indicated by a large gray dot. The detail 2514 in the legend 2508 indicates a small black dot will be displayed if the student “hesitated” but answered the problem correctly. The detail 2516 in the legend 2508 indicates a problem which has been “mastered” by the student will be shown by a large black dot.

According to the present Method For Teaching Rapid Recall Of Facts invention, an answer is incorrect (i.e., “missed”) if either (1) the student answered the displayed problem with a wrong answer or (2) the student failed to answer the question within 7 seconds (the total of the first and second time periods). An answer is correct only if (1) the student entered the correct answer to the displayed problem and (2) the student entered the correct answer within 3 seconds (the first time period). If the student answers the problem correctly in more than 3 seconds (the first time period) and before the expiration of an additional 4 seconds (the second time period), the student's answer will be deemed to have “hesitated.” “Mastered” is a defined term meaning the student answered that particular problem correctly on the last three occasions that particular problem was displayed.

It will be further understood by one skilled in the art that each answer category (missed, correct, hesitated, and mastered) corresponds to the student's brain function. If the student “misses” the answer, then the student has not yet associated the correct answer with the problem displayed. A correct answer suggests the student's association of the answer with the problem displayed has moved from the cognitive function of the brain, through the long-term memory function of the brain, and has become embedded in rapid recall memory, where retrieval of the answer requires no conscious thought process. As discussed above with respect to FIG. 6, the timer ring 544 is a graphic representation of two pre-set time periods—a first rapid recall elapsed time period and a second time period. The first time period is three seconds and the second time period is four seconds. Studies have shown that the actual time for a person to retrieve a fact from rapid recall memory is only 0.6 seconds (i.e., six-tenths of one second). The additional 2.4 seconds (for a total of 3.0 seconds) is sufficient time for a typical student to enter the rapidly recalled answer for a displayed problem. For purposes of clarification, answers which are “correct” pursuant to the present method might also be referred to as “rapidly correct.”

It will be further understood by one skilled in the art that a “hesitated” response suggests the answer is present in the student's long-term memory but not in the student's rapid recall memory. As discussed above with respect to FIG. 6, the second pre-set time period is four seconds. Together, the first rapid-recall time period (3 seconds), and the second pre-set time period (4 seconds) define a long-term memory time period of 7 seconds. During the 7-second long-term memory time period, it is possible for the student who has stored information in long-term memory to process the displayed problem and enter a mathematically-correct answer to a displayed problem. The long-term memory time period may, in certain cases, be sufficient for a student to obtain a mathematically-correct answer by counting on the student's fingers. While the answer thus obtained may be mathematically correct, the answer is actually “hesitatingly correct” according to the present method, hence the term “hesitated” in the legend 2508.

It will be further understood by one skilled in the art that the term “Mastered” (entry 2516 in the legend 2508) has special significance. Studies have shown that information embedded in the brain's rapid-recall memory may be embedded to a relatively lessor or greater extent. Some information is “locked in” more than other information. A student who, on a single occasion, enters a correct answer to a particular problem within the rapid-recall time period has demonstrated the answer is stored in the student's rapid-recall memory. A student who, on each and every occasion the problem is displayed, enters a correct answer demonstrates the answer is deeply embedded in the student's rapid-recall memory. According to the present method, a student who enters the correct answer within 3 seconds to a particular fact (problem), on each of three consecutive occasions the particular problem is displayed, is deemed to have “mastered” that particular fact (problem).

Referring still to FIG. 38 and more specifically to the addition grid 2518, an addition grid identifier 2526 indicates the grid 2518 displays the student Brooklyn Gacia's progress with respect to addition problems. Missed problems, indicated by an “x” in corresponding squares in the addition grid 2518 are 1+6=7 and 5+1=6. A large gray dot indicates Brooklyn answered the following problems correctly (meaning Kelly entered a correct answer within 3 seconds): 0+0=0, 0+4=4, 0+9=9, 1+0+0, 1+4=5, 1+5+6, 1+7=8, 1+9=9, 5+0=5, 7+1=8, 8+1=9, and 9+1=10. A small gray dot shows Brooklyn hesitated when answering the problem 3+0=0. The absence of a large black dot in the addition grid 2518 indicates the student has not yet “mastered” any of the addition facts.

Referring still to FIG. 38 and more specifically to the multiplication grid 2520, a multiplication grid identifier 2528 indicates the grid 2520 displays Brooklyn Gacia's progress with respect to multiplication problems. An “x” in a squares in the multiplication grid 2520 corresponding to the multiplication problem 4×5=20 indicates Brooklyn missed that problem are 1+6=7 and 5+1=6. Large gray dots indicated Brooklyn has correctly answered, but not yet mastered, the following multiplication problems: 3×9=27, 4×8=32, 5×3=15, 5×8=40, 6×7=42, 7×8=56, 8×7=56, 8×10=80, 9×5=45, 9×7=63, 9×8=72, and 10×8=80. A large number of large black dots indicates Brooklyn has mastered the remaining multiplication problems selected from groups 214, 216, and 218 (See FIG. 2). The absence of a large gray dot, an “x,” a small dot, or a large black dot from group 220 indicates Brooklyn has not yet been introduced to multiplication problems wherein the multiplier or the multiplicand is 11, 12, or 13.

Referring still to FIG. 38, a subtraction grid identifier 2530 indicates the subtraction grid 2522 displays Brooklyn Gacia's progress with respect to subtraction problems, and a division grid identifier 2532 indicates the division grid 2524 displays Brooklyn Gacia's progress with respect to division problems. Thus the Student Progress Report 2500 according to applicant's method provides a snapshot of each student's current progress.

Referring now to FIG. 39, an interactive, on-screen Student Progress Report 2600 includes identifying material (text) indicating the name of the student 2602 (Kelly Robinson), the name of the instructor 2604 (Kathy Robinson), and the date 2606 (Sep. 13, 2007). A legend 2608 provides details 2610, 2612, 2614, and 2616 of entries in an active addition grid 2618, an active multiplication grid 2620, an active subtraction grid 2622, and an active division grid 2624. The detail 2610 in the legend 2608 indicates a “missed” question (i.e., an incorrect answer to a problem) will be indicated by an “x.” The detail 2612 in the legend 2608 indicates a “correct” answer will be indicated by a large gray dot. The detail 2614 in the legend 2608 indicates a small black dot will be displayed if the student “hesitated” but answered the problem correctly. The detail 2616 in the legend 2608 indicates a problem which has been “mastered” by the student will be shown by a large black dot.

Referring still to FIG. 39, an active addition grid identifier 2626 displayed beneath the active addition grid 2618 indicates the active addition grid 2618 displays the student Kelly Robinson's progress with respect to addition problems. An active multiplication grid identifier 2628 displayed beneath the active multiplication grid 2620 indicates the active multiplication grid 2620 displays Kelly's progress with respect to multiplication problems. An active subtraction grid identifier 2630 beneath the active subtraction grid 2622 displays Kelly's progress with respect to subtraction problems. An active division grid identifier 2632 beneath the active division grid 2624 indicates the active division grid 2624 displays Kelly's progress with respect to division problems. In each displayed active grid 2618, 2620, 2622, 2624, an “x” in a square indicates Kelly missed the problem corresponding to that square, a large gray dot indicates Kelly answered the problems correctly (meaning Kelly entered a correct answer within 3 seconds) but has not yet mastered that problem. A small gray dot shows Kelly hesitated when answering the problem. A large black dot indicates Kelly has mastered the corresponding problem, i.e., Kelly answered that particular problem correctly on the last three occasions she encountered that particular problem.

The on-screen, interactive Student Progress Report 2600 shown in FIG. 39 differs from the Student Progress Report 2500 shown in FIG. 38. Whereas the Student Progress Report 2500 is a paper report, the on-screen, interactive Student Progress Report 2600 is an active screen containing active grids for use by the student in mastering the rapid recall of facts contained in the grids. When the student places the cursor over a particular square, as at 2640 in the active addition grid 2618, the problem 2642 corresponding to that square is displayed beneath the active addition grid 2618. Thus the present Method for Teaching Rapid Recall of Facts invention permits a student to focus directly on missed problems (as indicated by an “x”) by placing the cursor over each “x” in a particular grid. The student can review missed problems for a particular operation just prior to a fact practice session, the student can review missed problems immediately following a student session, or the student can elect to focus strictly on missed problems rather than practicing on a variety of problems in a fact practice session. Similarly, the student may wish to review not only missed problems (indicated on the grids by an “x”) but also problems on which the student hesitated (indicated on the grids by a small dot).

It will be understood by one skilled in the art that the on-screen, interactive Student Progress Report 2600 shown in FIG. 39 is especially useful for the student wishing to focus on not-yet-mastered problems. Using the “x” 2640 as an example, the student can immediately determine the student provided a wrong answer (or no answer) to the sum (10+9). The student can answer the problem to himself/herself, then place the cursor over the “x” 2640. The problem, complete with answer, is displayed beneath the active addition grid 2618 as shown at 2642.

Still referring to FIG. 39, a print icon 2644 is available so the student (or the student's parent) can print out a Student Progress Report 2500 (See FIG. 38). A link 2646 permits the student (or the student's parent) to print a Mad Minute Worksheet (See FIG. 36) or a Trouble Facts Worksheet (See FIG. 29) for selected operations (addition, subtraction, multiplication, division).

Referring now to FIG. 39 in conjunction with FIG. 5, a student begins a student session by selecting an icon on the display 500. The student can select addition 502, multiplication 504, subtraction 506, or division 508. In the alternative, the student can select the Progress Report icon 510, and be taken to a the display of the Student Progress Report 2600 shown in FIG. 39. Prior to beginning a student session, the student is encouraged to view the student's Progress Report 2900, highlight each missed problem in the active grid matching the operation to be selected for the student session, and write down each missed problem. The process of viewing and recording each missed problem, complete with the answer, helps the student to place the fact in the student's long-term memory. Similarly, the process of viewing each problem for which the student hesitated (as indicated by a small black dot), helps the student move those facts/problems from long-term memory to rapid-recall memory.

It will be understood by one skilled in the art that the active grids 2618 (addition), 2620 (multiplication), 2622 (subtraction), and 2624 (division) provide an additional study aid for the student. At the beginning of a student session, the student has access to the student's Student Progress Report 2600 shown in FIG. 39 for all operations. At the end of a student session, satisfaction of session-ending criteria results in display of the Progress Report and arcade-style game menu 600 shown in FIG. 10. Like each grid 2618 (addition), 2620 (multiplication), 2622 (subtraction), and 2624 (division) shown in the Student Progress Report 2600, the student-specific grid 610 in FIG. 10 is an active grid. If desired, the student can highlight each missed problem at the end of a student session and the missed problem will be displayed, complete with answer, on the student's display.

Referring once again to FIG. 39, each active grid 2618 (addition), 2620 (multiplication), 2622 (subtraction), and 2624 (division) provides a real-time snapshot of the student's current progress toward mastery of rapid-recall facts. The Xs will become small black dots, the small black dots will change to large gray dots, and the gray dots will become large black dots. Students are eager to see the progress reflected in the active grids 2618 (addition), 2620 (multiplication), 2622 (subtraction), and 2624 (division).

Still referring to FIG. 39, the student-specific Student Progress Report 2600, which is normally current through the last student session, is always available to the student, the student's parents, teachers, and administrators.

Referring now to FIG. 39 in conjunction with FIG. 29, the Student Progress Report 2600 and the Trouble Facts Report 1900 are especially useful if the student has internet access at the student's home. Concerned parents can learn about their child's current progress by viewing the Student Progress Report 2600. If the parents wish to give the child extra work with the child's most-missed facts, the parents can print out the student-specific Trouble Facts Report 1900 or a student-specific Mad Minute work sheet 2300 (See FIG. 36). In the alternative, the child with internet access from home may prefer to participate in a student session, thereby improving the child's rapid recall of specific facts and, at the same time, earning game practice time on the child's favorite arcade-style game.

The significance of a child's having an opportunity to hone the child's skills at home cannot be overstated. Parents no longer need wait for a parent-teacher conference to learn how their child is progressing. Parents no longer need ask their child's teacher for extra work sheets. The parents now have access to their child's Student Progress Report and to tools designed to help their child master the rapid recall of facts.

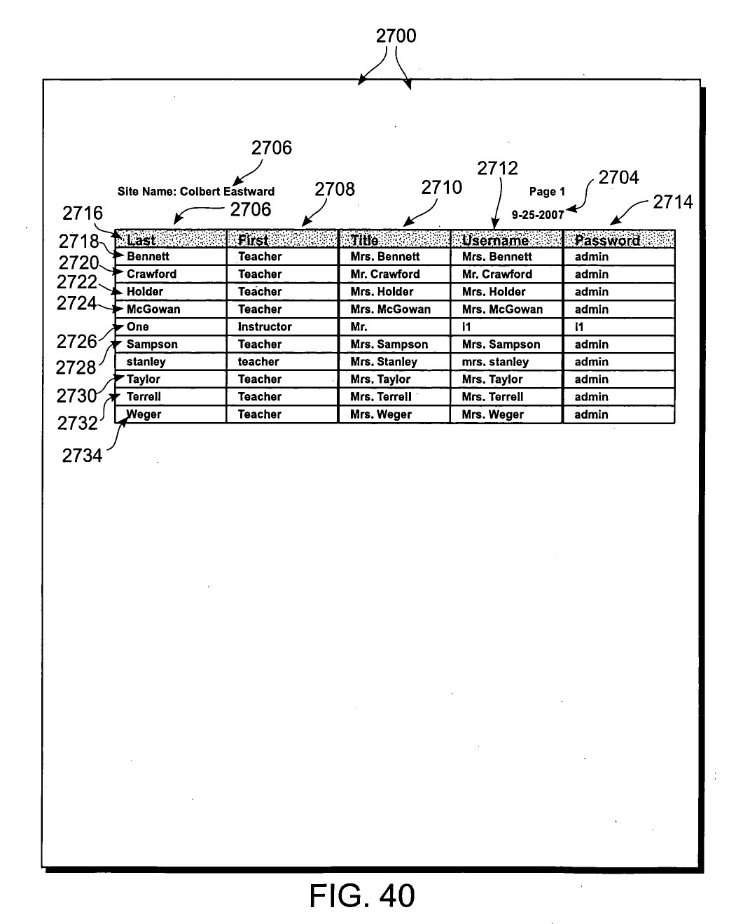

Referring now to FIG. 40, an Administrative Teacher Report 2700 provides an administrator with login information relating to each teacher using the present Method. The Administrative Teacher Report 2700 contains site name identifying text 2702 (Colbert Eastward), a report date 2704 (9-25-2007), a teacher last name column heading 2706 (Last), a teacher first name column heading 2708 (First), a teacher title column heading 2710 (Title), a teacher user name column heading 2712 (Username), and a teacher Password column heading 1414 (Password). Information corresponding to the column headings is provided in an entry 2716, 2718, 2720, 2722, 2724, 2726, 2728, 2730, 2732, 2734 for each teacher Bennett, Crawford, Holder, McGowan, One, Sampson, Stanley, Taylor, Terrell, and Weger, respectively.

Still referring to FIG. 40, the Administrative Teacher Report 2700 has great value when a substitute teacher takes a class of students to the computer lab or when a regular teacher forgets the teacher's username or password. The on-demand, real-time Administrative Teacher Report 2700 provides the necessary information to assist teachers. The administrator may be a principal, a principal's designated administrator, a superintendent, or the superintendent's designated administrator.

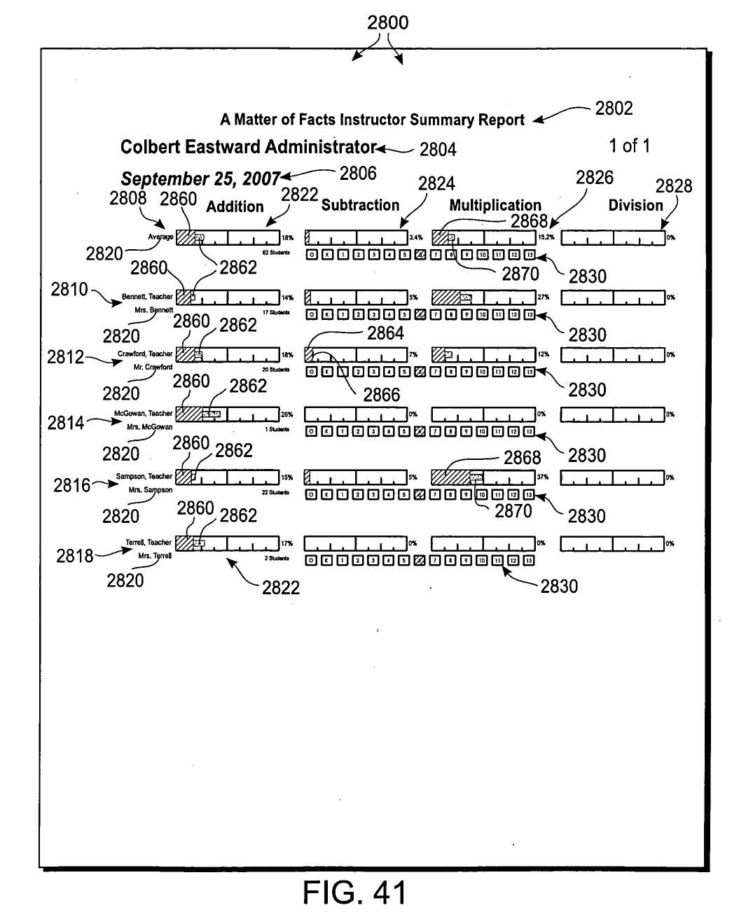

Referring now to FIG. 41, an Administrative Instructor Summary Report 2800 contains report identifying material (text) 2802 (A Mater of Facts Instructor Summary Report), administrator identifying material (text) 2804 (Colbert Eastward Administrator), and a report date 2806 (Sep. 25, 2007). The Administrative Instructor Report 2800 is a real-time, on-demand snapshot of the progress of students of selected teachers in mastering rapid recall of addition, subtraction, multiplication, and division facts. Moving from top to bottom, an entry for the average of all students in all classes 2808 is followed by entries for each selected teacher 2810 (Mrs. Bennett), 2812 (Mr. Crawford), 2814 (Mrs. McGowan), 2816 (Mrs. Sampson), and 2818 (Mrs. Terrell).

Still referring to FIG. 41, each entry includes, from left to right, entry identifying information (text) 2820, a graphic representation of the teacher's students' group progress with respect to addition 2822, a graphic representation of the teacher's students' group progress with respect to subtraction 2824, a graphic representation of the teacher's students' group progress with respect to multiplication 2826, and a graphic representation of the teacher's students' group progress with respect to division 2828. Each entry also includes a graphic representation 2830 of the students' grade level for each teacher.

Still referring to FIG. 41 and, more specifically, to the graphic representations 2822 of student progress in mastering rapid recall of addition facts, each addition graphic 2822 contains a relatively wider horizontal band 2860 and a relatively narrower horizontal band 2862. The wider horizontal band 2860 indicates, for each teacher's students at a group, the students' mastery of addition facts. The narrower horizontal band 2862, extending to the right beyond the wider horizontal band 2860, indicates the extent to which the students, as a group, have answered addition problems correctly (i.e., a correct answer within the 3-second initial time period) but has not done so three times in a row (the definition of mastery according to the present invention). The average of all students in all classes is provided across for the entry 2808 (Average).

Still referring to FIG. 41 and to the addition graphic 2822 for the entry 2910, Mrs. Bennett's students have mastered 14% of math facts addition problems, and Mrs. Bennett's students have answered an additional approximately 5-6% of the math facts addition problems correctly at least once as of data gathered following the students' last student session. Referring to the addition graphic 2822 information for entry 2808, the class, on average, has mastered 18% of the math facts addition problems and answered an additional approximately 8% of the math facts addition problems correctly at least once.

Still referring to FIG. 41 and to the addition graphic 2822 for the entry 2814 (Mrs. McGowan's students), the addition graphic 2822 indicates mastery of about 25% of addition facts, and Mrs. McGowan's students have answered an additional approximately 15% of the math facts addition problems correctly at least once. From these results, the Administrator would find that Mrs. McGowan's class is outperforming the other classes with respect to rapid recall of information relating to addition problems. Mrs. McGowan's students may have had more computer lab time and, as a result, Mrs. McGowan's students may have completed more student sessions. Mrs. McGowan's students may be conducting student sessions from home. Mrs. McGowan may have stressed the review step at the beginning of each session (See discussion regarding FIGS. 10 and 39, above). In any event, the Administrator (including the school principal and school district administrative personnel) have a valuable tool for tracking the performance of particular groups of students with a goal of improving the progress of all students.

Still referring to FIG. 41 and, more specifically, to the graphic representations 2824 of each selected teacher's students' progress in mastering rapid recall of subtraction facts, each subtraction graphic 2824 contains a relatively wider horizontal band 2864 and a relatively narrower horizontal band 2866. The wider horizontal band 2864 indicates, for each teacher's students, the students' mastery of subtraction facts. The narrower horizontal band 2866, extending to the right beyond the wider horizontal band 2864, indicates the extent to which the student has answered subtraction problems correctly (i.e., a correct answer within the 3-second initial time period) but has not done so three times in a row (the definition of mastery according to the present invention). The subtraction graphic 2824 for the entry 2808 indicates the averages of all students in all classes of the selected teachers with respect to subtraction problems.

Still referring to FIG. 41, and, more specifically, to the graphic representations 2826 of each teacher's student's progress, as a group, in mastering rapid recall of multiplication facts, each multiplication graphic 2826 contains a relatively wider horizontal band 2868 and a relatively narrower horizontal band 2870. The wider horizontal band 2868 indicates, for each teacher's students, the students' mastery, as a group, of multiplication facts. The narrower horizontal band 2870, extending to the right beyond the wider horizontal band 2868, indicates the extent to which the teacher's students have answered subtraction problems correctly (i.e., a correct answer within the 3-second initial time period) but have not done so three times in a row (the definition of mastery according to the present invention). The multiplication graphic 2826 for the entry 2808 indicates the average of all students in the classes of the selected teachers with respect to multiplication problems.

Still referring to FIG. 41 and, more specifically, to the graphic representations 2826 of each teacher's students' progress in mastering rapid recall of division facts, each division graphic 2826 would normally contain a relatively wider horizontal band 2872 and a relatively narrower horizontal band 2874. The wider horizontal band 2872 would indicate, for each teacher's students, the students' mastery of division facts. The narrower horizontal band 2874, extending to the right beyond the wider horizontal band 2872, would indicate the extent to which the teacher's students have answered division problems correctly (i.e., a correct answer within the 3-second initial time period) but has not done so three times in a row (the definition of mastery according to the present invention). The division graphic 2828 for the entry 2808 will the average of all students in the selected teacher's classes with respect to division problems.

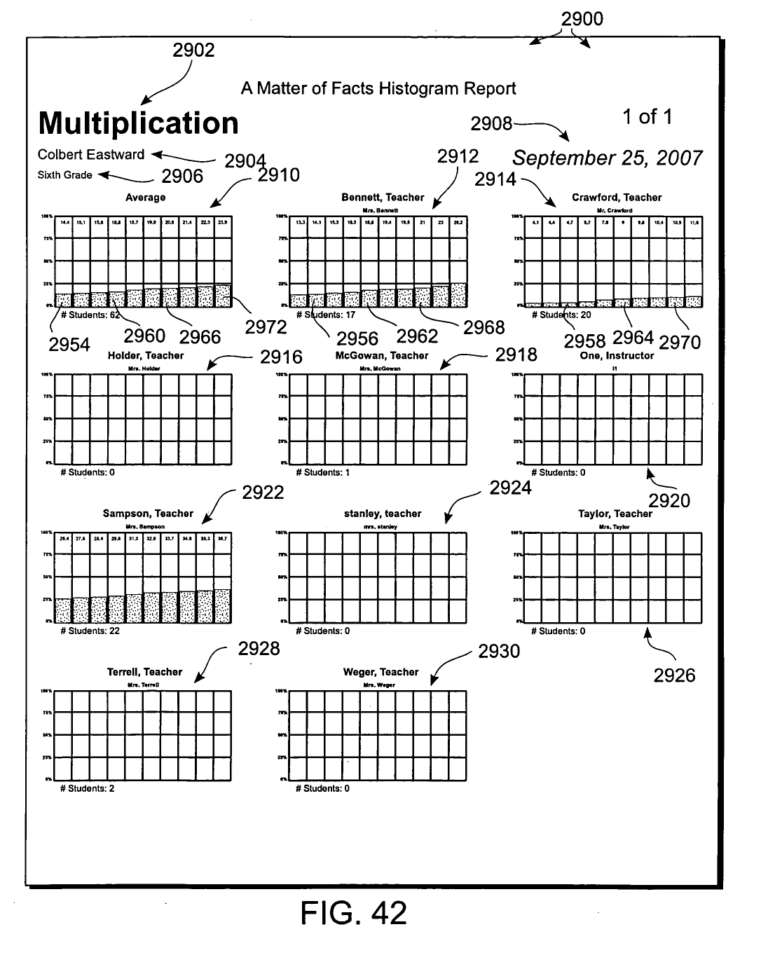

Referring now to FIG. 42, an Administrative Teacher Histogram Report 2900 provided by the present Method For Teaching Rapid Recall Of Facts includes identifying information (text) indicating the operation 2902 (multiplication), the site 2904 (Colbert Eastward), the grade level 2906 (Sixth Grade), and the report date 2908 (Sep. 25, 2007). Moving from left to right and from top to bottom, an entry for the average 2910 of all students of selected teachers is followed by an entry for the students of each selected teacher 2912 (Bennett), 2914 (Crawford), 2916 (Holder), 2918 (McGowan), 2920 (One), 2922 (Sampson), 2924 (Stanley), 2926 (Taylor), 2928 (Terrell), and 2930 (Weger). Depending on the interest and purpose of the Administrative Teacher Histogram Report 2900, the reference group related to the graphic 2910 (Average) may be the students of all teachers of a single grade level at a particular school, the students of all teachers of a single grade level of all schools, or the students of all grade levels at all schools in the school district. The Administrative Teacher Histogram Report 2900 can be generated at any time by the Administrator or the Administrator's designee, and the information contained in the Administrative Teacher Histogram Report 2900 is current through the most recent student session.

In the Administrative Teacher Histogram Report 2900 illustrated in FIG. 42, each teacher-specific graphic shows, on a vertical scale, the group results of a series of student sessions (from left to right) 2954, 2956, 2958, 2960, 2962, 2964, 2966, 2968, 2970, and 2972. Optionally, and at the election of the teacher or administrator, each student result 2954, 2956, 2958, 2960, 2962, 2964, 2966, 2968, 2970, and 2972 can be an group average of a specified number of consecutive student sessions (e.g., six consecutive student sessions) for a particular operation. The teacher-specific graphic representations 2912 . . . 2930 provide an indication of each selected teacher's students' progress overtime. The graphic 2910 provides an indication of the progress of all students of all selected teachers.

it will be understood by one skilled in the art that the Administrative Teacher Histogram Report 2900 is a valuable teaching, tracking, and diagnostic tool for administrators. It will be further understood by one skilled in the art that the Administrative Teacher Histogram Report 2900 is available, on-demand, to the Administrator, or the Administrator's designee, for each operation (addition, multiplication, subtraction, and division).

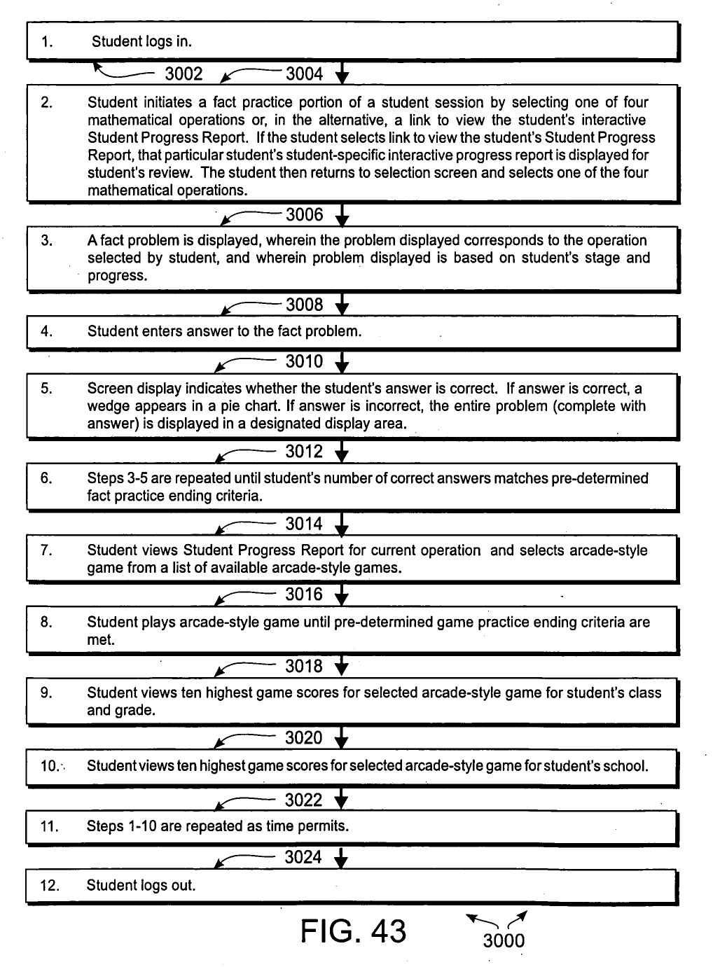

Referring now to FIG. 43 in conjunction with FIGS. 5-10, a step-by-step summary 3000 details the process by which a student engages in fact practice and game practice using the present Method Of Teaching Recall Of Facts invention in relation to the screen display. In Step 1 (3002), the student logs in to a computer terminal using the student's site code (i.e., a unique identifier for all students located at a single location, not shown), the student's Username 1412 and the student's password 1414 (See FIG. 20) and a selection screen 500 (See FIG. 5) is displayed. In Step 2 (3004), the student clicks on one of four mathematical operation icons 502, 504, 506, 508 (See FIG. 5) to begin the student's “fact practice session” wherein the student will be working problems corresponding to the selected mathematical operation or, in the alternative, the student clicks on the Progress Report icon 510 to view the student's interactive Student Progress Report (See FIGS. 10 and 39). If the student clicks on the Progress Report icon 510, the student's interactive Student Progress Report 2500 (See FIG. 39) containing active grids 2518 (addition), 2520 (multiplication), 2522 (subtraction), and 2524 (division) will be displayed. The student has an opportunity to review and write down previously missed problems for the operation of interest. The student then returns to the selection screen 500 by closing out the Student Progress Report 2500 using the on-screen navigation button 626 (See FIG. 10) and selects a mathematical operation for the fact practice portion of a student session. For purposes of this illustration, we are assuming the student selected the addition icon, but the steps which follow apply to all operations.

Still referring to FIG. 43 in conjunction with FIGS. 6-9, in Step 3 (3006), an addition problem 522 corresponding to the operation selected by the student is displayed. As will be discussed later, the problem displayed is generated by the present Method For Teaching Rapid Recall Of Facts based on the student's stage and progress. When the addition problem 522 is first displayed within the timer graphic 524, a rapid recall period timer begins a 3-second timer, with progress displayed by the moving arrow 548 within the timer ring 544 of the timer graphic 524. An auditory alarm (not shown) sounds at the end of 3 seconds and a second timer begins, with progress once again displayed by the moving arrow 548 within the timer ring 544 of the timer graphic 524.

Still referring to FIG. 43, in Step 4 (3008), the student enters an answer to the addition 522 problem displayed on the student's computer screen 520. In Step 5 (3010), if the student enters a mathematically correct answer prior to the expiration of 3 seconds, the responsive face 536 displays a relatively happier expression, a wedge appears in one of eight sections 528a -528h of the pie chart 528, and the numerator 532 in the fraction 530 changes from 0 to 1. If the student enters a mathematically correct answer after expiration of the 3-second time period but before the expiration of the second 4-second time period, or if the students enters a mathematically incorrect answer, or if the student fails to enter an answer prior to the expiration of the 4-second time period, the addition problem 522, complete with answer, is displayed on the student's computer display. The responsive face 536 displays a relatively unhappier expression, no wedge appears in the pie chart 528, and the numerator 532 in the fraction 530 does not change.

Still referring to FIG. 43 in conjunction with FIGS. 5-10, in Step 6 (3012), Steps 3, 4, and 5 (3006, 2608, and 3010) are repeated until the student's number of correct answers matches pre-determined fact practice portion ending criteria. Each time the student enters a mathematically correct answer within the 3-second rapid recall time period, an additional wedge appears in the pie chart 528, the numerator 532 in the fraction 530 increases by 1, and the responsive face 536 displays a relatively happier expression. Fractions such as 2/8, 4/8, and 6/8 are reduced to lowest terms ¼, ½, and ¾, respectively. Each time the student fails to enter a mathematically correct answer within the 3-second rapid recall time period, the missed problem 522, complete with answer, is displayed on the student's computer screen, the responsive face 536 displays a relatively unhappier expression, no wedge appears in the pie chart 528, and the numerator 532 in the fraction 530 does not change.

Referring now to FIG. 43 in conjunction with FIG. 10, on satisfaction of fact-practice-ending reward criteria, in Step 7 (3014), the student views the student's current interactive Student Progress Report for the operation practiced in the just-ended student fact practice (610 in FIG. 10) and selects an arcade-style game from a list of available arcade-style games in the game menu section 604 of the screen 600. The interactive Student Progress Report section 602 of the Progress Report and arcade-style game menu 600 has an interactive, student-specific addition grid 610 containing the student's results through the just-ended fact practice session (See FIG. 10). The student-specific addition grid 610 displayed on the student's screen is active, so the student can place the student's cursor over a particular square in the grid and the problem represented thereby will be displayed, complete with answer, on the student's screen.

Referring again to FIG. 43, in Step 8 (3016), the student plays the selected arcade-style game until pre-determined game-practice ending criteria are met. In Step 9 (3018), the ten highest scores for the selected arcade-style game are displayed for the student's class and grade (See FIG. 11).

Still referring to FIG. 43, in Step 10 (3020), the ten highest scores for the selected arcade-style game are displayed for the student's entire school (See FIG. 12).

Still referring to FIG. 43, in Step 11 (3022), Steps 1-10 (3004-3020) are repeated until the student computer lab period is over. In Step 12 (3024), the student logs out at the end of the student session.

According to the present Method For Teaching Rapid Recall Of Facts invention, a student session consists of at least one more practice portion and at least one game practice portion. Prior to engaging in the fact practice portion of the student session, the student has an opportunity to review the student's progress to date and note missed problems. At the end of the fact practice portion of the student session, the student once again has an opportunity to review the student's progress and note missed problems. In the fact practice portion of the student session, the student works a series of problems until the student answers a target number of problems (typically 8 or 16) correctly within 3 seconds. At the beginning of the game practice portion of the student session, the student's previous game progress and score are displayed. At the end of the game practice portion of the student session, a display shows the top 10 scores for the student's grade and class, then a second display shows the top 10 scores for the student's school. Thus, with respect to both the fact practice portion of the student session and also the game practice portion of the student session, the student first focuses, then practices, and then reviews.

It will be understood by one skilled in the art that alternation of a fact practice portion with a game practice portion is an important feature of the present Method For Teaching Rapid Recall Of Facts invention. Studies have shown that, when an individual is in the process of acquiring new facts, an intellectual “quiet time”—somewhat akin to a gestation period—following a period of intense study improves retention of new facts. The game practice portion of the student session according to the present invention provides a useful period during which new facts acquired during the fact practice portion of the student session are assimilated and catalogued in the student's memory for retrieval. Thus the game practice portion of the student session plays an important part in the student's learning.

It will be further understood by one skilled in the art that the fact practice portion of the student session according to the present invention provides an improved learning experience not practical without the use of a computer. Referring now to FIGS. 6-9, a problem is displayed to the student and a timer is started. The moving arrow 548 in the outer ring 44 of the timer graphic 524 provides sensory input to the student that the clock is running and a correct answer is required within 3 seconds for the student to advance toward the fact practice ending criteria and earn game practice time in an arcade-style game. The responsive face 536 adds an element of immediate feedback (positive if the answer is correct and negative in the absence of a correct answer) to the student. The insertion of a wedge 528a, 528b, 528c, 528d, 528e, 528f, 528g, or 528h to the pie chart 528 for each correct answer provides not only sensory feedback but also provides the student with a real-time measure of the student's progress during the current fact practice portion of the student session. The changing numerator 532 in the fraction 530 provides subtle education in an area to be introduced later in the student's educational curriculum. The repetition of a fractional progression . . . ⅛, 2/8 (¼), ⅜, 4/8 (½), ⅝, 6/8 (¾), ⅞, completion . . . over many fact practice sessions instills in the student a beginning understanding of fractions. From the perspective of the student, the process is effortless. From the perspective of the teacher, the process is effortless. Yet the benefit to the student is substantial and lasting.

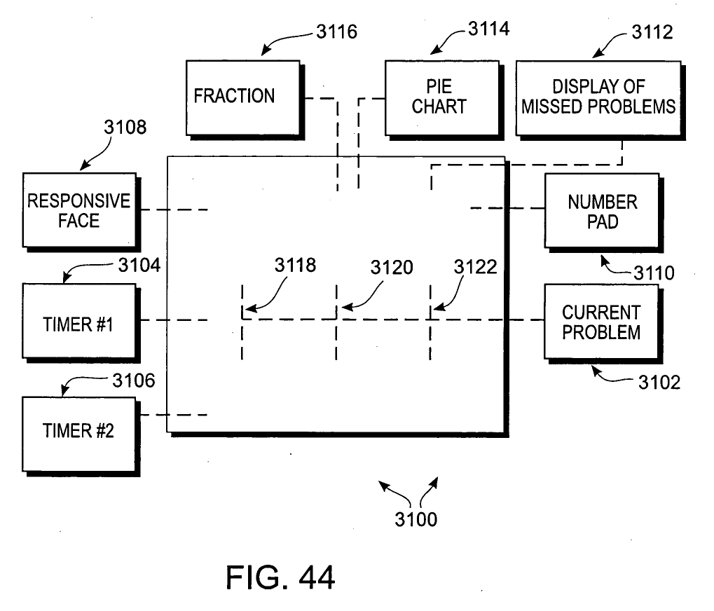

Referring now to FIG. 44, a functional diagram illustrates how the present Method For Teaching Rapid Recall Of Facts invention presents problems (facts) to the student during the fact practice portion of a student session. A computer screen 3100 displays a problem 3102, a first timer graphic 3104, a second timer graphic 3106, a responsive face 3108, an on-screen number pad 3110, a missed problems area 3112, a pie chart 3114, and a fraction 3116. The first timer graphic 3104 and the second timer graphic 3106 can be separate timer graphics or combined as illustrated by the timer graphic 524 in FIGS. 5-9. The precise location of the problem 3102, the first timer graphic 3104, the second timer graphic 3106, the responsive face 3108, the on-screen number pad 3110, the missed problems area 3112, the pie chart 3114, and the fraction 3116 on the computer screen 3100 is arbitrary.

Referring still to FIG. 44, problems 3102 are displayed serially from left to right across the bottom portion of the screen 3100 in a bottom left position 3118, a bottom middle position 3120, and a bottom right position 3122. While, as stated above, the precise locations of the problem is arbitrary, the progressive location of successive problems from left to right across the screen is helpful with younger students, especially those in pre-kindergarten and kindergarten levels. The successive location of the problem from left to right across the screen also trains the student's eyes to move from left, to center, to right, then back to the left position. This left-to-right-then-back-to-left movement is similar to the eye movement required for reading.

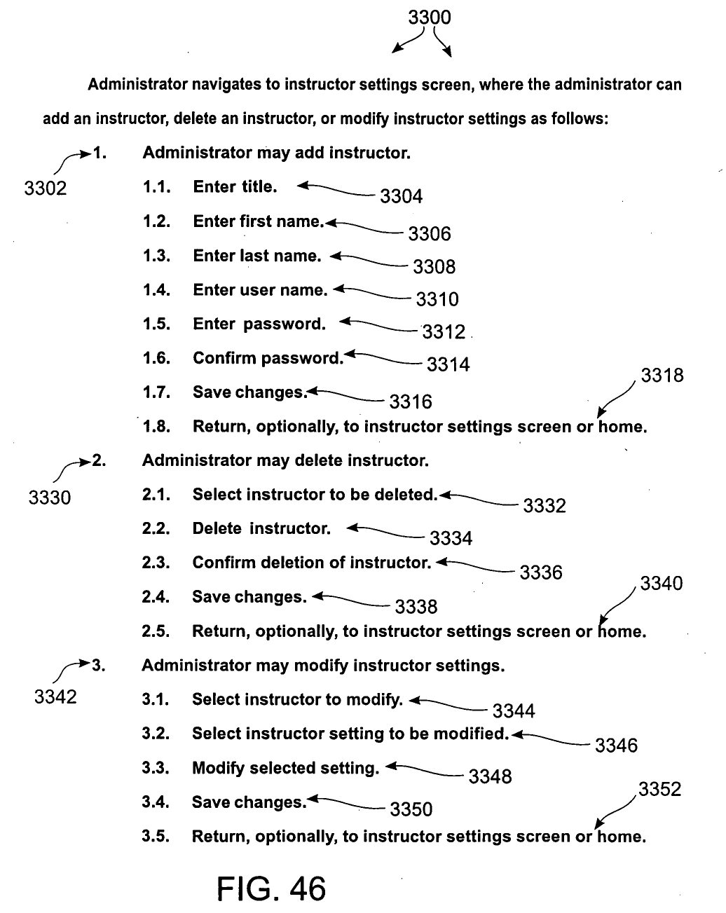

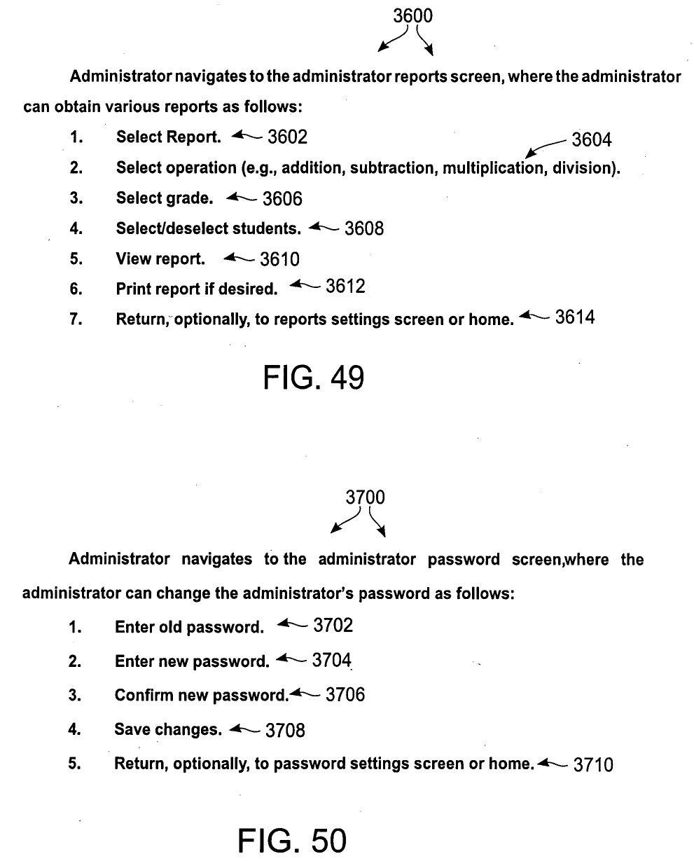

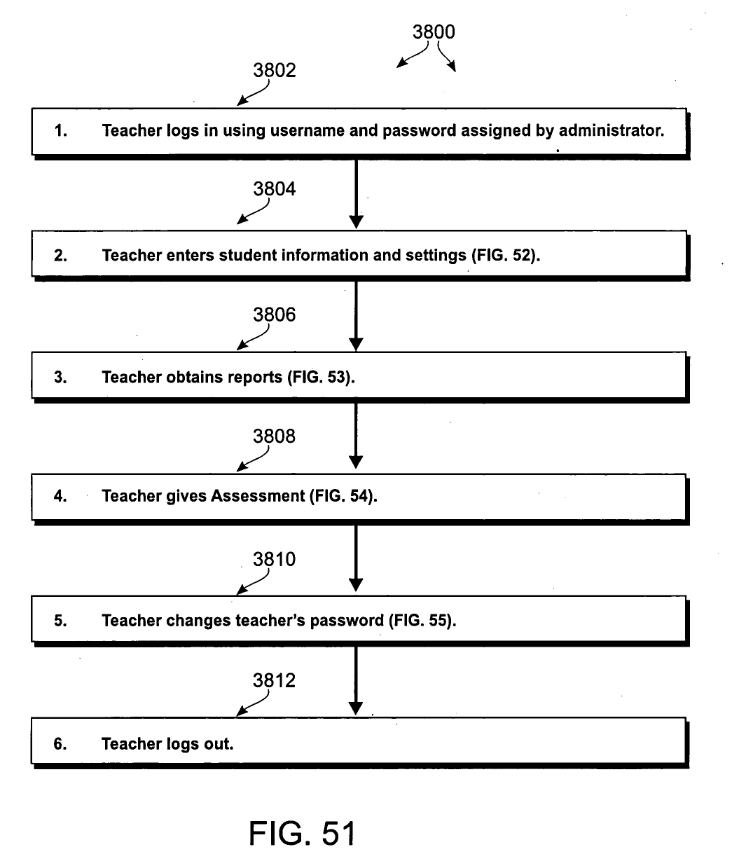

Referring now to FIG. 45, an Administrative Interface Summary 3200 describes the process by which an administrator uses the present Method Of Teaching Recall Of Facts invention. In Step 1 (3202), the administrator uses a selection screen to log in to a computer terminal by entering a default administrative username, a default administrative password, and a predetermined site code. In Step 2 (3204) , the administrator optionally enters instructor settings (See FIG. 46). In Step 3 (3206), the administrator optionally enters student settings (See FIG. 47). In Step 4 (3208), the administrator optionally enters site defaults (See FIG. 48). In Step 5 (3210), the administrator optionally enters report settings (See FIG. 49). In Step 6 (3212), the administrator optionally changes the administrator's password (See FIG. 50). In Step 7 (3214), the administrator logs out. As used herein, the term administrator means a principal, vice-principal, superintendent, assistant superintendent, or other individual having administrative responsibilities beyond (or in addition to) the responsibilities of a classroom teacher.

Referring now to FIG. 46, an Administrative Interface Instructor Settings Summary 3300 describes the manner by which an administrator uses the present Method Of Teaching Recall Of Facts invention to add instructors, delete instructors, and modify instructor settings. After logging in and navigating to the instructor settings screen, the administrator selectively adds instructors (3302), deletes instructors (3330), or modifies instructor settings (3342). After selecting “add instructor” from a menu at the instructor settings screen, the administrator adds an instructor by entering the instructor's title (3304), entering the instructor's first name (3306), entering the instructor's last name(3308), entering the instructor's user name (3310), entering the instructor's password (3312), confirming the instructor's password(3314), and saving changes (3316). The administrator then returns, optionally, to either the instructor settings screen or home (3318).

Referring still to FIG. 46, to delete an instructor the administrator selects “delete instructor” at the instructor settings screen, then selects an instructor to be deleted (3332), deletes the selected instructor (3334), and confirms deletion of the selected instructor (3336). The administrator returns, optionally, to the instructor settings screen or home (3338).

Still referring to FIG. 46, the administrator can modify instructor settings by first selecting “modify instructor settings” at the instructor settings screen. The administrator then selects an instructor (3344), selects the instructor setting to be modified (3346), modifies the selected setting (3348), and saves changes (3350). The administrator then returns, optionally, to the instructor settings screen or home (3352).

In the case of an instructor of special education students, the administrator might choose to permit the instructor to alter the default fact practice ending criteria or the time periods associated with the first timer graphic 3104 and the second timer graphic 3106 (See FIG. 44). A student having normal mental capacity coupled with a physical disability which impairs the student's ability to enter a correct answer within the default 3-second first rapid recall time period, the instructor might wish to increase the first rapid recall time period to permit the student time to enter the correct answer using the on-screen number pad 3110. Similarly, the instructor might wish to decrease the default fact practice ending criteria from 8, 16, or 32 correct answers to a lesser number of correct answers. It will be understood by one skilled in the art that, while normally assigning default fact practice ending criteria based on the student grade level in light of well-established research, the present Method provides the capability of customizing critical aspects of the Method to accommodate educational needs and teacher preferences.

Referring now to FIG. 47, an Administrative Interface Student Settings Summary 3400 describes the manner by which an administrator uses the present Method Of Teaching Recall Of Facts invention to add students, delete students, modify student information, move students from a current teacher to a different teacher, and promote students. After logging in and navigating to the student settings screen, the administrator selectively adds students (3402), deletes students (3424), modifies student settings (3436), moves students (3448), or promotes students (3464). To add a student, the administrator selects a teacher (3404), selects “add student” for the selected teacher (3406), enters the student's first name (3408), enters the student's last name (3410), enters the student's user name (3412), enters the student's password (3414), confirms the student's password (3416), selects the student's grade (3418), modifies student default settings (3419), and saves changes (3420). The administrator then returns, optionally, to either the student settings screen or home (3422).

Still referring to FIG. 47, to delete a student, the administrator selects a student to be deleted (3426), deletes the selected student (3428), confirms deletion of the selected student (3430), and saves changes (3432). The administrator then returns, optionally, to either the student settings screen or home (3434).

Still referring to FIG. 47, to modify student settings, the administrator selects a student (3438), selects the selected student's setting to be modified (3440), modifies the selected student's selected setting (3442), and saves changes (3444). The administrator then returns, optionally, to either the student settings screen or home (3446).

Referring still to FIG. 47, to move students to another teacher, the administrator selects students to be moved (3450), navigates to the “Select Instructor” screen (3452), selects the new instructor (3454), confirms the selected students (3456), selects “move students” (3458), and saves changes (3460). The administrator then returns, optionally, to either the student settings screen or home (3462).

Still referring to FIG. 47, the administrator can promote students by first selecting “promote students” at the student settings screen. The administrator then selects/deselects students qualified for promotion (3466), selects “promote students” from the menu displayed at the student settings screen (3468), and saves changes (3470). The administrator then returns, optionally, to the student settings screen or home (3472).

It will be understood by one skilled in the art that the present Method enables the administrator to promote students effortlessly and, in the process, move the promoted students from the old teacher to the new teacher. When appropriate, the administrator can promote all students in a class. In the alternative, the administrator can first “select all,” then deselect those students not qualified for promotion. For students promoted from kindergarten to first grade, the present Method will automatically introduce Stage 2 addition problems from the group 116 (See FIG. 1). For students promoted from second grade to third grade, the present Method will automatically introduce Stage 3 addition problems from the group 118 (See FIG. 1), Stage 2 multiplication problems from the group 216 (See FIG. 3), and Stage 1 division problems from the group 414 (See FIG. 4). For students promoted from fourth grade to fifth grade, the present Method will automatically introduce Stage 4 addition problems from the group 120 (See FIG. 1) and Stage 3 division problems from the group 418 (See FIG. 4).

It will be further understood by one skilled in the art that the normal schedule for staged introduction, of addition, multiplication, subtraction, and division problems to students, as reflected in the following table, is the default schedule according to the present Method. Thus a student recently promoted to the first grade will begin to have some problems from Group 116 of the addition grid 100 (FIG. 1). As discussed in greater detail below, however, the present Method will continue to present problems from Group 114 of the addition grid 100 (FIG. 1). Based on the student's performance on Assessments and in student sessions, the present Method shifts back to a previous group of problems if the student is not yet ready for higher stage problems. It will be still further understood by one skilled in the art that the present Method's ability to tailor problems automatically to the student's readiness avoids difficulties often encountered with peers in the classroom who may ridicule or otherwise inhibit the progress of a student whose progress may be lagging behind the progress of the class as a whole.

| | Addition | Multiplication | Subtraction | Division |
|---|---|---|---|---|
| | (FIG. 1) | (FIG. 2) | (FIG. 3) | (FIG. 4) |
| Stage 1 | Group 114 | Group 214 | Group 314 | Group 414 |
| | Grades PK, | Grade 2 | Grades PK, K, 1 | Grade 3 |
| | K | | | |
| Stage 2 | Group 116 | Group 216 | Group 316 | Group 416 |
| | Grades 1, 2 | Grade 3 | Grades 2, 3 | Grade 4 |
| Stage 3 | Group 118 | Group 218 | Group 318 | Group 418 |
| | Grades 3, 4 | Grades 4, 5, 6 | Grades 4, 5 | Grades 5, 6 |
| Stage 3 | Group 120 | Group 220 | Group 320 | Group 420 |
| | Grades 5, 6 | Grades 7+ | Grades 6+ | Grades 7+ |

Referring now to FIG. 48, an Administrative Interface Site Defaults Settings Summary 3500 describes the manner by which an administrator uses the present Method Of Teaching Recall Of Facts invention to limit operations available to the students, to select the specific views available to the students, to limit games available to the students, and to modify fact practice settings. After logging in and navigating to the site defaults settings screen, the administrator selectively limits operations available to students (3502), limits specific views available to students (3522), limits games available to students (3542), and modifies fact practice settings (3560). To limit operations available to students, the administrator selects grade and teacher (3504), selects/deselects operations available to the selected grade and teacher (3506), confirms the selection/de-selection (3508), and saves changes (3510). The administrator then returns, optionally, to either the site defaults settings screen or home (3512).

Referring still to FIG. 48, to limit specific views available to students, the administrator selects a grade and teacher (3524), selects/deselects views available to the selected grade and teacher (3526), confirms the selection/de-selection (3528), and saves changes (3530). The administrator then returns, optionally, to either the site defaults settings screen or home (3532).

Still referring to FIG. 48, the administrator can limit games available to students by first selecting “limit games” at the site defaults settings screen. The administrator then selects a grade and teacher (3544), selects/deselects games to be available to the selected grade and teacher (3546), confirms the selection/de-selection (3548), modifies the maximum game time for the selected games if desired (3550), and saves changes (3552). The administrator then returns, optionally, to the site defaults settings screen or home (3554).

Still referring to FIG. 48, the administrator can modify fact practice settings by first selecting “modify fact practice settings” at the site defaults settings screen. The administrator then selects a teacher and grade (3562), selects/deselects the fact practice setting(s) to be modified (3564), modifies the selected fact practice setting(s) (3566), and saves changes (3568). The administrator then returns, optionally, to the site defaults settings screen or home (3570).

Referring now to FIG. 49, an Administrative Interface Reports Settings Summary 3600 describes the manner by which an administrator uses the present Method Of Teaching Recall Of Facts invention to obtain various reports. After first selecting “obtain reports” at the administrator settings screen, the administrator selects a report (3602), selects an operation (3604), selects a grade (3606), selects/deselects students (3608), views the report (3610), and prints the report if desired (3612). The administrator then returns, optionally, to the administrator reports screen or home (3614).

Referring now to FIG. 50, an Administrative Interface Password Settings Summary 3700 describes the manner by which an administrator uses the present Method Of Teaching Recall Of Facts invention to the administrator can change the administrator's password. After first selecting “change password” at the administrator settings screen, the administrator enters the administrator's old password (3702), enters the new password (3704), confirms the new password (3706), and saves changes (3708). The administrator then returns, optionally, to the administrator settings screen or home (3510).

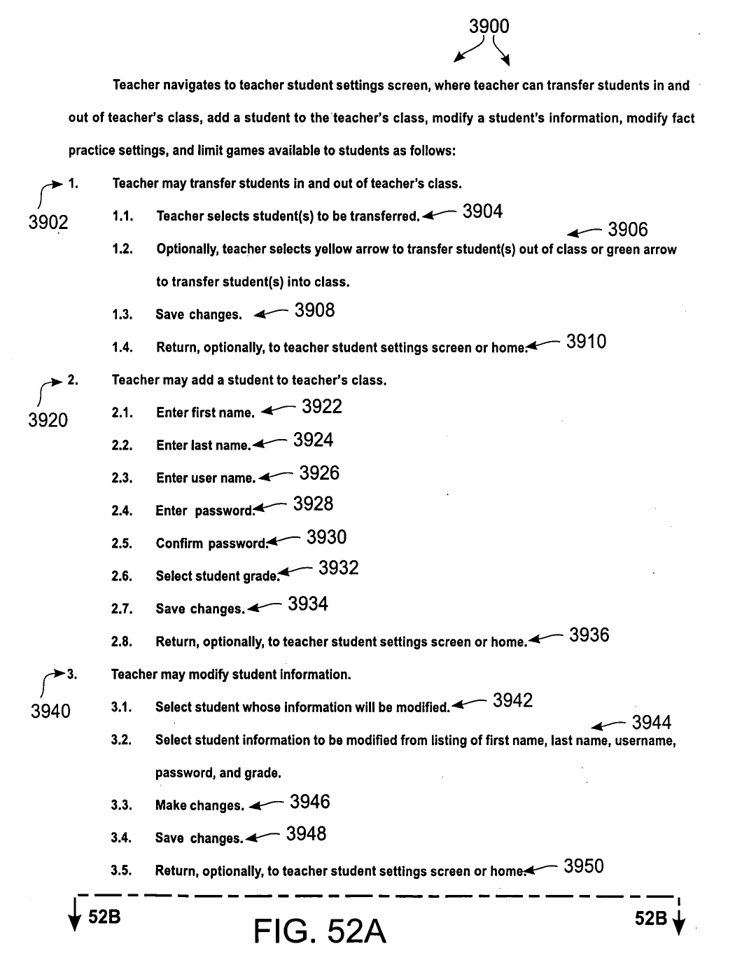

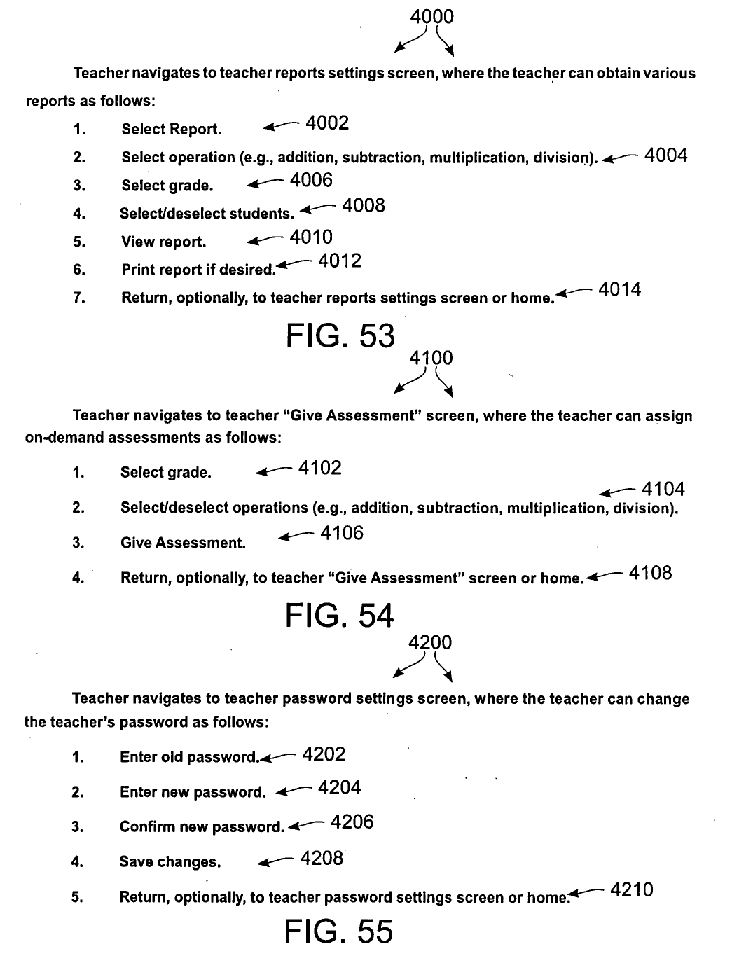

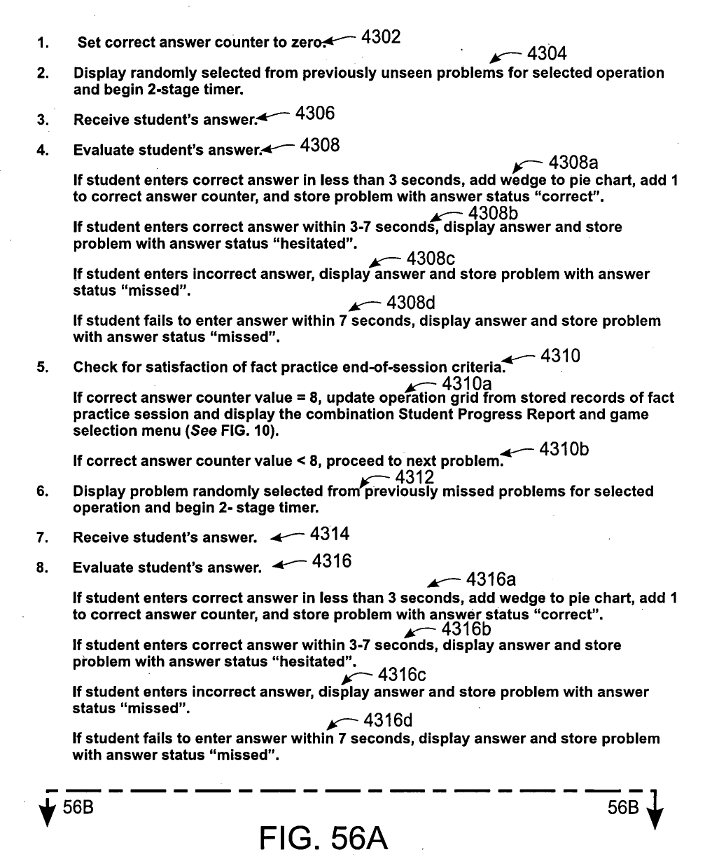

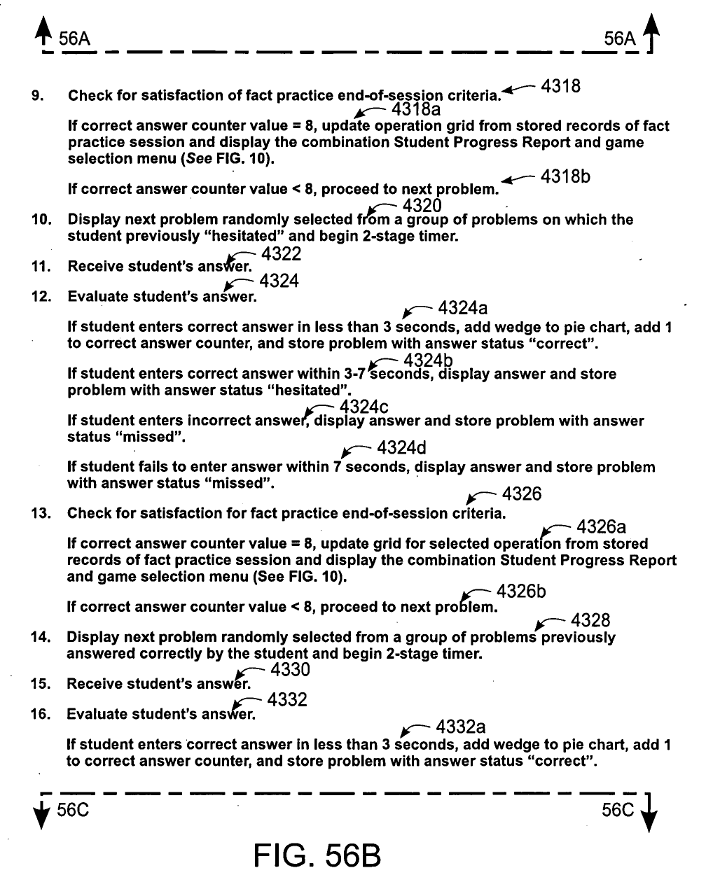

Referring now to FIG. 51, a Teacher Interface Summary 3800 describes the process by which a teacher/instructor uses the present Method Of Teaching Recall Of Facts invention. In Step 1 (3802), the teacher logs in to a computer terminal by entering the username and the password provided by the Administrator, together with a unique site code. In Step 2 (3804), the teacher enters student information and settings (See FIG. 52). In Step 3 (3806), the teacher obtains reports (See FIG. 53). In Step 4 (3808), the teacher gives an Assessment (See FIG. 54). In Step 5 (3810), the teacher can change the teacher's password (See FIG. 55). In Step 6 (3812), the teacher logs out.

Referring now to FIGS. 52A and 52B, a Teacher Interface Student Settings Summary 3900 describes the manner by which a teacher uses the present Method Of Teaching Recall Of Facts invention to transfer students in and out of a teacher's class, add students, modify student information, modify fact practice settings, and limit games available to students. After logging in and navigating to the teacher student settings screen, the teacher selectively transfers students (3902), adds students (3920), modifies student information (3940), modifies fact practice settings (3960), and limits games available to students (3980).

Referring now to FIG. 52A, to transfer students in and out of the teacher's class, the teacher selects “transfer student” at the Teacher Interface Student Settings screen, selects the student(s) to be transferred (3904), selects, optionally, a yellow arrow icon to transfer student(s) out of class or a green arrow icon to transfer selected student(s) into class (3906), and saves changes (3908). The teacher then returns, optionally, to the teacher student settings screen or home (3910).

Referring still to FIG. 52A, to add a student to the teacher's class, the teacher selects “add student” at the Teacher Interface Student Settings screen, enters the student's first name (3922), enters the student's last name (3924), enters the student's user name (3926), enters a password to be assigned to the student (3928), confirms the password (3930), selects the student's grade (3932), and saves changes (3934). The teacher then returns, optionally, to the teacher student settings screen or home (3936).

Still referring to FIG. 52A, to modify student information the teacher selects “modify student information” at the Teacher Interface Student Settings screen, selects the student whose information will be modified (3942), selects the student information to be modified (3944), modifies the selected student information (3946), and saves changes (3948). The teacher then returns, optionally, to the teacher student settings screen or home (3950).

Referring now to FIG. 52B, to modify fact practice settings the teacher selects “modify fact practice settings” at the Teacher Interface Student Settings screen, selects the student(s) whose fact practice settings will be modified (3962), selects the fact practice setting to be modified (3964), modifies the selected fact practice setting (3966), and saves changes (3968). The teacher then returns, optionally, to the teacher student settings screen or home (3970).

Referring still to FIG. 52B, to limit games available to students the teacher selects “modify games available to students” at the Teacher Interface Student Settings screen, selects the student(s) whose game availability settings will be modified (3982), confirms the students selected/deselected (3984), selects/deselects games to be made available to the selected students (3986), confirms selection/de-selection of games (3988), modifies the maximum game time or accepts default setting (3990), and saves changes (3992). The teacher then returns, optionally, to the teacher student settings screen or home (3994).

Referring now to FIG. 53, a Teacher Interface Reports Settings Summary 4000 describes the manner by which the teacher can obtain various reports. The teacher first selects “obtain reports” at the Teacher Interface Student Settings screen. The teacher then selects a report (4002), selects an operation (4004), selects a grade (4006), selects/deselects students (4008), views the report (4010), and prints the report if desired (4012). The teacher then returns, optionally, to the Teacher Interface Student Settings screen or home (4014).

Referring now to FIG. 54, a Teacher Interface Give Assessment Summary 4100 describes the manner by which the teacher gives an Assessment. The teacher first selects “give assessment” at the Teacher Interface Student Settings screen. The teacher then selects a grade (4102), selects/deselects operations to be included in the Assessment (4104), and gives the Assessment (4106). The teacher then returns, optionally, to the Teacher Interface Student Settings screen or home (4108).

Referring now to FIG. 55, a Teacher Interface Change Password Summary 4200 describes the manner by which the teacher changes the teacher's password according to the present Method. The teacher first selects “change password” at the Teacher Interface screen. The teacher then enters the teacher's old password (4202), enters the new password (4104), confirms the new password (4106), and saves changes (4208). The teacher then returns, optionally, to the Teacher Interface Student Settings screen or home (4208).

Turning now to the guaranteed review and recycle feature of the present Method, each fact practice portion of a student session includes at least one of the following (in order of priority):
1. A previously unseen (i.e., a new) problem (fact).
2. A previously missed problem (fact).
3. A problem (fact) on which the student previously “hesitated.”
4. A problem (fact) previously answered correctly by the student.
5. A problem (fact) previously mastered by the student.
   Each type of problem will be discussed in turn with reference to FIGS. 1 and 39.

The inclusion of a previously unseen problem helps the student to advance from Stage 1 through Stage 4. Referring now to the addition grid 2618 in FIG. 39 in conjunction with the addition grid 100 in FIG. 1, at least one problem from the group 120 (corresponding to Stage 4 addition problems) would be included in Kelly Robinson's next addition fact practice session.

The inclusion of a previously missed problem helps the student to learn facts not yet within the student's long-term memory. Referring again to the addition grid 2618 in FIG. 39, at least one of Kelly's “missed” addition problems (1+1=2, 0+0=9, 1+10=11, 3+1=4, 4+10=14, 6+6=12, 6+10=16, 7+2=9, 7+9−16, and 8+3=11) will be included in Kelly's next addition fact practice session.

The inclusion of a problem on which the student previously hesitated helps the student move that particular fact from long-term memory to rapid recall memory. Referring once again to the addition grid 2618 in FIG. 39, at least one of Kelly's “hesitated” addition problems (4+2=6, 8+2=10, and 10+2=12) will be included in Kelly's next addition fact practice session.

The inclusion of a problem previously answered correctly by the student helps the student to “master” that particular fact for rapid recall. Referring again to the addition grid 2618 in FIG. 39, at least one problem corresponding to a large gray dot in the addition grid 2618 will be included in Kelly's next addition fact practice session.

The inclusion of a problem previously mastered by the student insures that particular fact remains in the student's rapid recall memory. Referring once again to the addition grid 2618 in FIG. 39, at least one problem corresponding to a large black dot in the addition grid 2618 will be included in Kelly's next addition fact practice session.

In the context of FIG. 6 and with reference to FIG. 39, wherein the student must provide 8 correct answers to complete the fact practice portion of the student session, the present Method would (1) randomly select and display a previously unseen addition problem, then (2) randomly select and display a previously missed problem, then (3) randomly select and display a previously “hesitated” problem, then (4) randomly select and display a previously “correct” problem, then (5) randomly select and display a previously “mastered” problem, and then repeat steps 1-5 until the student enters 8 correct answers.

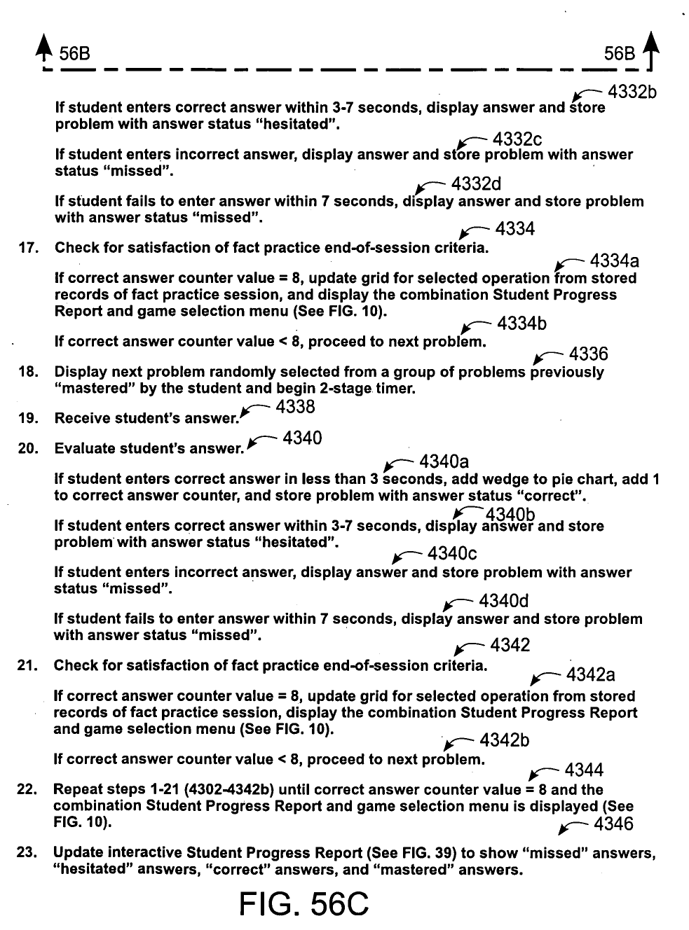

Referring now to FIGS. 56A-56C, the steps of the present Method's selection and display of problems are contained in a summary 4300. Whether the fact practice ending criteria is 8 correct answers (grades PK-3) or 16 correct answers (for higher grades), it will be immediately apparent that the student will always see at least one problem from each of the categories set forth above (unseen, missed, hesitated, correct, and mastered).

Following selection of an operation (See FIG. 5), the present Method first sets a correct answer counter to zero (4302), then randomly selects and displays a problem, previously unseen by the student and begins the 2-stage timer (4304). See discussion of FIGS. 6-9 for details of the operation of the two-stage timer. The present Method receives the student's answer (4306) and then evaluates the student's answer (4308). If the student enters a correct answer in less than 3 seconds, the present Method adds a wedge to the pie chart displayed on the student's screen, adds 1 to correct answer counter, and stores the answer status for the problem as “correct” (4308a). If the student enters a correct answer within more than 3 seconds but less than 7 seconds, the present Method displays the problem (including the correct answer) and stores the answer status for the problem as “hesitated” (4308b). If the student enters an incorrect answer, the present Method displays the problem (including the correct answer) and stores the answer status for the problem as “missed” (4308c). If the student fails to enter an answer within 7 seconds, the present Method displays the problem (including the correct answer) and stores the answer status for the problem as “missed” (4308d).

Still referring to FIGS. 56A-56C, the present Method next checks for satisfaction of fact practice end-of-session criteria by checking the correct answer counter (4310). If the correct answer counter value equals 8, the present Method updates the selected operation grid to reflect answers from the current fact practice session and displays the combination Student Progress Report and game selection menu (4310a; See FIG. 10). If the correct answer counter value is less than 8, the Method proceeds to the next problem (4310b).

Still referring to FIGS. 56A-56C, the present Method next selects and displays another problem. For the second problem, the present Method randomly selects a problem from the group of problems which were previously missed by the student (4312). The present Method receives the student's answer (4314) and then evaluates the student's answer (4316). If the student enters a correct answer in less than 3 seconds, the present Method adds a wedge to the pie chart displayed on the student's screen, adds 1 to correct answer counter, and stores the answer status for the problem as “correct” (4316a). If the student enters a correct answer within more than 3 seconds but less than 7 seconds, the present Method displays the problem (including the correct answer) and stores the answer status for the problem as “hesitated” (4316b). If the student enters an incorrect answer, the present Method displays the problem (including the correct answer) and stores the answer status for the problem as “missed” (4316c). If the student fails to enter an answer within 7 seconds, the present Method displays the problem (including the correct answer) and stores the answer status for the problem as “missed” (4316d).

Still referring to FIGS. 56A-56C, the present Method checks once again for satisfaction of fact practice end-of-session criteria by checking the correct answer counter (4318). If the correct answer counter value equals 8, the present Method updates the selected operation grid to reflect answers from the current fact practice session and displays the combination Student Progress Report and game selection menu (4318a; See FIG. 10). If the correct answer counter value is less than 8, the Method proceeds to the next problem (4318b).

Still referring to FIGS. 56A-56C, the present Method next selects and displays another problem. For the third problem, the present Method randomly selects a problem from the group of problems wherein the student supplied the proper mathematical answer but “hesitated” (4320). As used herein, a “hesitated” answer is an answer which is correct mathematically but which was entered after expiration of the first timer time period (3 seconds by default) and prior to expiration of the second timer time period (7 seconds by default). The present Method receives the student's answer (4322) and then evaluates the student's answer (4324). If the student enters a correct answer in less than 3 seconds, the present Method adds a wedge to the pie chart displayed on the student's screen, adds 1 to correct answer counter, and stores the answer status for the problem as “correct” (4324a). If the student enters a correct answer within more than 3 seconds but less than 7 seconds, the present Method displays the problem (including the correct answer) and stores the answer status for the problem as “hesitated” (4324b). If the student enters an incorrect answer, the present Method displays the problem (including the correct answer) and stores the answer status for the problem as “missed” (4324c). If the student fails to enter an answer within 7 seconds, the present Method displays the problem (including the correct answer) and stores the answer status for the problem as “missed” (4324d).

Still referring to FIGS. 56A-56C, the present Method checks once again for satisfaction of fact practice end-of-session criteria by checking the correct answer counter (4326). If the correct answer counter value equals 8, the present Method updates the selected operation grid to reflect answers from the current fact practice session and displays the combination Student Progress Report and game selection menu (4326a; See FIG. 10). If the correct answer counter value is less than 8, the Method proceeds to the next problem (4326b).

Still referring to FIGS. 56A-56C, the present Method next selects and displays another problem. For the fourth problem, the present Method randomly selects a problem from the group of problems which were previously answered correctly by the student (4328). As used herein, a “correct” answer is an answer which is not only correct mathematically but which is also entered within the first timer time period (3 seconds or less by default). The present Method receives the student's answer (4330) and then evaluates the student's answer (4332). If the student enters a correct answer in less than 3 seconds, the present Method adds a wedge to the pie chart displayed on the student's screen, adds 1 to correct answer counter, and stores the answer status for the problem as “correct” (4332a). If the student enters a correct answer within more than 3 seconds but less than 7 seconds, the present Method displays the problem (including the correct answer) and stores the answer status for the problem as “hesitated” (4332b). If the student enters an incorrect answer, the present Method displays the problem (including the correct answer) and stores the answer status for the problem as “missed” (4332c). If the student fails to enter an answer within 7 seconds, the present Method displays the problem (including the correct answer) and stores the answer status for the problem as “missed” (4332d).

Still referring to FIGS. 56A-56C, the present Method checks once again for satisfaction of fact practice end-of-session criteria by checking the correct answer counter (4334). If the correct answer counter value equals 8, the present Method updates the selected operation grid to reflect answers from the current fact practice session and displays the combination Student Progress Report and game selection menu (4334a; See FIG. 10). If the correct answer counter value is less than 8, the Method proceeds to the next problem (4334b).

Still referring to FIGS. 56A-56C, the present Method next selects and displays another problem. For the fifth problem, the present Method randomly selects a problem from the group of problems which were previously answered correctly and “mastered” by the student (4336). As used herein, a “mastered” answer means the student entered a “correct” answer each of the last three times the problem was presented. A “correct” answer is an answer which is not only correct mathematically but which is also entered within the first timer time period (3 seconds or less by default). The present Method receives the student's answer (4338) and then evaluates the student's answer (4340). If the student enters a correct answer in less than 3 seconds, the present Method adds a wedge to the pie chart displayed on the student's screen, adds 1 to correct answer counter, and stores the answer status for the problem as “correct” (4340a). If the student enters a correct answer within more than 3 seconds but less than 7 seconds, the present Method displays the problem (including the correct answer) and stores the answer status for the problem as “hesitated” (4340b). If the student enters an incorrect answer, the present Method displays the problem (including the correct answer) and stores the answer status for the problem as “missed” (4340c). If the student fails to enter an answer within 7 seconds, the present Method displays the problem (including the correct answer) and stores the answer status for the problem as “missed” (4340d).

Still referring to FIGS. 56A-56C, the present Method checks once again for satisfaction of fact practice end-of-session criteria by checking the correct answer counter (4342). If the correct answer counter value equals 8, the present Method updates the selected operation grid to reflect answers from the current fact practice session and displays the combination Student Progress Report and game selection menu (4342a; See FIG. 10). If the correct answer counter value is less than 8, the Method proceeds to the next problem (4342b).

It will be understood by one skilled in the art that the present Method systematically and hierarchically (1) introduces new problems to the student, (2) reviews problems previously missed by the student, (3) reviews problems on which the student previously hesitated, (4) reviews problems for which the student entered a mathematically correct answer in more than 3 seconds but less than 7 seconds, and (5) reviews problems already mastered by the student.

Still referring to FIGS. 56A-56C, the present Method continues to present problems to the student in the order set forth herein until the fact practice end-of-session criteria are satisfied (4344). By default, the fact practice session is set to end when the student has correctly answered 8 problems. The student then views the combination Student Progress Report and game selection menu, but only after the appropriate interactive grid contained in the Student Progress Report has been updated to include the status of problems from the student's just-concluded practice session (4346). See FIG. 39.

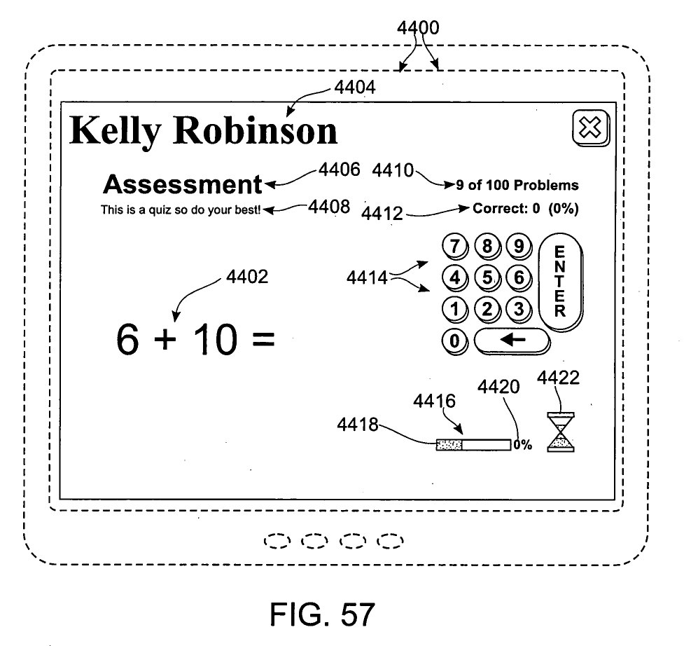

Referring now to FIG. 57, an Assessment screen display 4400 is displaying a math facts addition problem 4402 in horizontal format. The assessment screen display contains student identifying material (text) 4404 (“Kelly Robinson”), a title (text) 4406 (“Assessment”), and reminder text 4408 (“This is a quiz so do your best!”). An assessment progress indicator 4410 identifies the current problem and the total number of problems to be presented (the current problem 4402 is the 9^{th} problem out of 100 problems). A real-time display 4412 indicates the students number of problems answered correctly thus far (0) and the percentage of problems answered correctly (0%). An on-screen number pad 4414 enables entry of the answer using the mouse. If the student's computer is equipped with touch screen capabilities, the on-screen number pad 4414 also functions as a touch pad, enabling the student to enter the answer by touching the numbers forming the answer and then touching the enter key on the on-screen number pad 4414. A horizontal bar graph 4416 shows the student's current progress against a background of the student's most recent previous assessment score 4418. The percentage of correct answers on the current assessment 4420 appears to the right of the horizontal bar graph 4416. A timer graphic 4422 provides a visual indicator of the time left in which to answer the displayed problem.

Still referring to FIG. 4400, the timer graphic 4422 has only a single time period (3 seconds by default), because the purpose of the Assessment is to find out what the student already knows. It will be understood by one skilled in the art that, beginning in the fourth grade, an Assessment would normally be given at the beginning of the year. Correct answers to problems contained in the Assessment will be reflected in the interactive student-specific Student Progress Report (See FIG. 39).

It will be understood by one skilled in the art that the inclusion of a single 3-second time period—the rapid recall response time period—provides sufficient time for the student to enter the correct answer only if the student knows the correct answer without calculation, i.e., if the student has stored the correct answer in what is sometimes called “rapid recall memory” or “rapid recall.” Thus the Assessment, as reflected by the display shown in FIG. 4400, provides a means for moving rapidly through the simple problems to problems where the student needs substantial practice by identifying as “mastered” those problems answered correctly by the student on the Assessment. Whereas several fact practice sessions might be required for the student to move past easier math facts problems, the Assessment permits the student to advance more quickly to fact practice sessions involving those problems for which the student truly needs practice. Yet even “mastered” problems will reappear from time to time to insure the student's mastery of particular problems is more nearly permanent.

Referring now to FIGS. 1-5 in conjunction with FIG. 39, the present Method automatically moves to the next stage and begins to introduce unseen problems from a new group (e.g., stage A4 problems from the group 120 in FIG. 1) whenever the student achieves mastery of a predetermined percentage of the previous stage (e.g., stage A3 problems from the group 118 in FIG. 1). Although the mastery level can be altered, the default mastery level for introduction of next-stage problems according to the present Method is eighty percent. Because problems from every eligible group may be presented during a fact practice session, it is possible for a student to progress to a new stage automatically as the student is ready. It is also possible for the student to regress to an earlier stage. In that event, problems from the higher stage are not re-designated as unseen, they are simply not presented until the student has indicated a re-mastery of the lower stage problems.

It will be further understood by one skilled in the art that, while the order does not matter in addition and multiplication, the same is not true for subtraction and division.

a+b=b+a

a×b=b×a

a−b≠b−a

a+b≠b+a

The present Method solves this problem, with reference to the grid, by first determining the minuend (in the case of subtraction) and the dividend (in the case of division). The minuend is the sum of the two terms involved in the subtraction problem, and the minuend is always presented first. Referring to FIG. 3, for a subtraction problem involving the number 5 along the y axis 304 and the number 9 along the x axis 302, the present method first determines the minuend by adding 5+9, and the problem displayed to the student will be (if in horizontal format):

14−5=9 or

14−9=5

With respect to division and with reference to FIG. 4, a division problem involving the number 8 on the x axis 402 and the number 7 on the y axis 404 first requires determination of the product of 8×7=56. Thus 56 becomes the dividend, and the problems displayed to the student will be (if in horizontal format):

56÷8=7 or

56÷7=8

Division by zero is not permitted.

The steps of the present Method are suitable for implementation using either a spreadsheet approach or a database approach. Whether generated by a spreadsheet or database, the present Method uses an interactive grid to deliver the fact problems, to track the fact problems, to provide student-specific review of the student's progress, to generate the Trouble Facts reports, and to generate the Student Progress Report. Within each grid, factual problems are introduced in stages based on the individual student's grade and progress. The interactive grid also provides a snapshot of the student's progress toward mastery of the facts delivered by the grid.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for teaching a student the rapid recall of facts using a computer in a fact practice session, the method comprising the steps of:
(A) providing at least one interactive grid containing a first fact component spaced along an x-axis and a second fact component spaced along a y-axis, wherein each of the at least one interactive grids corresponds to a particular topic, and wherein each interactive grid cells contain factual content defining a problem derived from the first fact component and the second fact component, and wherein each interactive grid cell contains an indicia of the student's answers to the corresponding problem, wherein a first indicia indicates a “missed” answer, a second indicia indicates a “hesitated” answer, a third indicia indicates a “correct” answer, and a fourth indicia indicates a “mastered” answer;
(B) providing an interactive startup menu containing topics for selection by the student;
(C) setting pre-selected fact practice session-ending criteria for ending a fact practice session;
(D) providing at least one arcade-style game for play by the student in a game practice session on satisfaction of the fact practice session-ending criteria;
(E) setting pre-selected game practice session-ending criteria for ending the game practice session;
(F) receiving the student's selection of a topic for the fact practice session;
(G) selecting a problem based on one of the at least one interactive grids;
(H) displaying the selected problem on the student's computer screen;
(I) receiving the student's answer to the selected problem;
(J) evaluating the student's answer to the selected problem, wherein the evaluating step further comprises the steps of:
(i) classifying the student's answer to the selected problem as “correct” if the student enters a correct answer in less than a first relatively shorter pre-determined time period;
(ii) classifying the student's answer to the selected problem as “hesitated” if the student enters the correct answer a second relatively longer predetermined time period;
(iii) classifying the student's answer to the selected problem as “missed” if the student either enters a incorrect answer within the second relatively longer predetermined time period or fails to enter an answer within the second relatively longer predetermined time period; and
(iv) classifying the student's answer to the selected problem as “mastered” if the student answered the selected problem with a “correct” answer on 3 consecutive times the selected problem was presented to the student;
(K) storing the status of the student's answer to the selected problem;
(L) displaying the selected problem, together with the answer, on the student's computer screen if the answer was either “hesitated” or “missed;”
(M) determining whether the pre-selected fact practice session-ending criteria have been satisfied;
(N) updating interactive grid from stored records of fact practices session and display a combination Student Progress Report and game selection menu if the pre-selected fact practice session-ending criteria have been satisfied, otherwise proceed to next problem, wherein the combination Student Progress Report further comprises the interactive grid showing the status of the student's answers to and a menu of games for selection by the student;
(O) repeating steps G-N until the pre-selected fact practice session-ending criteria have been satisfied and the combination Student Progress Report and game selection menu is displayed;
(P) receiving the student's game selection from the combination Student Progress Report and game selection menu;
(Q) running the arcade-style game selected by the student as a reward for completing a fact practice session until the game practice session-ending criteria are satisfied; and
(R) repeating steps B-Q as computer access time permits.

2. The method of claim 1, wherein the problems displayed on the student's computer screen are mathematical operational problems displayed in a standard horizontal format.

3. The method of claim 1, wherein the problems displayed on the student's computer screen are mathematical operational problems displayed in a standard vertical format.

4. The method of claim 1, wherein the problems displayed on the student's computer screen are mathematical operational problems displayed in algebraic format.

5. The method of claim 1, wherein successive problems are displayed on the student's computer screen first toward the left side of the student's computer screen, then generally in the left-to-right center of the student's screen, and then toward the right side of the student's computer screen.

6. The method of claim 1, further comprising the additional step of providing an on-screen keypad for use with computer mouse.

7. The method of claim 6, wherein the on-screen keypad also functions as a touch pad.

8. The method of claim 2, wherein the first fact component is a first addend, wherein the second fact component is a second addend, and wherein the problem is an addition problem having a sum equal to the sum of the first addend and the second addend.

9. The method of claim 2, wherein the problem is a subtraction problem wherein the first fact component is the minuend, the second fact component is the difference, and the subtrahend is the sum of the first fact component and the second fact component.

10. The method of claim 2, wherein the problem is a multiplication problem wherein the first fact component is the multiplicand, the second fact component is the multiplier, and the product of the first fact component and the second fact component is the product.

11. The method of claim 2, wherein the problem is a division problem wherein the first fact component is the divisor, the second fact component is the quotient, and the dividend is the product of the first fact component and the second fact component.

12. The method of claim 1, wherein the problem is a factual history question wherein the first component identifies the topic, the second fact component is the question, and wherein the answer to the problem is the answer to the history question.

13. The method of claim 1, wherein the problem is a language vocabulary question wherein the first component is a term in the student's first language, the second component is a definition of the term in the student's first language, and the answer is a corresponding term in the language being studied by the student.

14. The method of claim 1, wherein the pre-selected fact practice session-ending criteria and the pre-selected game session-ending criteria are modifiable by teachers and administrators.

15. The method of claim 1, wherein the first relatively shorter predetermined time period in the evaluating step is 3 seconds and wherein the second relatively longer predetermined time period in the evaluating step is 4 seconds.

16. The method of claim 15, wherein the first relatively shorter predetermined time period and the second relatively longer predetermined time period are modifiable by teachers and administrators.

17. The method of claim 1, further comprising the additional steps of:
giving a teacher-prompted assessment by displaying problems sequentially on the student's computer screen;
evaluating the student's answers according to the method set forth in claim 1; and
updating the student's interactive grid to show correct answers entered by the student on the assessment as “mastered” answers in the interactive grid.

18. The method of claim 1, further comprising the step of displaying missed problems on the student's computer screen.

19. The method of claim 1, further comprising the steps of:
displaying a pie chart on the student's computer screen; and
displaying an additional wedge in the pie chart on the student's computer screen each time the student answers a question correctly.

20. The method of claim 1, further comprising the step of displaying a motion graphic on the student's computer screen indicating the elapsed time in the first relatively shorter predetermined time period.

21. The method of claim 1, further comprising the stop of displaying a motion graphic on the student's computer screen indicating the elapsed time in the second relatively longer predetermined time period.

22. The method of claim 1, further comprising the step of generating a student-specific trouble facts report at the request of a student, teacher, or administrator.

23. The method of claim 1, further comprising the step of generating a student-specific Student Progress Report at the request of a student, teacher, or administrator.

24. The method of claim 1, further comprising the step of automatically generating and displaying a list of the ten highest game scores, for the student's class and grade, for the arcade-style game at the completion of the student's game practice session.

25. The method of claim 1, further comprising the step of automatically generating and displaying a list of the ten highest game scores, for all student's in the student's school for the selected arcade-style game.

26. The method of claim 1, further comprising the step of generating selected reports for teachers and administrators, on demand, in response to a request from a teacher or administrator.

27. The method of claim 26, wherein the selected report is a Student User Report.

28. The method of claim 26, wherein the selected report is an Assessment Report.

29. The method of claim 26, wherein the selected report is a “We Beat Our Best Assessment!” report.

30. The method of claim 26, wherein the selected report is a Group Summary report.

31. The method of claim 26, wherein the selected report is a Histogram Report.

32. The method of claim 26, wherein the selected report is a Group Trouble Facts Report.

33. The method of claim 26, wherein the selected report is a generic Mad Minute work sheet.

34. The method of claim 26, wherein the selected report is a student-specific Mad Minute work sheet.

35. The method of claim 1, further comprising the step of generating selected reports for administrators, on demand, in response to a request from an administrator.

36. The method of claim 35, wherein the selected administrative report is an Administrative Instructor Summary Report.

37. The method of claim 36, wherein the selected administrative report is an Administrative Histogram Report for All Instructors.

38. The method of claim 1, further comprising the additional steps of:
providing an administrative interface for entry of student and teacher information by administrators; and
providing an instructor interface for entry of student and teacher information by instructors.

39. The method of claim 38, wherein an administrator or teacher can selectively promote students from one grade to another grade.

40. The method of claim 1, wherein problems from the interactive grid are introduced to the student in stages corresponding to the student's grade and performance.
